(19) United States
(12) Patent Application Publication
(10) Pub. No.: US 2016/0012739 A1
(43) Pub. Date: Jan. 14, 2016

(54) NETWORKING SYSTEMS AND METHODS FOR FACILITATING COMMUNICATION AND COLLABORATION USING A SOCIAL-NETWORKING AND INTERACTIVE APPROACH

(71) Applicant: Ali Jafari, Carmel, IN (US)

(72) Inventor: Ali Jafari, Carmel, IN (US)

(21) Appl. No.: 14/799,552

(22) Filed: Jul. 14, 2015

Related U.S. Application Data
(60) Provisional application No. 62/024,014, filed on Jul. 14, 2014.

(51) Int. Cl. G09B 5/08; G06Q 50/00; G06Q 30/02; G09B 7/00; H04L 29/08

(52) U.S. Cl. CPC G09B 5/08; G09B 7/00; H04L 67/22; G06Q 30/0239; G06Q 50/01

(57) ABSTRACT

Systems, methods, and techniques for providing a dynamic platform for educators and businesses to employ a networking-based approach to course management and/or training through the use of social networking models. The computer-aided system and method facilitate global user collaboration and communication across a network-based learning environment through the use of various feature sets including, for example, a rewards tool. The systems and methods hereof support course creation and implementation, as well as the formation of groups, Conexus and user-defined groups. The system and method can categorize and sort these groups and courses into subsets based on subject matter bases, which thereby enables user to share information and collaborate, not just in their personalized groups, but also with learners positioned all over the world.

### PRIORITY

This application is related to and claims the priority benefit of U.S. Provisional Application Ser. No. 62/024,014 to Jafari, filed Jul. 14, 2014, the contents of which is hereby expressly incorporated by reference in its entirety into this disclosure.

### BACKGROUND

The conventional course and learning management system (CMS/LMS) approach is limited in several ways. Primarily, conventional systems place a heavy focus on e-course delivery and management. Such systems and the functionalities thereof are designed around “management” aspects of courses, with a large part of their functionality geared toward informing and guiding students with respect to announcements, upcoming tasks and deadlines, etc. In many cases, the main reasons students log onto the CMS is to learn what tasks are upcoming, to review new assignments, to submit assignments and/or to access grades.

Furthermore, the conventional LMS approach is based on connecting with limited members of a given classroom. In other words, it operates within a closed environment that is only accessible by members of a single class or, at most, a single campus or institution. This is problematic given that the ability of educators (including educational institutions, private corporations and institutions of higher learning) to reach potential students has generally been limited by geography. Indeed, many prospective students are deprived of receiving instruction from other, possibly better-qualified instructors or institutions, that are located outside of their immediate locale. Similarly, educational institutions have been limited to serving only those students located within commutable distance of their campuses and who are able to reach such campuses at the times the courses of interest are being provided. The built-in constraints of conventional CMS and LMS models offer little in the way of alleviating this educational norm and, thus, continue to limit the availability of education as well as the dissemination of knowledge.

The advent of networked computers and communications has afforded a partial solution to these limitations. In particular, the availability of electronic networks such as the Internet has enabled students and educators to, at least partially, overcome geographic dispersion and physical location barriers. Using this electronic medium, students and instructors are able to exchange information through classroom lectures, homework assignments, texts and materials, grading, question and answer interaction sessions, and other related modalities to affect a traditional learning or educational experience regardless of physical location.

However, the systems that are currently available to use with distance education are complex and often do not facilitate ease of use. Furthermore, conventional CMS/LMS are designed with little attention to human factors, which necessarily results in a design that is not user intuitive. For example, in many cases, a very basic function may require several clicks, and extensive prior instruction and training are often required before faculty and students are comfortable within the environment. Furthermore, due to the variable nature of instructors' teaching techniques, current network-based systems do not provide for a significant degree of customization and are ill-suited to support diverse teaching modalities.

Still further, many educational institutions have existing or legacy network-based systems that students access to obtain various types of information (e.g., class schedules). The addition of yet another network-based system adds additional complexity to an already difficult environment, especially considering the vast amount of time and resources required to aggregate and share information between legacy networks and a new CMS/LMS.

As evidenced by the recent popularity of social networking systems, a new communication and networking paradigm has changed the way people communicate and socialize globally. Millennials (individuals between the age of 13-30), in particular, find social networking natural and comfortable. Importantly, this generation does not simply regard these systems as intriguing innovations of the digital era; instead, they are considered integral components of their lifestyle, used every day in their social lives and searches for knowledge and understanding. Accordingly, it would be desirable to have systems and methods for the delivery of e-learning education courses and/or training programs that not only support course management, but that also build on this new communication paradigm and, thus, focus on student engagement, collaboration, and activities above and beyond what students can do in a face-to-face classroom. Furthermore, it would also be desirable that such systems and methods support interconnected, searchable content from global users, and are also user-intuitive, rewarding to use, and readily customizable. Such systems and methods should additionally not only facilitate ease of interaction with students and instructors, but also be easy to interface with legacy systems to facilitate ease of use and implementation.

### BRIEF SUMMARY

In at least one exemplary embodiment of a system for facilitating user collaboration and communication across a network-based learning environment, the system comprises a plurality of user devices (each associated with a user having one or more interests), at least one server computer in communication with each of the user devices over a network, and an environment supported by the server in which information is capable of being published. The server computer comprises a processor in communication with at least one storage device. The environment additionally comprises a means for facilitating interaction between the users in the environment, such means comprises at least social networking features. Additionally, the system comprises means for allowing a first user to enter and publish content in the environment to create a first entry (the first entry visible to at least one of the other users), and a means for analyzing the first entry and identifying a subject matter indicia therein. In at least one embodiment, the means for analyzing the first entry is executed by the processor. Additionally or alternatively, the subject matter indicia may be selected from a group consisting of a hashtag published within the content of the first entry, a metatag associated with the first entry, and a label.

The first and second users may or may not have a formal association with each other on the system. Furthermore, the at least one server computer is configured to make the first entry available to those users having at least one interest that correlates with the subject matter indicia of the first entry. In at least one embodiment of the system, the first entry may be associated with defined access permissions and the at least one server computer is further configured to make the first entry available to the one or more users only if such users satisfy the access permissions.

In at least one embodiment, the system may further comprise a means for allowing a second user to create a second entry by entering and publishing reflective content in the environment in response to the first entry, wherein the second entry is associated with the first entry in the environment and available to at least the first and second users. In yet another embodiment, the system may further comprise a means for allowing each user to publish a visual portfolio comprising one or more graphical icons. In such embodiments, each of the graphical icons may be indicative of a credential or experience of the relevant user, and at least part of the visual portfolio may be visible to at least one of the other users.

Certain embodiments of the system for facilitating user collaboration and communication across a network-based learning environment may additionally comprise: a means for a user to award a certification badge to another user; and a means for automatically publishing the awarded certification badge to the visual portfolio of the awarded user. In such embodiments, the awarding user may be designated as an instructor of a course delivered via (at least in part) the environment, with the awarded user registered in the course. Additionally or alternatively, the system may further comprise a translation application configured to translate the first entry from a first language into a second language and to dynamically learn user preferences.

Other embodiments of a system for facilitating user collaboration and communication across a network-based learning environment are also disclosed. In at least one such embodiment, the system comprises a plurality of user devices (each associated with a user having one or more interests), at least one server computer in communication with each of the user devices over a network, and a learning environment configured for the publication of information. Here, the learning environment of the system comprises one or more social networking features to facilitate interaction between the users in the environment and an incentive application. The incentive application is configured to promote user participation in the environment by tracking and quantifying the participation of one or more users in the environment in terms of one or more participation parameters, and crediting a reward to a user in response to such user satisfying the one or more participation parameters. In addition to the aforementioned, in at least one embodiment, the incentive application is additionally configured to receive and consider input from a second user on the participation of a first user for consideration in quantifying the participation.

In at least one embodiment, user participation in the environment comprises one or more activities selected from the group consisting of creating content, publishing content in the environment, interacting with other users using the social networking features of the environment, reflecting on content published to the environment by other users using the social networking features of the environment, and participating in an activity associated with an online course. Perhaps more specifically, participation in the environment may comprise publishing content in the environment and/or reflecting on content published to the environment by other users. Furthermore, the one or more participation parameters may comprise a quality component such as a minimum number of words that must be associated with the content or content reflection, or some other quality standard. Still further, the incentive application may be configured to receive and consider input from a second user on the participation of the first user for consideration in quantifying the participation.

The reward credited by the incentive application may comprise a points-based reward. In at least one embodiment of the system, the amount of the point-based reward credited to the user is cumulative over a prescribed period of time. In such embodiments, the one or more participation parameters may also additionally comprise one or more goal values and the incentive application may be configured to dynamically assess the cumulative number of points credited to a user during the prescribed period of time as compared to the one or more goal values to achieve a status value for the user and provide the user with a feedback notification of the status value. Additionally, the incentive application may further comprise a means to provide the user with one or more feedback notifications of the status value within the prescribed period of time.

Additionally or alternatively, the environment may comprise an online course and the one or more participation parameters may be defined by an instructor of the online course. In such an embodiment, if the reward comprises an amount of points, such amount may be prescribed by the instructor.

In an exemplary embodiment of a method for facilitating user collaboration and communication across a network-based learning environment, the method comprises the steps of defining one or more participation parameters for one or more users of a learning environment; tracking the one or more users' participation in the learning environment; quantifying the participation of each user in terms of the one or more participation parameters to achieve an outcome associated with each user; and if the outcome of a user satisfies a predetermined goal, awarding a reward to the user. In at least one additional embodiment, the method further comprises the step of displaying the outcome of a user, wherein the color red in the display is indicative of an unsatisfactory outcome with respect to the predetermined goal and the color green in the display is indicative of a satisfactory outcome with respect to the predetermined goal. In yet another embodiment, the participation parameters and the predetermined goal are established by an instructor and/or the reward comprises a point-based reward. If the reward is a point-based reward, the amount of points awarded to the user may be cumulative over a prescribed period of time. Furthermore, in such embodiments of the method, the one or more participation parameters may additionally comprise one or more interim goals and the method may further comprise the steps of: dynamically assessing the cumulative number of points awarded to a user during the prescribed period of time as compared to the one or more interim goals to achieve a status value for the user; and providing the user with one or more feedback notifications of the status value within the prescribed period of time.

Additionally or alternatively, in at least one additional embodiment, user participation in the environment may comprise one or more activities selected from the group consisting of creating content, publishing content in the environment, interacting with other users through the environment, reflecting on content published to the environment by other users, and participating in an activity associated with an online course. In yet another embodiment, one or more of the participation parameters comprises a quality component and the step of quantifying the participation of each user further comprising assessing the quality of the participation of the user in terms of the one or more participation parameters.

In yet another exemplary embodiment, a method for providing educational services and facilitating user collaboration and communication across a network-based environment is disclosed. Such method comprises the steps of: receiving a request from one or more users to access a network-based learning environment; providing a plurality of groups to users over a network, each of the groups having at least one subject matter focus; assigning, using a processor, at least one category value to each group pursuant to the subject matter focus of the group; associating one or more of the users with one or more of the groups; receiving a first content from a first user in connection with such user's participation in a first group; and making the first content available to those users of the learning environment that are associated with the groups having the same category value as the first group. In at least one embodiment, the groups of the method may comprise an online course, a massive open online course, or an interest group. Additionally or alternatively, the step of assigning at least one category value to each group of the method is automatically performed by the processor using word analytics or may alternatively comprise a user creating a new category value and assigning the new category value to a group. In those embodiments of the method where a user creates a new category value, the method may additionally comprise the steps of: monitoring for the creation of new category values; identifying the new category value; comparing the new category value with existing category values; and accepting or denying the new category value based the degree of difference between the new category value and the existing category values. In yet another embodiment of the method, if the new category value is denied, the method may further comprise the step of assigning at least one existing category value to the group pursuant to the subject matter focus of the group.

Furthermore, the aforementioned method may optionally also comprise the step of providing social networking tools for interaction between the users within the network-based learning environment, wherein the content is received from the user in connection with the user's use of the social networking tools.

Additionally, the content referenced in the method may, in at least one embodiment, comprise a post or educational resources. Further, the method may additionally comprise the step of making content associated with a second group visible to the users of a third group despite the second and third groups having different category assignment values.

Additional embodiments of the aforementioned method may further comprise the steps of: receiving a second content from a second user in response to the first content of the first user; and making the second content available to those users of the learning environment that are associated with the groups having at least one like category value as the first group. In such cases, the first and second users may or may not be associated with the same group and may or may not be collocated. For example, in at least one exemplary embodiment, the first and second users are not associated with the same group, are not collocated, and comprise global classmates.

Furthermore, in at least one embodiment, the learning environment additionally comprises an automated assignment tool and a gradebook tool. In such embodiments, the aforementioned method may further comprise the steps of: generating one or more task items using the automated assignment tool, each of the task items associated with one of the groups; identifying resources and content associated with each task item; providing a link in each task item to the identified resources and content; and, where a task is identified as gradable, interfacing the automated assignment tool with the gradebook tool such that a corresponding category is created in the gradebook tool for each task item. Still further embodiments of such methods may additionally comprise the step of creating one or more subcategories for a task item using the automated assignment tool or the step of assigning one or more access permissions to one or more task items. In the event the method comprises the step of assigning one or more access permissions to one or more task items, the access permission for the one or more task items may be conditional based on calendar dates or other task items being completed by the user. Furthermore, each task item may comprise a series of instructions. In such embodiments, the method may optionally further comprise the steps of: assigning a status of complete to the task item; and creating a record in the category of the gradebook tool that corresponds with the task item, the record relating to the completed instructions. Still further, the step of associating a grade with the record in the category of the gradebook tool may be performed.

Where the learning environment of the aforementioned method additionally comprises automated assignment and gradebook tools, in yet another embodiment, the method may further comprise the steps of: interfacing the automated assignment tool with a dropbox tool; uploading content to a task item using the automated task tool; transferring the uploaded content to the dropbox tool; and creating a record in the category of the gradebook tool that corresponds with the task item, the record relating to the uploaded content.

In certain embodiments of the method, each group is associated with a particular sub-environment of the learning environment that is not accessible to users not associated with the group. Additionally or alternatively, the method may further comprise the steps of: creating one or more subset groups within a group; and assigning one or more of the users of the group to one or more of the subset groups. Still further, the method may additionally comprise the steps of: defining one or more user roles for one or more of the users associated with a group; and defining access permissions associated with each of the user roles. For example, in such embodiments, the user role can be selected from, for example, the group consisting of student, teaching assistant, graduate student, course coordinator, external reviewer, instructional designer, librarian, academic liaison, professional mentor, field expert, and audit student.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a screenshot of an exemplary embodiment of a login page of the course networking system hereof.

FIGS. 4A-4E are screenshots of a homepage, and various components thereof, that is designed for use in connection with an exemplary embodiment of a course networking system.

FIG. 5 is a screenshot of a Conexus page as used in connection with an exemplary embodiment of a course networking system.

FIG. 6A is a screenshot of at least one embodiment of a profile page as used in connection with an exemplary embodiment of a course networking system.

FIGS. 6B-6D are screenshots of at least one alternative embodiment of a profile page used in connection with an exemplary embodiment of a course networking system.

FIG. 7 is a screenshot of a window for use in establishing the parameters of Personal Network functionality in connection with an exemplary embodiment of a course networking system.

FIGS. 8A-8O are screenshots of various tools and feature sets that may be incorporated within a course page in connection with an exemplary embodiment of a course networking system.

FIGS. 9A and 9B are screenshots representative of posts from Global Classmates incorporated within a course page in connection with an exemplary embodiment of a course networking system.

FIGS. 10A-10G are screenshots representative of posts and post creation functionalities available in connection with an exemplary embodiment of a course networking system.

FIG. 11 is a screenshot of a post published using an exemplary embodiment of a course networking system.

FIGS. 12A and 12B are screenshots of components related to a sorting tool of an exemplary embodiment of a course networking system.

FIG. 12C is a screenshot of a display showing a word analytics result related to an additional sorting tool of an exemplary embodiment of a course networking system.

FIGS. 13A-13C are screenshots representative of course creation functionality of an exemplary embodiment of a course networking system.

FIGS. 14A-14E are screenshots representative of various customization settings available in connection with an exemplary embodiment of a course networking system.

FIGS. 15A-15E are screenshots representative of various post management options, and the results thereof, that are available in connection with an exemplary embodiment of a course networking system.

FIG. 16 shows a flow chart of an exemplary embodiment of a method for facilitating user collaboration and communication across a course networking system.

FIG. 17 shows a flow chart of an exemplary embodiment of a method for comprehensive content sorting and dissemination using a course networking system.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is intended, with any additional alterations, modifications, and further applications of the principles of this disclosure being contemplated hereby as would normally occur to one skilled in the art. Accordingly, this disclosure is intended to cover alternatives, modifications, and equivalents as may be included within the spirit and scope of this application as defined by the appended claims. While this technology may be illustrated and described in a preferred embodiment, the systems, methods, and techniques hereof may comprise many different configurations, forms, materials, and accessories.

For example, the systems, methods and techniques of the present application will be described in the context of a networking model that facilitates user engagement, collaboration and activities to ultimately achieve an effective and expansive educational environment. However, it should be noted that the systems, methods, and techniques of the present application apply in a wide variety of contexts including, but not limited to, business applications and professional continuing education.

In the following description, numerous specific details are set forth in order to provide a thorough understanding of the present disclosure. Particular examples may be implemented without some or all of these specific details. In other instances, well known process operations and/or system configurations have not been described in detail so as to not unnecessarily obscure the present disclosure.

Various techniques and mechanisms of the present disclosure will sometimes describe a connection between two components. Words such as attached, affixed, coupled, connected, and similar terms with their inflectional morphemes are used interchangeably unless the difference is expressly noted or made otherwise clear from the context. These words and expressions do not necessarily signify direct connections, but include connections through mediate components and devices. Indeed, it should be noted that a connection between two components does not necessarily mean a direct, unimpeded connection, as a variety of other components may reside between the two components of note. For example, a workstation may be in communication with a server, but it will be appreciated that a variety of bridges and controllers may reside between the workstation and the server. Consequently, a connection does not necessarily mean a direct, unimpeded connection unless otherwise noted.

Furthermore, wherever feasible and convenient, like reference numerals are used in the figures and the description to refer to the same or like parts or steps. The drawings are in a simplified form and not to precise scale.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be kept in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the embodiments of the present application; the operations are machine operations. Indeed, a human operator could not perform many of the machine operations described herein due, at least in part, to the networking and vast distribution capabilities of the present disclosure.

Useful machines for performing the operations of one or more embodiments hereof include general purpose digital computers or other similar devices. In all cases the distinction between the method operations in operating a computer and the method of computation itself should be recognized. One or more embodiments of the present application relate to methods and apparatus for operating a computer in processing electrical or other (e.g., mechanical, chemical) physical signals to generate other desired physical manifestations or signals. The computer and systems described herein operate on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present disclosure also relate to an apparatus or specific hardware for performing the disclosed operations. This apparatus and/or hardware may be specifically constructed for the required purposes or it may comprise a general purpose computer or related hardware as selectively activated, employed, or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact (e.g., in at least one embodiment, the computer programs use a set of predefined APIs (defined below)). In particular, various general purpose machines may be used with programs written in accordance with the teachings herein, or it may prove more convenient to construct at least one more specialized apparatus to perform the required method steps. The required structure for a variety of these machines will appear from the description below.

Embodiments of the present invention may deal with “object-oriented” software, and particularly with an “object-oriented” operating system. The “object-oriented” software is organized into “objects,” each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages may be generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “API” relates to a set of computer instructions and associated data which can be activated directly or indirectly by the user. The terms “windowing environment,” “running in windows,” and “API-oriented operating system” are used to denote a computer user interface in which information is manipulated and displayed on a video display such as within bounded regions on a raster scanned video display. The terms “network,” “local area network,” “LAN,” “wide area network,” or “WAN” mean two or more computers which are connected in such a manner that messages may be transmitted between the computers. In such computer networks, typically one or more computers operate as a “server,” which run one or more applications capable of accepting requests from clients and giving responses accordingly. Servers can run on any computer including dedicated computers, which individually are also often referred to as “the server” and typically comprise—or have access to—large storage devices (such as, for example, hard disk drives) and communication hardware to operate peripheral devices such as printers, webcams, or modems. Servers can also be configured for cloud computing, which is Internet-based computing where groups of remote servers are networked to allow for centralized data storage. Such cloud computing systems enable users to obtain online access to computer services and/or other resources despite such users' potentially diverse geographic locations.

Other computers, termed “workstations” or “clients,” provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of APIs with associated settings for the user associated with the desktop. When the desktop accesses a network resource, which typically requires an application program to execute on the remote server, the desktop calls an Application Program Interface, or “API” to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a worldwide network of computers, namely the “World Wide Web” or simply the “Web.” Examples of Browsers compatible with one or more embodiments described in the present application include, but are not limited to, the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details operations in terms of a graphic user interface of a Browser, it will be understood that one or more embodiments disclosed in the present disclosure may be practiced with text based interfaces, voice or visually activated interfaces, or any other interfaces now or hereinafter developed that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an API, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant” or “PDA,” as defined above, means any handheld, mobile device that combines computing, telephone, fax, e-mail and/or networking features. The terms “wireless wide area network” or “WWAN” mean a wireless network that serves as the medium for the transmission of data between a handheld device and a computer. The term “synchronization” means the exchanging of information between a first device (e.g., a handheld device) and a second device (e.g., a desktop computer), either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone, PDA, tablet, wearable or smartphone. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

“PACS” refers to Picture Archiving and Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format) and the like, once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

In the following specification, the term “social network” may be used to refer to a multiple user computer software system that allows for relationships among and between users (individuals or members) and content assessable by the system. Generally, a social network is defined by the relationships among groups of individuals, and may include relationships ranging from casual and/or professional acquaintances to close familial bonds. In addition, members may be other entities that may be linked with individuals such as, for example, universities or educational institutes. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Conventional examples of social networks include, but are not limited to, facebook, twitter, myspace, linkedin, and other systems. The exact terminology of certain features, such as associations, fans, profiles, etc. may vary from social network to social network, although there are several functional features that are common to the various terms. Thus, a particular social network may have more or less of the common features described above. In terms of the following disclosure, the general use of the term “social network” encompasses a system that includes one or more of the foregoing features or their equivalents.

To aid in understanding the novel concepts presented herein, a brief overview of a course networking system 300 and its functionality will now be described, followed by more detailed descriptions of the components thereof and its underlying system architecture and computing environments. In general, the systems, methods and techniques disclosed herein provide a dynamic platform for educators and businesses to employ a networking-based approach to course management and/or training through the use of social networking models. The systems, methods and techniques hereof not only support course management, but also generate new learning and information distribution opportunities using social networking and collaboration as a foundational basis for education in an online environment. Such systems, methods and techniques provide a unique, multi-purpose infrastructure that, in addition to the foregoing advantages, can also vastly expand the distribution of (and a user's access to) relevant knowledge through social media-like platforms, provide entertainment, and provide professional networking capabilities via, in at least one embodiment, a credential system and a dynamic and verifiable visual resume.

For example, in at least one embodiment, an educational institution may establish a course on the system, which its students (as users of the system) may then join either in conjunction with a physical class held at the institution or an online course (MOOC or otherwise). The exemplary system disclosed herein then provides the student users with a social networking-based environment through which they can access resources that are relevant to the course and also interact with each other and their instructor in a meaningful way that is authentic in the context of their interests, needs and social perspectives. Specifically, the core interactions between users of the system may involve users reviewing and reflecting on each other's postings, thereby allowing for a type of peer review that facilitates effective understanding and learning. As such, the course networking system described herein may be used to provide socially-mediated learning that is rewarding, engaging and entertaining for its users.

Additionally, in at least one embodiment, the system also facilitates communication between the students and other individuals interested in a like course topic on a global level. For example, students may select to have visibility to postings and feedback from “global classmates.” As used herein, a student's “global classmates” are those other users of the system who may be from around the world and that have either a) indicated an interest in the topic of the particular course being taken by the student, and/or b) are enrolled in a course on the system that is categorized in the same category as the student's course. Indeed, in at least one embodiment, the systems provided herein are operated as a publicly available website on the Internet (e.g., a full API-based system), that may be accessed by anyone, whether they are affiliated with a particular institution or business entity or not. This provides a powerful and dynamic resource base of ideas and cross-cultural knowledge that may be drawn upon by any user of such systems. Furthermore, in order to facilitate meaningful use of the vast amount of information made available through the course networking systems hereof, the systems can assess and utilize user interests, actions, associations, affiliations, ranking by peer review, and/or characteristics to provide personalized content and, in at least one embodiment, targeted advertisements, to a user. Furthermore, the systems may incorporate content labeling methodologies that use hashtags, tags, or the like, for example, to facilitate the moderation of online discussion threads and enable content searching.

Accordingly, use of the systems, methods and techniques hereof is beneficial to both institutions and students as they provide a platform for individuals across the world to disseminate information, gain meaningful access to helpful/relevant resources and collaborate on like-topics in an effective, efficient and meaningful way.

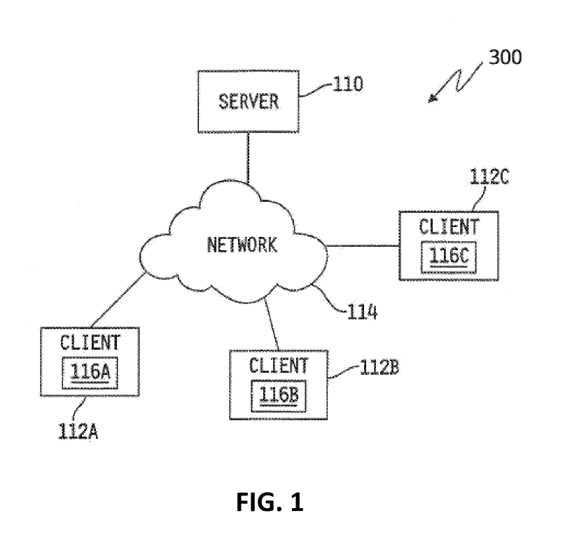

Now referring to the system architecture of the present disclosure, FIG. 1 is a high-level block diagram of a computing environment through which aspects of a presently disclosed course networking system and methods may be implemented. FIG. 1 illustrates a course networking system 300 of the present disclosure comprises one server 110 and three clients 112 connected by network 114. One or more users (not shown), such as users or administrators (as described in further detail herein), can access the system via the one or more clients 112. Specifically, in at least one embodiment, the system 300 of the present disclosure is configured such that one or more users can access the particular functionality of and/or data stored within the server 110 via a user interface (not shown) and the network 114. The computing environment may be configured similarly to a multi-user site in that numerous parties may register and/or access the server 110 via multiple—and commonly remote—clients 112. The server 110 is operatively coupled with the clients 112 over a network 114 or networking infrastructure. For example and without limitation, the network 114 may be operatively coupled with clients 112 via the Internet, intranet or other connection.

It will be appreciated that only three clients 112A, 112B, and 112C are shown in FIG. 1 in order to simplify and clarify the description and the same is not intended to be limiting. Indeed, embodiments of the computing environment may have thousands or millions of clients 112 connected to network 114, for example the Internet. Likewise, while only one server 110 is depicted in FIG. 1, the computing environment may comprise a plurality of servers 110.

The clients 112 may each comprise one or more network accessible devices that are capable of executing one or more applications and/or accessing a web-based system through a Browser. A client 112 may be any type of workstation such as, for example, any type of computer, computing device, or system of a type known in the art such as a personal computer, mainframe computer, workstation, notebook, tablet or laptop computer or device, PDA, mobile telephone or smartphone, wearable, or any other computing or communications device having network interfaces (wireless or otherwise). Additionally, users (not shown) may operate software 116 on one or more of clients 112 to both send and receive messages over the network 114 via server 110 and any of its associated communications equipment and software (not shown). Further, clients 112 may each comprise hardware and componentry as would occur to one of skill in the art such as, for example, one or more microprocessors, memory, input/output devices, device controllers, and the like. Clients 112 may also comprise one or more input devices that are operable by a user of the client 112 such as, for example, a keyboard, keypad, pointing device, mouse, touchpad, touch screen, microphone, camera, webcam, and/or any other data entry means (or combination thereof) known in the art or hereinafter developed. Furthermore, client 112 may also comprise visual and/or audio display means for displaying or emitting output. For example, a client 112 may comprise a CRT display, an LCD display, a printer, one or more speakers, and/or any other types of display or output devices known in the art or hereinafter developed. The exact configuration of each client 112 in any particular implementation of a course networking system hereof may vary between clients 112 and may be left to the discretion of the practitioner.

As shown in FIG. 1, each client 112 is connected to, and/or in communication with, the server 110 via a network 114. The network 114 providing access to and/or serving as part of an exemplary course networking system 300 of the present disclosure comprises any means for interconnecting the server 110 and a client 112. In at least one exemplary embodiment, the network 114 comprises the Internet, a global computer network. Alternatively, the network 114 may be selected from a variety of different networks and/or cables including, but not limited to, a commercial telephone network, one or more local area networks, one or more wide area networks, one or more wireless communications networks, coaxial cable(s), fiber optic cable(s), and/or twisted-pair cable(s). Additionally, the network 114 may comprise equivalents of any of the aforementioned, or combinations of two or more types of networks and/or cables.

Furthermore, in at least one embodiment where the server 110 and a client 112 comprise a single computing device operable to perform the functions delegated to both server 110 and a client 112 according to the present disclosure, the network 114 may comprise the hardware and software means interconnecting the server 110 and client 112 within the single computing device. Accordingly, the network 114 may comprise packet-switched facilities (such as the Internet), circuit-switched facilities (such as the public-switched telephone network), radio-based facilities (such as a wireless network), or any other facilities capable of interconnecting a client 112 with the server 110. Additionally, the clients 112 and/or wired/wireless connections may include the appropriate safeguards to ensure that the transmission of data between the server 110 and each client 112 is secure.

It will be appreciated that where the computing environment comprises a plurality of clients 112, such clients 112 need not all comprise the same type of client 112 or be in communication with the network 114 and/or server 110 via the same type of communication link. As such, the computing environment 100 may comprise some clients 112 configured to connect to/communicate with the server 110 via the Internet, for example, while other clients 112 are connected to the server 110 via a wired connection (e.g., a cable).

The course networking system 300 of the present disclosure may be implemented through any appropriate application architecture pattern now known or hereinafter developed. In at least one exemplary embodiment, the interpretation system 300 is delivered through an n-tier architecture in which presentation, application/business logic, and data management functions are logically and/or physically separated. This application architecture pattern provides benefits in the way of increasing availability of the system 300 to its users (i.e. reduced downtime), the minimization of the impact of any component failure, and through facilitating disaster recovery. Additionally, if desired, third party applications may be interfaced with the system 300 and provided to system users without sacrificing data security as such third party applications need not be in direct communication with the data structures of the system 300.

As described above, the clients 112 of the computing environment each comprise a user interface (not shown) to facilitate a user's input into and access to the functionality of and/or data stored within the server 110. The user interface can be any interface known in the art that is appropriate to achieve such a purpose and is fully customizable. For example, the display and content of the user interface may be customized for particular categories of users such that the course networking system 300 can provide standardized user interfaces having features and functionality that are specifically tailored to its different types of users' needs.

The user interface may be local to a client 112, provided over the network 114, or stored within the server 110. In at least one embodiment, the user interface comprises a web-based portal that provides functionality for accessing and displaying data stored within the server 110. In at least one exemplary embodiment, the user interface comprises a mobile application and/or widget designed to run on smartphones, tablet computers, wearables, and other mobile devices.

As previously described, one or more clients 112 can be operably connected to and/or in communication with the server 110 of the system 300's computing environment. In general, the system 300 supports at least two categories of “users”—administrators and individuals—that can logon and access the course networking system 300 via the client(s) 112. It will be noted that an individual-user may comprise a student, an instructor, or any other individual that uses the system 300 to facilitate learning (whether or not in connection with an organized course or a specific institution), while an administrator plays an operational or governance role. For the avoidance of doubt, when the term “user” is used herein, it shall mean an individual-user as opposed to an administrator, unless indicated otherwise.

The course networking system 300 is not limited geographically. Users from all over the world can participate, if desired, as there is no inherent restriction as to the number of users who can access and use the course networking system 300 at a single time. The configuration of the system 300 uniquely exploits this worldwide reach within the organized, course delivery structure thereby allowing for an expanded distribution of knowledge and users' access thereto. In at least one exemplary embodiment, the course networking system 300 is delivered as an open platform environment, where anyone with access to the Internet may register as a user of the system 300. Accordingly, by entering a publicly available website such as www.thecn.com, a user can register and gain access to the functionality provided, and learning environment fostered, by the course networking system 300. As such, use of the course networking system 300 allows for the elimination of traditional classroom walls and supports learning as open, free and collaborative, consisting of interconnected content from postings and intercultural collaborations throughout the world.

In at least one embodiment, the system 300—or components thereof—is managed by one or more administrators, which may be individuals, educational institutes, business entities, institutions of higher learning and/or representatives of the foregoing. In this manner, the system 300 facilitates support of a substantial number of users across an institution or a system of institutions. An administrator may have broad security credentials and/or access permissions that provide it, for example, with access to data stored in the system 300 and/or the ability to run and view data analytics based on user activity and course participation. Furthermore, the administrator may: distribute announcements to a user base; enable or disable system 300 functionality with respect to all or select users; customize components, functionality and/or features of the system 300 itself; establish default settings with respect to courses and different user roles; define baseline and other parameters used in determining subject-matter and/or like-interest associations between users and other applications; and terminate or suspend a user's account. In this manner, large volumes of users and courses may be managed efficiently and effectively.

For example and without limitation, if an educational institute, business entity, or institution of higher learning decides to employ the course networking system 300 hereof in connection with the curriculum offered to its students (hereinafter referred to as a “System Client”), at least one administrator may be appointed to such System Client's account and thus be able to customize aspects of the system 300 for use in connection with any users associated with that System Client. In at least one embodiment, an administrator is an employee of the System Client and his or her security credentials and administrative rights are limited to only those users of the system 300 who are registered or otherwise associated with that particular System Client on the system 300. In this manner, an administrator can establish and customize the presentation and functionality of the course networking system 300 as applied to a defined group of users (i.e. those associated with the System Client), and subsequently oversee such users' subsequent use of the system 300.

Notwithstanding the aforementioned, the course networking system 300 hereof may be configured such that users may also have some level of administrative credentials with respect to certain aspects of the system 300. For example, and as is discussed in further detail below, the system 300 can be configured such that a user can customize and set parameters with respect to courses, groups, etc. that he or she is instructing or may have established through operation of the system's 300 various tools. In at least one embodiment, where a user is an instructor of one or more courses on the course networking system 300, such user may have some ability to the customize the components, functionality and/or features of the system 300 that are related to those particular courses.

In at least one embodiment, the course networking system 300 is configured such that each System Client, and/or each subcategory thereof (such as a department or campus), may create and maintain its own customized environment within the course networking system 300. For example, each System Client may acquire an exclusive “channel” within the system 300 that provides a fully customizable, integrated and complete learning management system having strategic system tools; a massive open online course (MOOC) platform, including MOOC-to-credit capabilities for courses with thousands of simultaneous members; and/or campus-wide or global academic social networking services. Use of the channels also provides a level of security to each System Client. For the avoidance of doubt, any number of independent channels, as well as independent users not associated with any particular channel, may be supported by the system 300 concurrently.

One or more administrators may be associated with each channel, such that the administrator(s) can customize the presentation and functionality of the system 300 pursuant to System Client preference. For example, an administrator may establish and/or define the default settings related to the channel, information settings, those individuals/users who are to be granted access to the channel of the system 300, and/or the specific analytical data he or she would like to see collected and/or computed with respect to the System Client's users and/or system 300 usage.

Use of a channel in connection with the course networking system 300 allows for the integration of the system 300 with existing System Client systems, databases and other resources. For example, where a System Client is a university, the university's course catalog can be uploaded and integrated into the System Client's channel such that it is readily accessible to all of the System Client's associated users. Furthermore, a channel provides for information security. Similar to a course catalog, sensitive information (such as, for example, student personally identifiable information) can be uploaded to and made available through the System Client's channel. In at least one embodiment, the course networking system 300 can automatically upload and manipulate database information (either using cache server pages technology or other applications known in the art), assesses the uploaded information, and automatically perform one or more identified tasks.

In at least one embodiment, this data integration capability can be applied as a batch enrollment functionality. For example, the course networking system 300 may comprise a means for creating user accounts from an existing file of individuals associated with an external computer. In application, this functionality may be used for batch enrollment and, in one example, may be employed to automatically create system 300 accounts for individuals associated with a System Client (“System Client members,” which may be, for example, students enrolled with the System Client or, where the System Client is a business entity, employees thereof) and/or enroll specifically-identified system 300 users in courses.

Specifically, the course networking system 300 can upload and assess a System Client's existing database containing the names and profile information its System Client members using CSV file upload or other similar technologies. Based on this data, the system 300 automatically creates user accounts associated with the System Client's channel for each of the System Client members, and thereafter contacts such individuals with their account and login information. Use of such a batch enrollment capability enables existing System Client legacy systems having a large number of members stored therein to be conveniently and efficiently integrated within the system 300 without manual data entry. In another or additional application, this functionality can be used to easily incorporate an up-to-date list of courses into the system 300, along with all of those students who are registered for each course.

The server 110 is capable of multiple functionalities that may be customized according to a particular application of the system 300. As described in more detail below, the server 110 may be configured to categorize users and create focused subsets of users based on subject matter or other parameters, enable users to create a promotional homepage and other materials, enable administrators to establish online course materials and create a course homepage, and publish and make such homepages/materials available to the appropriate system 300 users. Additionally, the server 110 may also facilitate direct communication between users through the system 300. Furthermore, in at least one embodiment, the server 110 may be configured to incorporate an MOOC engine capable of integrating with for-credit, online courses.

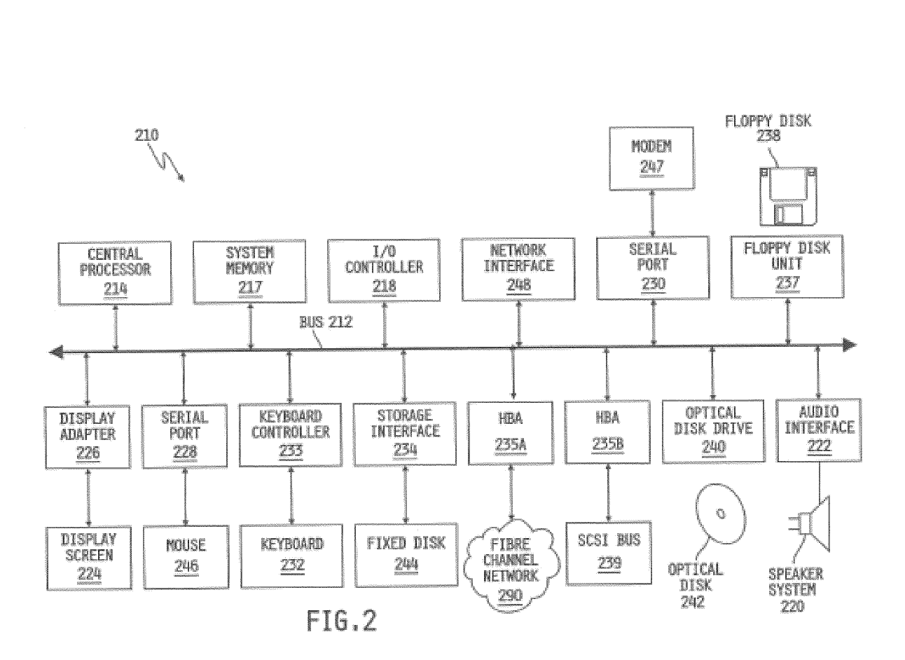

Now referring to FIG. 2, a block diagram of a computer system 210 suitable for implementing the course networking system 300 via server 110 or client 112 is shown. Computer system 210 includes bus 212 that interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, HBA interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Furthermore, devices and subsystems may be interconnected in different ways from that shown in FIG. 2. Operation of a computer system such as that shown in FIG. 2 is readily known in the art and is not discussed in detail in this application. Software source and/or API specifications to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art will recognize that a signal may be directly transmitted from a first block to a second block, or a signal may be modified (e.g., amplified, attenuated, delayed, latched, buffered, inverted, filtered, or otherwise modified) between blocks. Although the signals of the certain embodiments described herein are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Specific functionality of the systems, methods and techniques of the present application will now be described in further detail. As previously discussed generally, the course networking system 300 employs a social networking and interactive approach to education. In at least one exemplary embodiment, the course networking system 300 not only supports online course creation and management, but also generates new learning opportunities using social networking and collaboration as a foundational basis for learning. Furthermore, the course networking system 300 can be used to provide professional networking opportunities using the same social networking and collaboration functionalities.

Course networking system 300 comprises a novel learning and course management system that provides an environment configured to support and facilitate the open, free and collaborative learning through its underlying social networking-based structure. In part, the course networking system 300 comprises a learning platform for providing users with virtual access to course creation and management tools; online courses; course content; tests, homework, assessments, assignments, and other tasks to be completed by a user (collectively, “tasks”); grades; and other resources (both external and otherwise). Furthermore, the course networking system 300 integrates the concept of social networking into this learning platform, such that users (students and instructors, for example) can present themselves (through profiles or otherwise), locate other users having common interests and/or affiliations, and easily and comfortably interact with other users through communication modules and other applications. Accordingly, the course networking system 300 comprises a number of integrated feature sets, customizable depending upon the desired end-use of the system 300. Such feature sets may appear as a set of distinct tools or features that, when integrated, offer unique functionality to system 300 users.

In general, the course networking system 300 provides for the exchange of content and related information between users (non-collocated or otherwise). Formal courses may be offered over the system 300—either where the courses are conducted online in their entirety (i.e. no corresponding physical class) or where such online courses and other functionality are complementary to a class held in a physical learning environment (i.e. “blended learning”). Additionally or alternatively, business entities may utilize the course networking system 300 for employee training, certification, continuing education purposes and the like. Likewise, individual users may utilize the course functionality of the system 300 to conduct and/or participate in a course that is not affiliated with any particular school or business.

The course networking system 300 provides various personal and customizable social networking applications through which users can engage in educational and collaborative learning with others from around the world. One example of such a customizable social networking tool is the Conexus—or group discussions or forums—functionality provided by the system 300, which allows for groupings of like-interest users in a structure that is less formal than a course (described in further detail below).

The various feature sets of course networking system 300 will now be described in detail, using screenshots of embodiments of graphic user interfaces (“GUIs”) for explanatory purposes in some cases. It will be understood that these GUIs are simply examples of various embodiments of the system 300 and are not intended to be limiting in any manner. Indeed, unless otherwise expressly stated herein, it will be understood that the specific GUIs used with a course networking system 300 are fully customizable in accordance with the requirements and desires of a user.

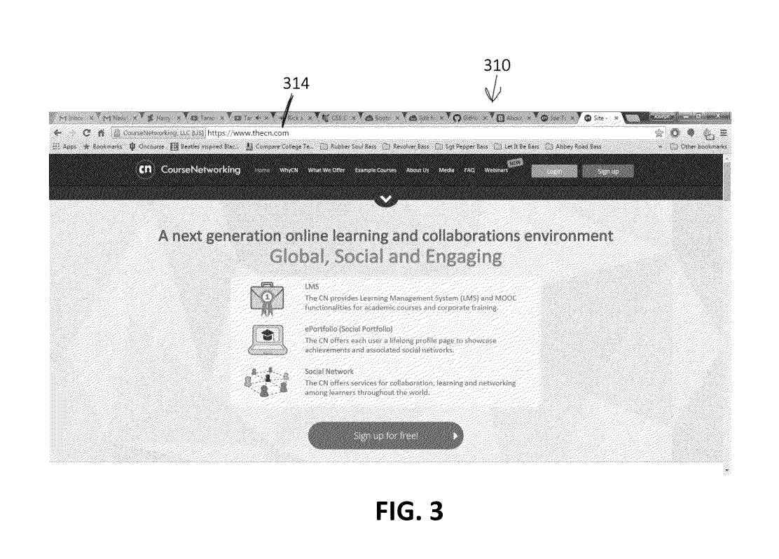

FIG. 3 shows a screenshot of at least one embodiment of a GUI login page 310 for the course networking system 300 that a user will view. The login page 310 comprises various input fields 312 where a user can provide a value as is known in the art (i.e. text field where the user is to enter his or her username and password to gain access to the system 300). As previously discussed, the course networking system 300 may be a cloud-hosted web application that is capable of serving millions of users located throughout the world. As such, the course networking system 300 may be hosted on a cloud environment such as Amazon Elastic Compute Cloud or other similar services such that it is operated as a publicly available website on the Internet that may be accessed by anyone via a web address 314, whether they are affiliated with a System Client or not. Accordingly, anyone with access to the Internet can create an account and access the course networking system 300.

A prospective user of the system 300 can create an account through the login page 310. In this at least one embodiment, the prospective user need not have any particular affiliation to establish an account; access to and use of the system 300 is available to any individual worldwide. Additionally or alternatively, as previously described, user accounts may be automatically created through use of a batch enrollment functionality (e.g., where a university desires to create system accounts for its students).

Each user account created may be assigned certain access credentials. For example, a user that is unaffiliated with a university or other organization may be assigned a standard set of credentials that permits such user to access only a baseline amount of information or data through the system 300. Conversely, those users who are associated with a particular institution may be assigned a different set of credentials, thereby enabling them to access institution-specific information. For example, System Clients may elect to restrict access to their information, courses and resources to only those users of the system 300 that have particular credentials (e.g., System Client members or users that are in good standing as a registered student with or current employee of the relevant institution, etc.). Such restrictions can be achieved through the use of a channel, as previously described, or through other means known in the art. Furthermore, a user's account on the course networking system 300 may be linked with another previously established social networking or other Internet-based account of that user (e.g., Twitter® or Facebook®) to facilitate ease of account set up. In such an embodiment, integrated social plugins from the desired social networking sites may be incorporated into the design of login page 310 (not shown).

During account creation, the course networking system 300 assigns each user a unique identifier for user identification purposes. Unique identifiers may comprise any identifier that is capable of identifying each individual user to the system 300 and/or distinguishing such user from other users. In at least one exemplary embodiment, the identifiers are assigned pursuant to an algorithm that assigns two alphabetic characters representing the user's first and last initials, followed by two numeric characters formulated based on the sequential order in which the user's initials have been previously assigned. For example, the user identifier JS20 represents a user having the initials J.S., where such user was the twentieth user having those initials to create an account on the system 300.

It will be appreciated that unique identifiers can be used for more than simple user login purposes. For example, where every user has their own personal profile page, the system 300 can incorporate the unique identifier into the URL associated therewith pursuant to a predetermined convention (e.g., inserting the username at the end of the homepage URL following a backslash—www.thecn.com/js20). In this manner, users can easily navigate the course networking system 300 to quickly and efficiently arrive at a particular user's profile page simply by knowing such user's unique identifier and plugging it into the naming convention. Such unique identifiers can also be used to “tag” (or identify) users in postings as well, which will be discussed in further detail herein.

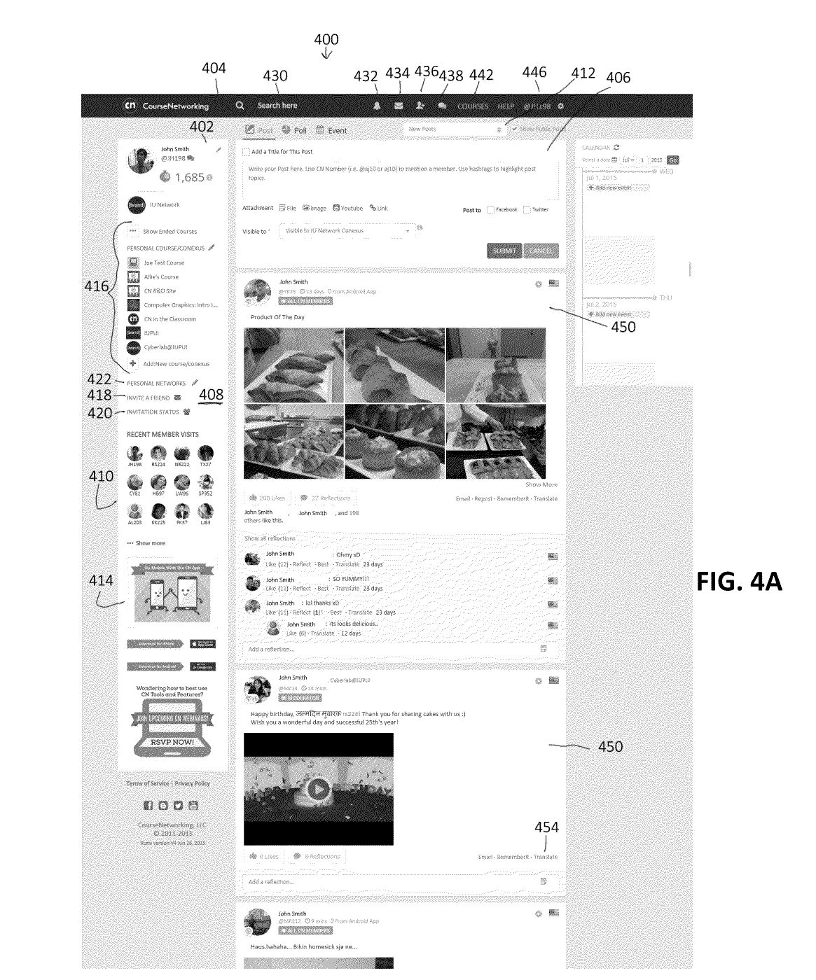

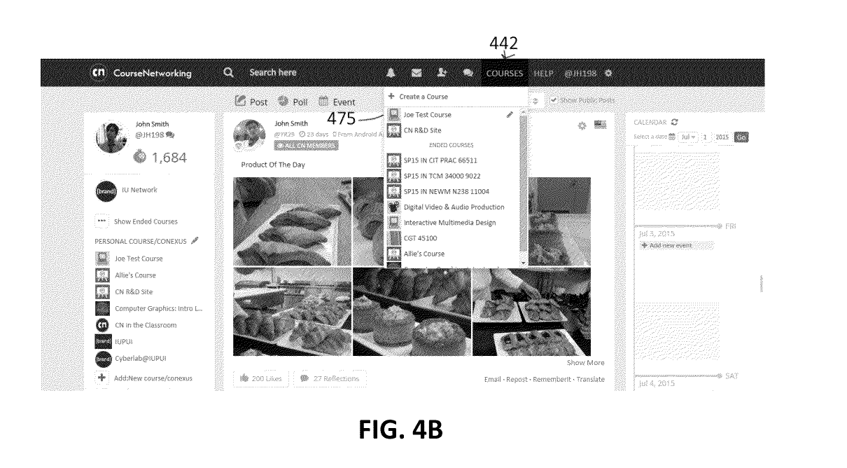

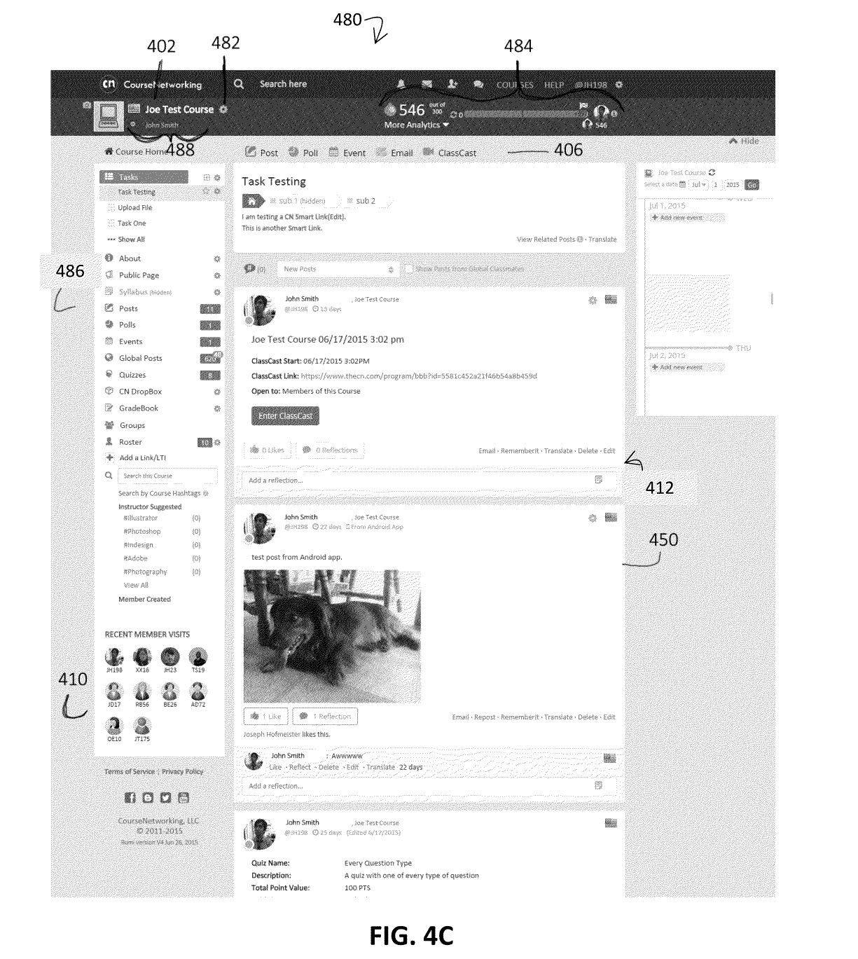

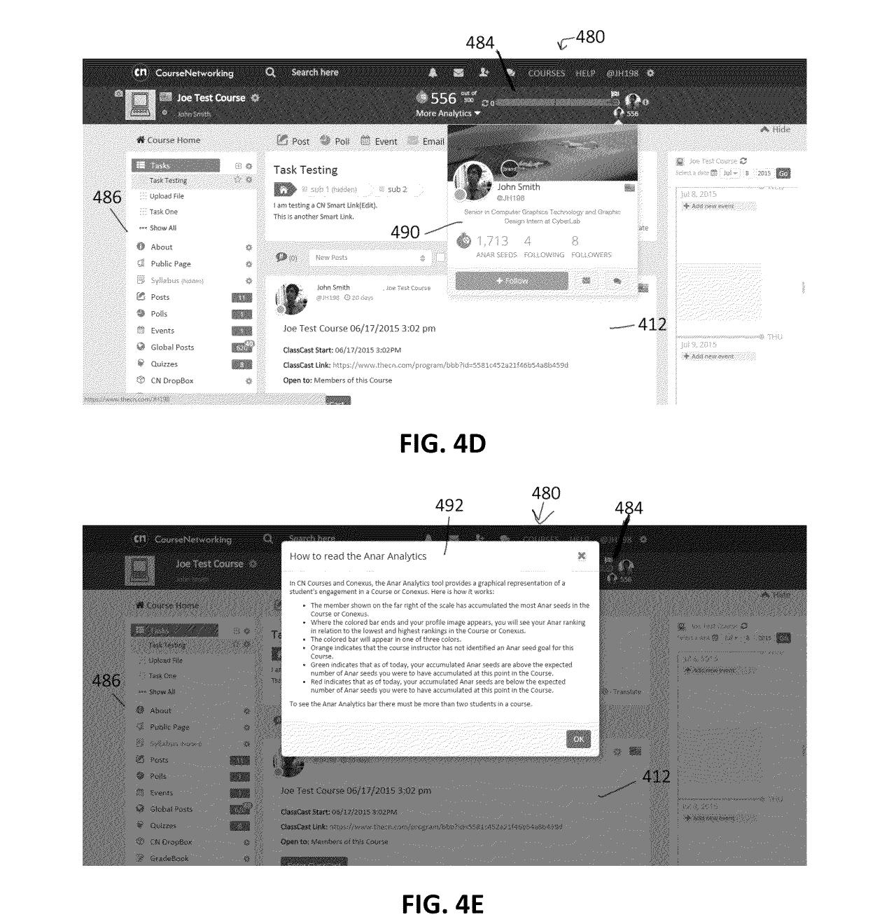

Now referring to FIG. 4A, a screenshot of a user homepage 400 is shown. In at least one embodiment, the homepage 400 is customizable in accordance with the requirements and/or desires of any user or, alternatively, an administrator. The homepage 400 provides a user with direct access to personal, course and/or System Client-specific tools.

Upon logging into the system 300, a user is directed to his or her homepage 400. As the system 300 recognizes the user via the unique identifier or otherwise, the system 300 automatically identifies information associated with that user and populates the user's homepage 400 with information that is both relevant and specific to that particular user. For example, upon login, the system 300 immediately identifies the user's user-established associations (defined below, but including for example the groups, Conexus, courses, other users, Personal Networks, etc. on the system 300 with whom the user has a relationship) and displays the same, as well as any information associated therewith, in an easily accessible format.

FIG. 4A shows at least one model of how such information can be organized and displayed via the homepage 400. As illustrated in FIG. 4A, the homepage 400 may comprise an information window 402, a navigation toolbar 404, a posting toolbar 406, a user-established associations window 408, a user window 410, and a post display window 412. Additionally, in at least one embodiment the homepage 400 may further comprise one or more advertisement windows 414.

The information window 402 may provide information regarding the user who is currently logged in and accessing the system 300. The homepage 400 may also comprise one or more indicators for displaying information regarding, as well as links and menus for accessing, the various functionalities of the system 300. Specifically, in at least one embodiment, one or more links to communication and other applications of the system 300 (including, but not limited to, notifications indicator/link 432, unread messages indicator/link 434, colleague requests indicator/link 436, chats received indicator/link 438, RememberIt tool link (not shown), courses menu link 442, homepage link (not shown), and user settings menu 446) are incorporated into the homepage 400 via the navigation toolbar 404. These links may enable access to one or more feature sets of the system 300 as a whole (e.g., opening the email communication application) or, in at least one exemplary embodiment, links and/or menus may be provided that allow a user to go directly and specifically to a portion of the underlying application (e.g., directly accessing all unread messages 434 or chats received 438, as opposed to the email or chat applications, respectively, as a whole). The use of specific links on the homepage 400 facilitates user convenience and ease of access by reducing the number of clicks, and instruction or experience, needed to navigate to the system 300.

Information and links relating to at least a portion of the user's user-established associations may be displayed in the user-established associations window 408. As shown in FIG. 4A, the user-established associations window 408 may include: a Course and Group Shortcut Menu 416 that is customizable to display those courses and/or groups most accessed or otherwise selected by the user; a system invitation link 418 for inviting third parties to register with/join the course networking system 300; one or more status links 420 for displaying the status of any outstanding invitations or other pending requests; a Personal Network link 422 for creating a Personal Network (as described in more detail herein); and/or one or more resource links (not shown), which can include links to viewable and/or downloadable documentation, information or other reference materials. Furthermore, the user window 410 may display links to other users of the course networking system 300. Additionally, the homepage 400 may also display what System Client(s) the user is associated with (if any) and any System Client-specific information (not shown).

The homepage 400 may also comprise a posting toolbar 406 for creating and/or viewing a user's own posts and/or e-mail, and a post display window 412 for displaying other users' posts 450. It will be appreciated that, as used herein, the term “post” encompasses several categories of postings, which include, but may not be limited to, informational-type posts, polls, and events. As shown in FIG. 4A, the homepage 400 may comprise one or more buttons for creating each of these specific types of posts.

The post display window 412 may display a feed of posts 450, presented in chronological order pursuant to when posted or, alternatively, organized in another manner. As will be described in further detail herein, upon user login, the system 300 automatically populates the post display window 412 with posts 450 from not only the user's identified user-established associations, but also from any user of the system 300 where a post 450 has been identified by the publishing user as “Public” and identified by the system 300 as relevant to the user's subject matter interests. Accordingly, the post display window 412 can provide a user with access to a vast amount of relevant information.

In at least one embodiment, the system 300 is capable of arranging posts 450 within each user's post display window 412 in accordance with user-type hierarchies. For example, the system 300 may be configured such that posts 450 published by an instructor of a course in which such user is enrolled display at the top of the post display window 412 irrespective of when or if such posts 450 were published before other classmate users' posts 450. In such example, posts 450 published by other users (classmates, etc.) are displayed in chronological order below the instructor-posts 450. In this manner, the system 300 can clearly display the most pertinent information and eliminate the need for sifting through displayed content.

The presentation of the information on the homepage 400 can be organized in any order and/or fashion to facilitate ease of accessibility and use. For example, as shown in FIG. 4A, the users displayed in the user window 410 may be organized in terms of most recently online, and the course and Group Shortcut Menu 416 may be populated pursuant to user preference. Moreover, the general layout of the homepage 400 is fully customizable. While it may be presented consistently to all users of the course networking system 300, it is also contemplated that it may be customized pursuant to individual user preference or specifically for System Client channels such that it is consistent for all users across a particular channel.

The homepage 400 can provide direct access to a user's courses, Conexus and/or other groups of which he or she is a member. By selecting the “Courses” menu link 442, a user is provided with a menu of his or her courses, which provides direct links to the courses that they teach and/or in which they are or were enrolled (see menu 475 of FIG. 4B). To access a course page, the user need only click on the course title to be automatically linked to the environment in the system 300 associated with that course (i.e. the “course page”). The user may also search the courses available on the system 300 by selecting the “Search for Course” link 477 in the courses menu link 442, at least one embodiment of which is illustrated in FIG. 4C.

For example, by selecting the link 475 for the desired course (here, “Joe Test Course”), which the user in this example is teaching, the user is shown the course page 480 illustrated in FIG. 4C. Course page 480 comprises several of the same components as homepage 400 and like numerals used between the Figures are representative of like components. For example, similar to homepage 400, course page 480 may comprise an information window 402, navigation toolbar 404 (not shown in FIG. 4C), posting toolbar 406, user window 410, and a post display window 412 displaying one or more posts 450. However, it will be appreciated that certain components of the course page 480—such as information window 402, user window 410, and post display window 412—are specific to the course, rather than a user (as with homepage content).

Indeed, the information window 402 displays information specific to the course including, without limitation, the course name and number, the number of members enrolled in the course, identification of the course creator, an image associated with the course, and—where the user is the instructor of the course—a settings link 482. Similarly, instead of being populated with all of the users of the system 300, the user window 410 only includes thumbnails and links to those users enrolled in the course.

In addition, the course networking system 300 provides certain functionality that is specific to the courses provided thereon and, thus, only accessible via a course page 480. Accordingly, in addition to the standard links (Post, Poll, Event, Email), the posting toolbar 406 of a course page 480 may also links to course-specific functionality (Tasks, ClassCast, Quiz, etc.), which will be described in more detail below. In addition to those components a course page 480 has in common with the homepage 400, course page 480 further comprises a link to participation management data (e.g., window or toolbar 484), tool set window 486, and user-specific information window 488.

Within a course page 480, a user is able to access all relevant course material and available feature sets. For example, as shown in FIG. 4C, the tool set window 486 may comprise links to informative and/or functional components associated with the course such that, upon selection, the relevant information is displayed (in a separate browser window or otherwise) or the desired application is initiated. As illustrated in FIG. 4C, in at least one embodiment of the course page 480, the tool set window 486 includes links to the course syllabus, any external webpage associated with the course and/or educational institute, a general description of the course, a class roster, and other tools. Furthermore, user-specific window 488 displays information specific to the particular user accessing the course page 480—namely, his or her status with respect to the course (here, the user is an instructor), action links relating to the user's and others' membership in the course, and an invitation status notification link.

Now referring to FIGS. 4D and 4E, embodiments of a participation management window 484 are shown. Generally, participation management window 484 displays information and analytics relevant to any incentive program that may be provided in connection with a course. For example, in at least one exemplary embodiment of the course networking system 300, the system 300 comprises a rewards tool that may optionally be utilized in connection with any course. There, the participation management window 484 may provide a representation (graphical or otherwise) of a student's engagement in that course including, for example, a number indicative of the rewards points accumulated by that user on the course page 480. In at least one embodiment, this may include the display of a point scale, that student's ranking as compared to other students' participation in the course, and/or a colorized comparative analysis of the student's accumulated course participation as compared to a predetermined participation goal as a function of time (elements shown in red when the goal has not been met and green when the goal has been achieved). For example, the screenshot of FIG. 4E illustrates an informative pop-up box 492 associated with a rewards program depicted in the participation management window 484 of FIG. 4D. Specifically, the informative pop-up box 492 provides that the member shown at the far right of the scale shown in FIG. 4D (here, evidenced by user profile pop-up window 490) has accumulated the most points in this course. Additionally, in at least one embodiment, the informative pop-up box may also be configured to display the average amount of points earned by all students of the course (not shown).

The rewards tool of the system 300 comprises an online mechanism for promoting active student involvement and engagement in the online course and/or Conexus environment and, thereby, facilitates the learning experience. In one course-specific embodiment, a student is awarded points (termed “Anar Seeds” in FIGS. 4C-4E) in connection with his or her active participation in social learning and collaborative aspects of the system 300 as they relate to a course provided therethrough. The course networking system 300 can track and display all of the points earned by each student in connection with a particular course that is utilizing the tool. Additionally or alternatively, the system 300 may track the points earned by a user in connection with their participation across the course networking system 300 as a whole, which may be separately displayed on a user's homepage 400 in the user information window 402, for example.

Conceptually, the underlying purpose of the rewards tool is to facilitate a user's meaningful engagement in a course. What constitutes meaningful engagement or participation may vary from course to course and between different instructors; it is contemplated that the rewards tool and the manner in which it is implemented are fully customizable. For example, in at least one embodiment, an instructor may establish a goal for students to obtain a certain number of points before the end of the semester or some other determined period of time. If students reach the goal, the instructor may opt to provide some form of a reward (e.g., a bonus item with an extra credit award such as a 5% bonus points for accumulating 500 Anar Seeds by the end of the term). Additionally or alternatively, the rewards tool may be used as a participation tracking mechanism, with a portion of the course grade dependent upon a student satisfying the prescribed goal (e.g., 40% of the course's grade). As such, accumulated points may be incorporated into the overall grading structure for a course. Furthermore, in at least one embodiment, the rewards tool may be configured to automatically assess a student's participation and determine their ultimate course grade therefrom.

Students may earn points through the rewards tool in a variety of ways. Activities that are eligible for earning points and/or point allocation levels may be automatically defined by the system 300 or manually established by the course instructor or, for example, an administrator. In at least one embodiment, activities that earn users points may include authoring and publishing posts 450, creating YouTube videos, interacting with classmates, participating in online quizzes, reflecting on other users' posts 450, etc. Furthermore, points may also be awarded in accordance with the quality of a user's participation in the online course (e.g., the quality of their posts 450 and/or other provided content), which can be measured subjectively by an instructor or, for example, in terms of the amount and/or quality of feedback/reflections such post 450 generated from other users. In at least one embodiment, an instructor can require that any student posts 450 must contain a minimal number of words in order to be eligible for earning rewards. Additionally or alternatively, awards may be based on peer review or, in other words, how fellow students rate a user's collaborative involvement in the course. For example, in at least one embodiment of the system 300, a “Post of the Week” may be awarded in connection with a course or Conexus pursuant either to student selection or some other selection criteria. There, an instructor may configure the rewards tool to automatically award any Post of the Week recipient with bonus points. Accordingly, the rewards tool can integrate quality controls such that students are not rewarded for minimal effort. In this manner, the rewards tool can be utilized to promote active user participation in a course or Conexus.

In at least one embodiment, the rewards tool may further incorporate notification and analytic functionalities. If an instructor chooses to utilize the rewards tool in connection with a course, weekly notifications may be provided to every student in the course to indicate how their total point accumulation compares to the expected number at that point during the term (above, below or meeting the standard). The rewards tool is also capable of dynamically assessing each student's points and automatically comparing the same against instructor-predetermined parameters. In this manner, students can track their progress with respect to point accumulation by viewing the progress bar shown on their course page 480 in participation management window 484 (see FIG. 4D). Student participation tracking information may be kept private between the student and instructor, or may be made available publicly and/or to other students in the course.

It will be appreciated that this reward functionality is not limited to use in connection with school-based courses. Indeed, it may be applied with respect to user participation in a Conexus and/or to professional accreditation and continuing education. In at least one embodiment, the rewards tool may incorporate the concept of certificates. For example, if a user earns a certain number of points through meaningful participation in the course networking system 300, he or she will be awarded a certificate.

Briefly referring back to FIGS. 4A and 4B, accessing a Conexus and/or other groups through the homepage 400, and the related pages, will now be described. A user can access a Conexus page by either selecting the “My Conexus” link within the user-established association window 408 of the homepage 400, or by selecting the title of a particular Conexus if the same is included within the Group Shortcut Menu 416. The user may also search Conexus available on the system 300 by, for example, selecting a search functionality in the courses menu link 442.

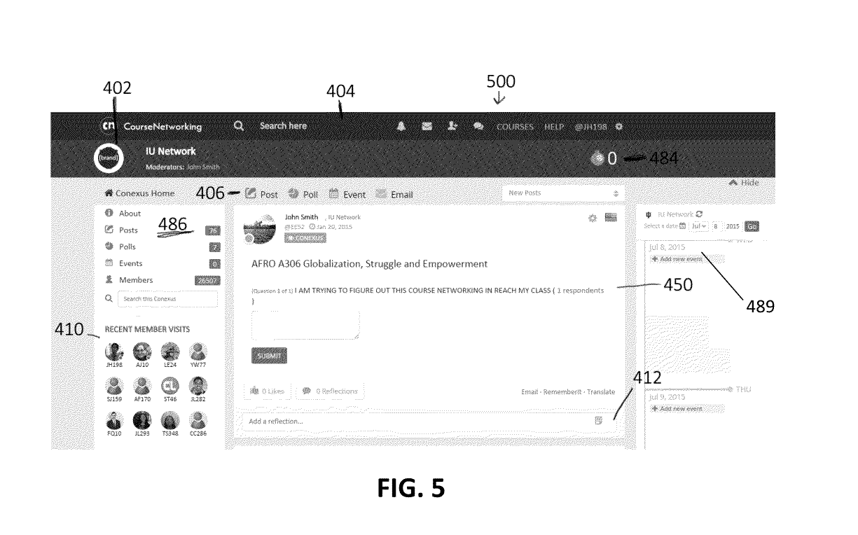

FIG. 5 illustrates at least one example of a Conexus page 500. Conexus page 500 comprises several of the same components as homepage 400 and course page 480 and like numerals used between the Figures are representative of like components. For example, similar to homepage 400 and course page 480, Conexus page 500 comprises an information window 402, navigation toolbar 404, posting toolbar 406, user window 410, a post display window 412 displaying one or more posts 450, participation management window 484, tool set window 486, a user-specific information window 488 (not shown) and/or a calendar 489. However, it will be appreciated that the content within such components of the Conexus page 500 are specific to that Conexus. For example, the information window 402 displays information specific to the Conexus including, without limitation, the Conexus name and number, the number of members of the Conexus (not shown), identification and contact information for the Conexus moderator, an image associated with the Conexus, and—where the user is a moderator of the Conexus—a settings link (not shown).

Within a Conexus page 500, a user is able to access all relevant material and available feature sets. For example, as shown in FIG. 5, the tool set window 486 may comprise links to informative and/or functional components associated with the Conexus such as a description of the Conexus, posts 450 (informational-type, poll-type and event-type, as applicable) published through the Conexus, as well as a Conexus Roster and number of members.

The functionality available through the course networking system 300 will now be described in detail. The course networking system 300 comprises a variety of feature sets, which are distinct tools that, when integrated into the system 300 and its various components (such as, for example, courses and Conexus), provide for unique functionality and learning opportunities for a user. General categories of system 300 feature sets may include content management and delivery tools, comprehensive communication and collaboration tools, personalized social networking features, assessment and rewards systems, categorization and pairing features, and personal information tools. Furthermore, more sophisticated feature sets may be provided that comprise a combination of one or more of the above-described features or tools.

Access to the majority of the feature sets of the networking course system 300 is provided in one place—the homepage 400—in order to deliver a user-friendly design and facilitate user convenience. Additionally, in at least one embodiment, the toolbar 420 has links to such functionality and may be a set frame across the environments of the system 300 such that it is consistently displayed in one location, regardless of the page currently being accessed by the user (e.g., the homepage, a course page, etc.). This approach provides a consistent user interface to facilitate ease of use of the system 300.

Now referring to the various feature sets of the course networking system 300, specific descriptions and working examples will be provided to facilitate understanding. However, it will be appreciated that these descriptions and examples are not limiting as any number of modifications may be made to the same. Accordingly, any similar functionality that is related to or corresponds with the specific embodiments described herein may be incorporated into the system 300 and is intended for inclusion in the present disclosure.

Generally, the content management and delivery tools of the course networking system 300 allow users to enter and/or upload information to the course networking system 300 that can optionally be shared with other users. Text may be typed directly into a form, or existing files and/or databases may be accessed and uploaded to the system 300. Documents such as word processing files, spreadsheets, slide presentations, graphics, audio and video clips, etc. may also be uploaded. For example, course instructors may post course documents, course information, staff information, tasks/assignments, etc. Furthermore, streaming multimedia may be provided to promote interactivity between the students and the course. In at least one embodiment, the content management and delivery tools described herein may be native to the system 300 and/or utilize integrated third party applications such as, for example, DropBox®, YouTube®, Adobe Flash Media Server, Ampache®, Firefly Media Server, QuickTime Broadcaster, and the like.

One specific application of this content management and delivery functionality is the creation and display of social and/or professional portfolios of users—otherwise known as user profiles—as is common with conventional social networking applications. Specifically, user profiles can be created and/or modified in connection with the creation of a user account, or at any time thereafter, typically provide descriptive information regarding that user, and represent the user in the system 300. However, unlike conventional systems, the user profiles of the course networking system 300 may be used by users of the system 300 and/or the system 300 itself to form very specific associations between users, which will be described in further detail below. Additionally, and as also described in further detail below, the course networking system 300 can utilize the data captured by the system 300 in connection with the user profiles and/or associations in a variety of ways, including to drive personalized content to a user.

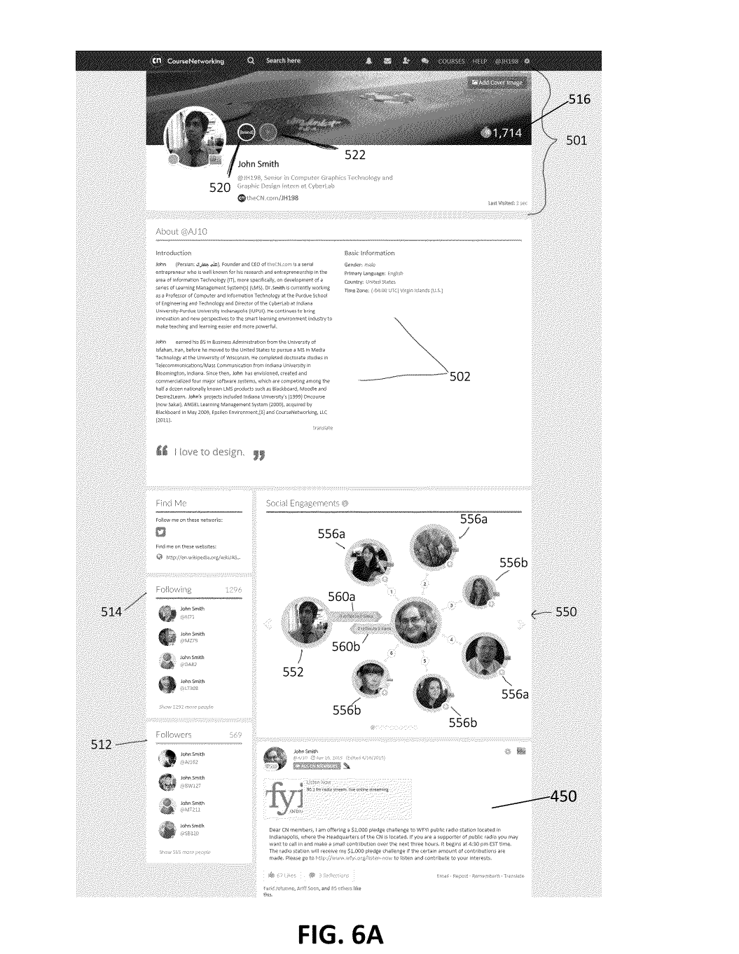

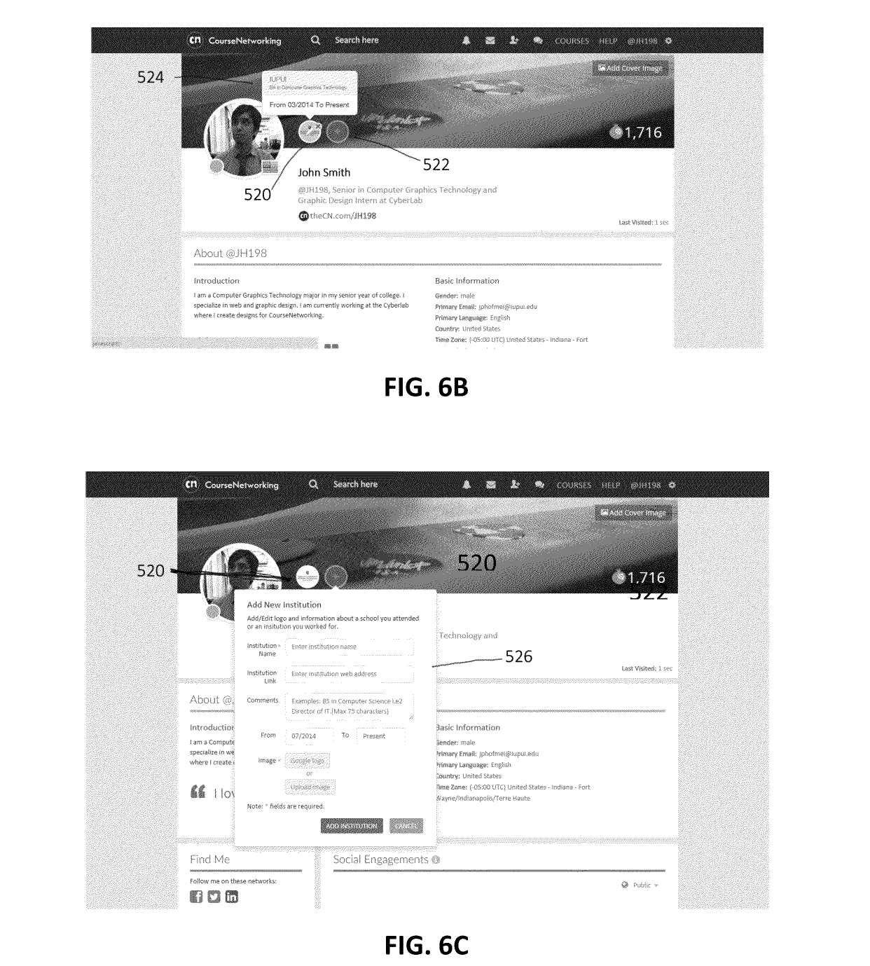

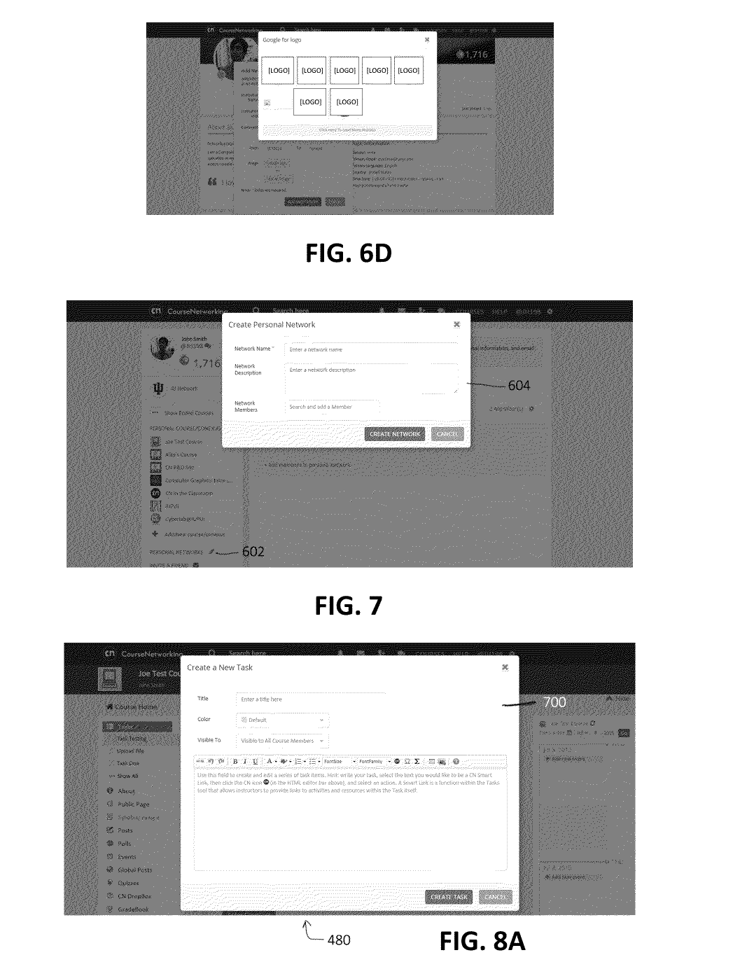

In at least one embodiment, each profile within the course networking system 300 may contain entries, and each entry may comprise information associated with that user's profile. FIG. 6A illustrates at least one example of a user profile 501 of the course networking system 300 having a variety of entries 502. Examples of entries for a personal profile may comprise contact information such as an email addresses, mailing address, instant messaging (or IM) name, Twitter® handle, website or phone number, personal information such as gender, languages spoken, birth date, age, ethnicity, religion, political view, current location, hometown location, passions and interests, tag lines, and/or activities; professional and/or education information such as universities or other educational institutes with which the user is affiliated/enrolled, skills, career, employer, or job description; photographs of a person or other graphics associated with an entity; or any other information or documents describing, identifying, or otherwise associated with a profile. In at least one exemplary embodiment, an entry may comprise a user explicitly expressing an interest in a concept or subject matter. Entries for a business profile may comprise industry information such as market sector, customer base, location, or supplier information; financial information such as net profits, net worth, number of employees, stock performance; or other types of information and documents associated with the business profile.

A user profile may also contain rating information associated with that specific user. For example, as shown in FIG. 6A, information regarding a user's number of colleagues (not shown), number of other users following that user (rating value 512), and/or number of other users that user is following in the system (rating value 514) may be displayed. The user may also be rated or scored by other users of the social network in specific categories, such as subject-matter expert, senior adviser, advanced, experienced, proficient, seasoned, skillful, intermediate, skilled, beginner, and novice (not shown). A user's category ratings may be contained in the member's profile.

As previously noted, in at least one embodiment of the course networking system 300, a user may have followers. Followers may be other users of the system 300 who have indicated an interest in—i.e. that they are “followers” of—the user. Rating information may also include the number of followers of a user and identifiers of the followers. Rating information may also include the rate at which a user accumulated ratings or followers and how recently the user has been rated or acquired followers. In yet other embodiments of the course networking system 300, the rating information can be modified for use in conjunction with the rewards system to facilitate and track user participation in the system 300 and/or specific activities associated therewith (like, for example, use of online course materials and/or participation in discussions). Furthermore, the number of rewards points accumulated by a user may be displayed in connection with the user's profile (see rating value 516 of FIG. 6A).

As previously described, users (and, by extension, their profiles) may be affiliated with one or more specific institutions, universities, System Clients, etc. on the course networking system 300. While, in such cases, the affiliated users may be afforded specific credentials associated with such affiliations (e.g., such that they can access certain Course pages, etc.) and their content/profile may be accessible and/or otherwise visible to other similarly-affiliated users of the system 300, it will also be appreciated that this does not necessarily mean that their profiles are only accessible and/or viewable by such like affiliations. Indeed, depending on user preference, a user profile—or parts thereof—may be accessible to and/or otherwise viewable by other users of the system 300 who are not similarly affiliated.

Such potential for system-wide profile visibility can be extremely beneficial to a user in several contexts, perhaps the most notably of which is for professional networking. This is especially true considering that the course networking system 300 hereof can support a vast and diverse array of users from all over the world. However, the flip-side to such a large group of users is that this necessarily creates ever-increasing amounts of information to sort through and digest. Accordingly, especially in the context of professional networking where, on average, employers spend 18 seconds viewing each resume they receive, it is critical that a user can adequately convey his or her credentials and experience in a comprehensive and easily digestible format.

FIGS. 6A-6D illustrate at least one embodiment of a user profile design that is configured to address this issue and, thus, facilitate professional networking via the system 300. The profile shown in FIG. 6A utilizes a visual-centric design that leverages the rationale that a symbol or picture is much quicker and easier for an individual to interpret that text-based information. Perhaps more specifically, while the visual profile—or “e-portfolio”-hereof can include some amount of text-based information regarding the underlying user, the profile also displays one or more graphical icons 520 that visually communicate a user's credentials. In at least one embodiment, the graphical icons 520 are displayed in a designated and prominent position on the user profile.

Each graphical icon 520 of the system 300 is configured to display a visual logo that may be selected by the user. In at least one exemplary embodiment, a user can use the graphical icons 520 of the profile page to display one or more visual logos that are representative of a quality and/or credential of such user. For example, a user may select to display the logo of his or her school(s) (to indicate degree therefrom or in progress), his or her previous/current employer(s) (indicative of experience), and/or any academic or industry credentials (to indicate particular skills and/or responsibilities). The graphical icons 520 may also be used to convey any certificates or recognitions the user has received. While such profiles can also contain text-based entries to further expand on the visually-displayed information, because such descriptions are provided by way of icons or logos as opposed to text-based, an employer can quickly review and comprehend a user's portfolio in one glance.

Furthermore, the graphical icons 520 may also be designed to convey some additional information via text, albeit in a condensed format. For example, as shown in FIG. 6B, if a mouse is moved over a graphical icon 520, a data window 524 conveying some information regarding such résumé item may be displayed. In this manner, a user may quickly review another user's profile and obtain a comprehensive understanding of such user's academics, credentials, and work experience, without investing a lot of time in reading paragraphs of text.

In at least one exemplary embodiment, a user may customize which categories of users can see which graphical icons 520 are displayed on his or her profile. For example, if the user is applying for an open position at a technology company, he or she may designate that employer-users of the course networking system 300 may only view his or her graphical icons 520 associated with those certifications/qualifications relevant to technology and hide any less relevant and/or social certifications therefrom. Accordingly, it will be understood that a user has a large degree of control over how his or her profile page is displayed via the system 300, including which graphical icons 520 are visible to whom. Such a diverse and customizable platform provides numerous benefits, at least one of which is that a user may employ a single platform for both business and personal use.

As shown in FIG. 6C, placeholder icons 522 may also be included on the profile page. Note that while the placeholder icons 522 may be visible to the user who owns the profile, the placeholder icons 522 may not be visible to other users of the system 300 (those users would only see graphical icons 520). In at least one embodiment, selecting a placeholder icon 522 results in a drop-down menu 526 where a user can enter the appropriate data regarding the desired graphical icon 520. Furthermore, and as illustrated in FIG. 6D, a search engine (may be integrated with the drop-down menu 526 (either via Google API or otherwise) such that a user can easily search for and select a logo to display in connection with the graphical icon 520. In this manner, the placeholder icons 522 can be configured to dynamically obtain logos from a network or other source (e.g., the Internet) to facilitate a user's addition of a graphical icon 520 to his or her profile page.

In at least one embodiment, the course networking system 300 may facilitate interaction between user profiles and/or allow for the designation of one or more associations or relationships therebetween such as, for example, colleague, follower, co-worker, family member, business associate, classmate, common-interest association, and common-geography association. Associations may also include intermediary relationships, such as colleague of a colleague, and degree of separation relationships, such as three or more degrees away. Associations between user profiles may also be reciprocal associations; for example, a first user may invite another user to become associated with the first user and the other user may accept or reject the invitation. A user may also categorize or weigh the association with other user profiles, such as, for example, by assigning a level to the association. For example, for a friendship-type association, the user may assign a level, such as acquaintance, friend, good friend, and best friend, to the associations between the user's profile and other member profiles. Additionally or alternatively, for an association relating to an educational institute, the users may be assigned a level such as administrator, instructor, teacher's assistant, or student. In certain instances, forming an association with another user in the course networking system 300 may allow such users greater access to communicate with each other.

To provide information on a user's associations and one or more particular relationships between users, the course networking system 300 can run engagement analytics on the data captured by the system 300 with respect to a user's profile and/or associations. Referring back to FIG. 6A, a visual representation 550 is shown that depicts the relationship or association between two users of the system 300 resulting from such engagement analytics. While a particular type of graph is displayed in FIG. 6A, it will be appreciated that any type or configuration of visual representation 550 may be employed (including, but not limited to, a chart), provided it is easy to read and understand.

The visual representation 550 of two users' relationship can be automatically accessed by a user anytime one user (the “visiting user 552”) visits another user's (the “viewed user 554”) user profile 501 or otherwise indicates that the relationship between the two users should be analyzed. FIG. 6A illustrates at least one example of a visual representation that a visiting user 552 might see upon viewing the viewed user's 554 profile. The visual representation 550 may include information specific to the visiting and viewed users' 552, 554 interactions and relationship with each other. For example, the visual representation 550 of FIG. 6A includes interaction summaries 560a, 560b, which provide information relating to how many times the visiting user 552 has reflected upon and/or liked the viewed user's 554 content (560a) and how many times the viewed user 554 has reflected upon and/or liked the visiting user's 552 content (560b).

Furthermore, in at least one embodiment, a summary bar 562 (not shown) may be included with the visual representation 55—that displays the number of other users—or associations—connected to the viewed user 554. In this at least one embodiment, each individual association of the viewed user 554 is depicted as an image positioned around the viewed user's 554 image (each a “viewed user's association 556”). Accordingly, a visiting user 552 can easily see and interpret the visual representation 550 of a visited user's 554 interactions and relationship on the system 300. For convenience, only a select number of visited user's associations 556 may be displayed at one time (here, six at a time), and the summary bar 562 can be used to navigate through the remainder. Along these lines, those interactions and relationships displayed in the visual representation 550 may be selected by the system 300 as those that, based on the engagement analytics, appear to be the most relevant to the visiting user 552.

Each of the viewed user's associations 556 may be assigned a relationship status icon 564a, 564b. The value of the relationship status icon 564a, 564b identifies whether or not a viewed user's association 556 also has a relationship with the visiting user 552 on the system 300. For example, where the visiting and viewed users 554, 552 have an association in common, a check icon 564a may be associated with such contact, whereas when the visiting user 552 does not have a relationship with one of the viewed user's associations 556, a plus sign icon 564b may be displayed. It will be appreciated that these relationship status icons 564a, 564b may also have link functionality such that, for example, if a visiting user 552 selects the plus sign icon 564b associated with one of the viewed user's associations 556, the system 300 will automatically route the visiting user 552 to functionality that enables the visiting user 552 to request the formation of an association with that particular viewed user's association 556 directly.

In addition to information relating to the direct connection between the visiting and viewed users, the visual representation 550 can also be used to convey levels of user engagement in the course networking system 300. User engagement on the system 300 can be tracked and/or measured in terms of the points a user accumulates through one or more rewards programs (described in further detail below), or in any other manner. The size of the images depicting each of the viewed user's association 556 in the visual representation 550 corresponds with the engagement level of each viewed user's association 556 over the course networking system 300. For example, in FIG. 6A, those viewed user's associations 556a depicted with larger images are the users who are more active on the system 300 (i.e. have a higher level of engagement). On the contrary, viewed user's association 556b is depicted with the smallest image, which indicates that that this user has the lowest amount of engagement with respect to the other viewed user's associations 556 displayed. Accordingly, the system 300 is capable of automatically ranking each viewed user's association's 556 engagement and conveniently displaying the same to a visiting user 552 in a manner that is easy to read and understand.

A user profile may also contain activity data associated with the user. User information may include information about a user's login patterns to the system 300, such as the frequency that the user logs in and the user's most recent login to the course networking system 300, which may or may not be visible to other users of the system 300. User information may also include information about the rate and frequency that a user profile gains associations to other user profiles. Where the course networking system 300 comprises advertising or sponsorship, a user profile may optionally contain consumer information including, without limitation, the frequency, patterns, types, or number of purchases the user makes, or information about which advertisers or sponsors the user has accessed, patronized, or used.

A user profile comprises data stored in memory. In addition to comprising data about the subject user, the profile may also include data relating to other individuals. For example, a user profile may contain an identification of associations or virtual links with other user profiles and/or other individuals' profiles stored in a third party application. Indeed, it will be appreciated that the underlying concepts associated with the previously described visual representation 550 may also be applied to a user's own profile. For example and without limitation, a visual representation 550 may be included on a user's own profile page, with the visual representation 550 graphically depicting such user's levels of user engagement in the course networking system 300 as compared to his or her user associations 556. In this manner, a user can quickly assess the level of engagement with his or her own associations simply by viewing his or her own profile page. A user's profile may also contain information excerpted from another associated user's profile, such as a thumbnail image of the associated user, his or her age, marital status, and location, as well as an indication of the number of users, organizations, institutions, and/or online courses with which the user is associated. In one embodiment, a user's profile may comprise a list of other users' profiles with which the user wishes to be associated or with which the user is associated through an educational or business institution.

An association between one or more users may be designated manually by a user or administrator, or automatically by the system 300. For example, a user may designate associated users manually by selecting other profiles and indicating an association that may be recorded in the user's profile (e.g., tagging them as a “Colleague,” which would subsequently be indicated on that user's profile as rating value 510, if used). According to one embodiment, associations may be established by an invitation and an acceptance of the invitation. For example, a first user may send an invitation to a second user inviting the second user to form an association with the first user (which would then be indicated to the second user as a colleague request 436 on the homepage 400 (FIG. 4A)). The second user may accept or reject the invitation. According to one embodiment, if the second user rejects the invitation, a one-way association may be formed between the first user and the second user. According to another embodiment, if the second user rejects the association, no association may be formed between the two users.

Another tool through which a user may manually form associations on the system 300 is by designating a list of individuals (or network) with whom that user desires to share posts, personal information, and/or resources. As a user may not have the same type of relationship with all of its associations, nor share all of the same interests, the course networking system 300 provides personalized networking tools through which a user may customize groupings of other users pursuant to whatever criteria desired. Accordingly, the course networking system 300 supports the formation of a user's own Personal Networks through a personalized social networking feature that facilitates the convenient and meaningful sharing of information over the course networking system 300.

FIG. 7 shows at least one embodiment of a screenshot of a popup window 604 for use in establishing a Personal Network. As shown in FIG. 7, a link 602 (labeled “Create a Personal Network” or otherwise) may be included on the homepage 400. When selected by a user, the popup window 604 appears. The user can then enter the name of the personal network and identify those users for inclusion therein. For example, a student user of the system 300 may create a first Personal Network called “Research Collaborators” and a second Personal Network called “My Family” and add members to these groups, as appropriate. Thereafter, when that user creates posts (as described in further detail herein) or uploads other content to the system 300, he or she may customize which of their Personal Networks will have visibility thereto by defining access permissions for the same. Accordingly, a user can elect to have some privacy with respect to some types of information by limiting the associated access/visibility permissions associated with personal content to only those members of the established My Family Personal Network. Likewise, the user can ensure that any data pushed from his or her account to members of the Research Collaborators Personal Network is relevant to the research subject matter.

Personalized social networking tools also offer the capability of creating associations between groups of users—namely, learning groups (courses), interest groups (Conexus), and groups of courses within the same or similar learning categories. In contrast to Personal Networks, which typically relate only to establishing and managing content visibility settings (i.e. establishing easy ways to identify and distinguish between different groups of users such that a user can quickly and easily send or make visible relevant content to the appropriate groups), the driving purpose behind courses and Conexus is to facilitate mutual communication and collaborative interaction.

As the term is used herein, a “Conexus” is a common-interest discussion group and/or online forum created and maintained through the course networking system 300 that provides its membership with an avenue through which to find each other, explore and share perspectives and resources. All of the tools and feature sets available through the system 300 for supporting communication, collaboration, the exchange of ideas, and/or the sharing of resources are available for use with a Conexus, including but not limited to notification tools, comprehensive posting and/or reflection tools, group-oriented messaging (using, for example, Personal Networks), and discussion boards for posting questions and answers in a threaded-discussion format. Typically, Conexus are used to host informal or very large interest groups; however, there is no minimum number of members required to establish a Conexus on the course networking system 300.

The purpose of a Conexus is to form an association between users with like interests, as well as to initiate discussion, share events, information and resources therebetween. Due to the global nature of the system 300 itself, a Conexus provides global connectivity between like-minded users in an unrestricted fashion that promotes the development of new ideas and the discovery of fresh perspectives.

Any user of the system 300 may create and/or moderate a Conexus (they need not be an instructor or administrator) and a Conexus can be either open to the public or a closed group, as per user preference. When a user forms and/or joins a Conexus—i.e. forms an association therewith—he or she is thereafter afforded access permissions with respect to the content posted in connection with that Conexus. Specific descriptions and elements of a Conexus will be provided in further detail below.

Learning groups, or “courses,” are yet another form of association that may be established through the course networking system 300. A “course,” as the term is used herein, comprises a formal learning environment provided through the course networking system 300 that includes social networking components for school-based or personal courses (i.e. structured learning). Similar to Conexus, courses may be open to the public or, alternatively, kept private. Furthermore, while users who are official instructors at an institution typically use the system 300 to create and execute one or more online courses, the system 300 also enables users who are not professional instructors to create an online course or MOOC to be shared through the system 300 with their respective learning communities.

Courses provided through the course networking system 300 may utilize all of the tool sets and features described herein in connection with the system 300 and, in at least one embodiment, additionally comprise tools that are specific to courses. Examples of such course-specific tools include, but are not limited to, Tasks, Quizzes, Dropbox, Certification Badges and/or Gradebook functionality.

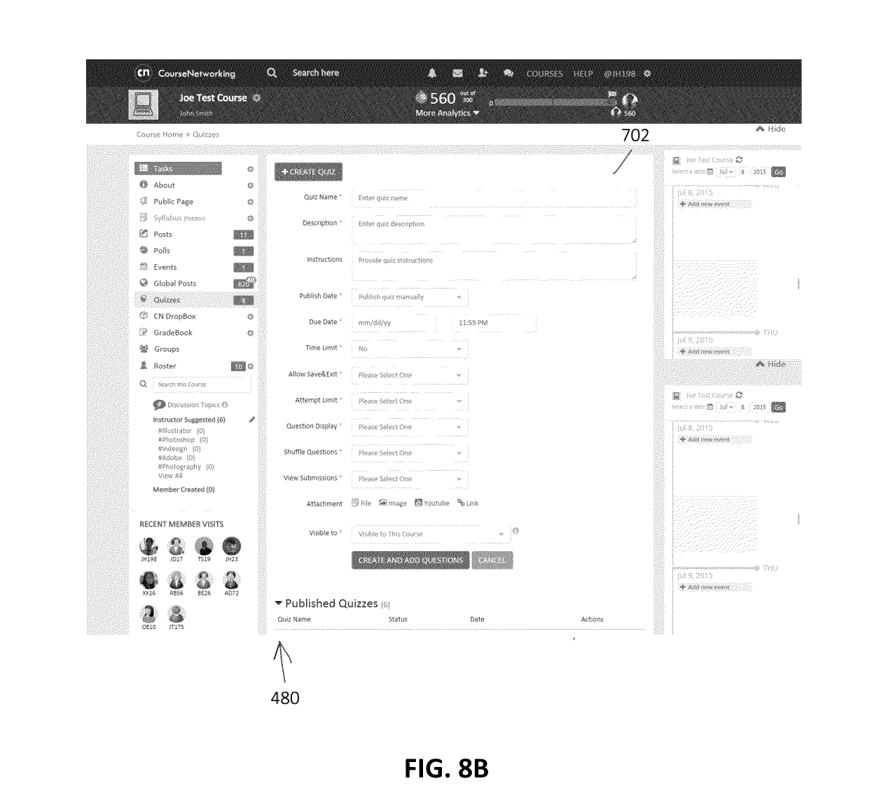

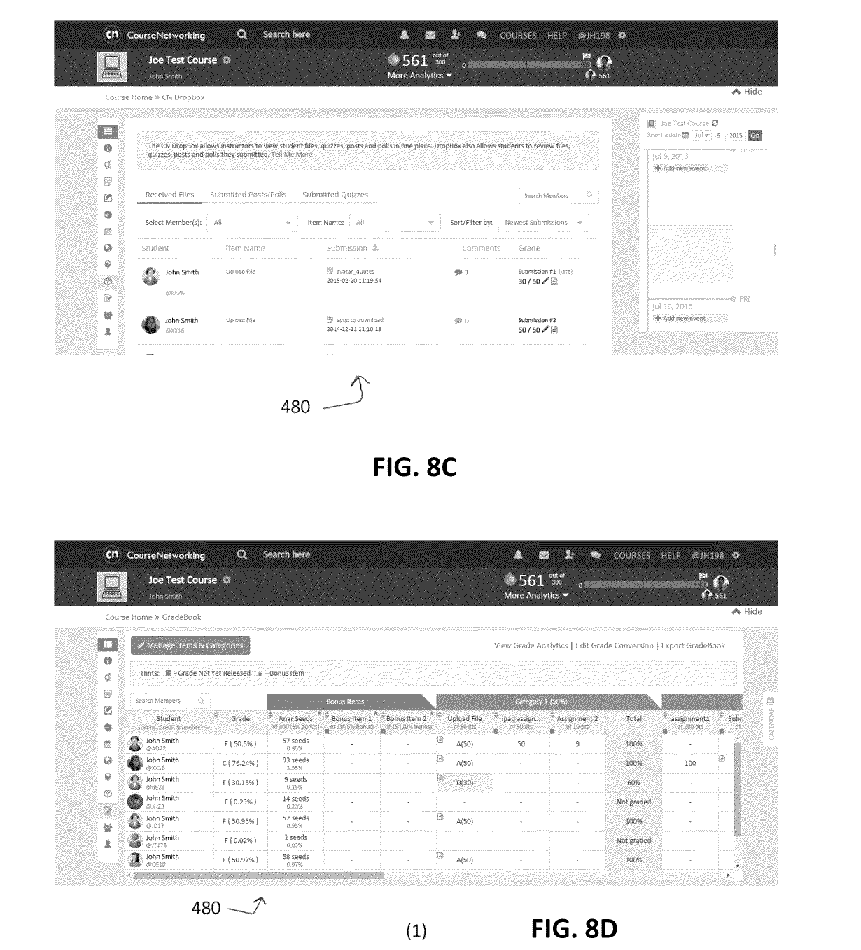

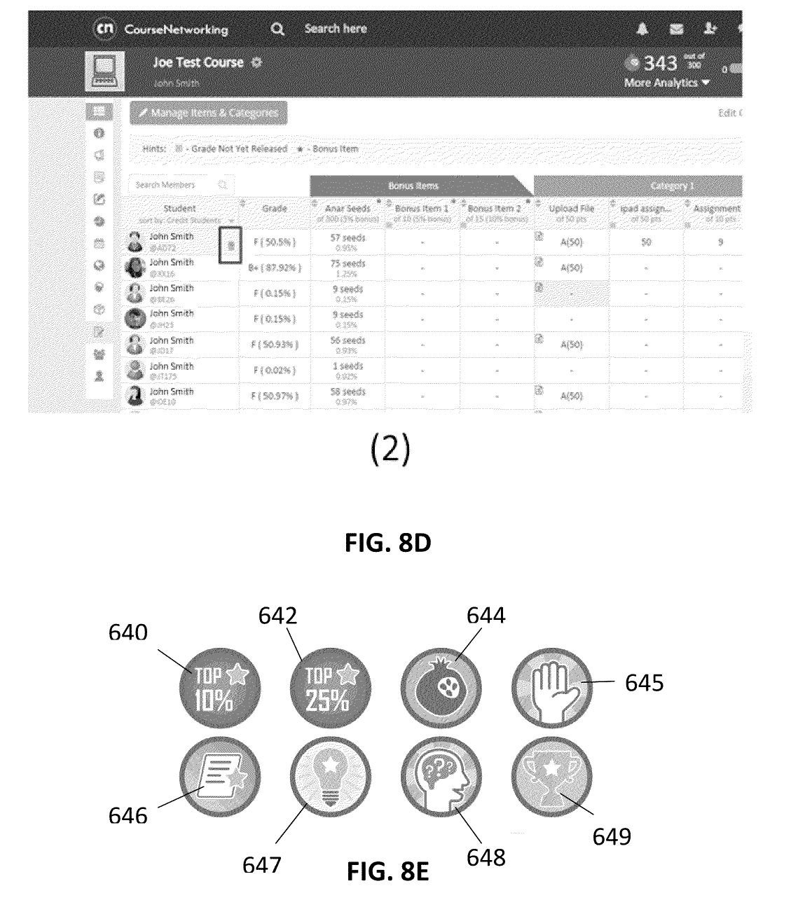

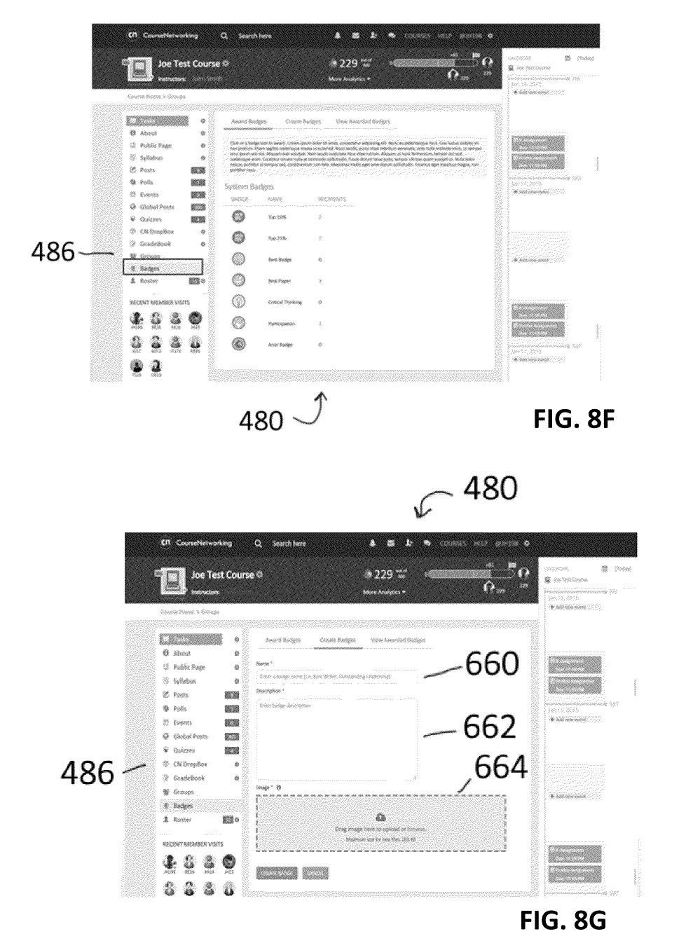

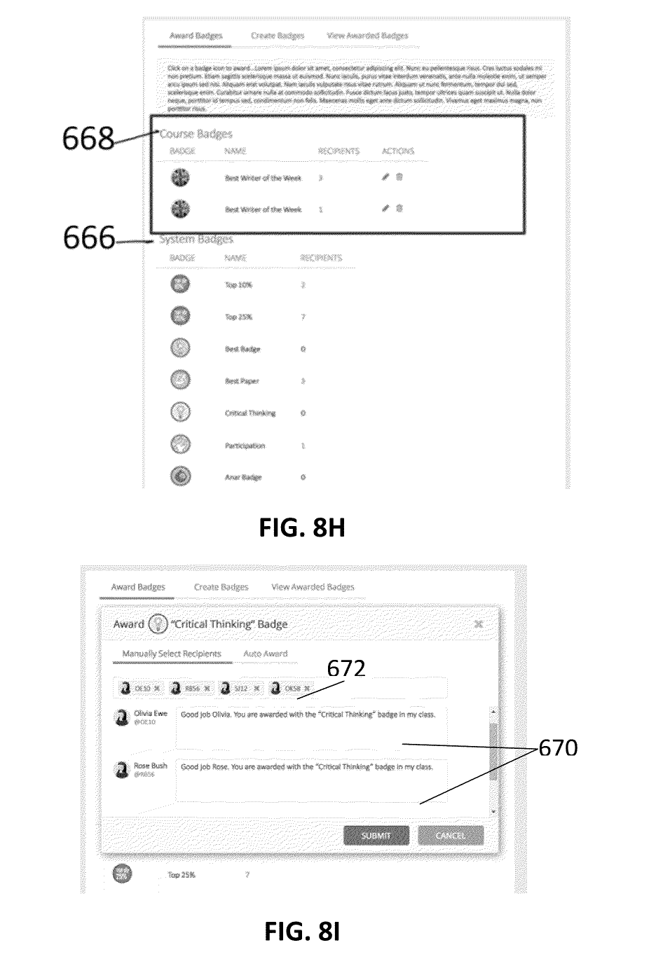

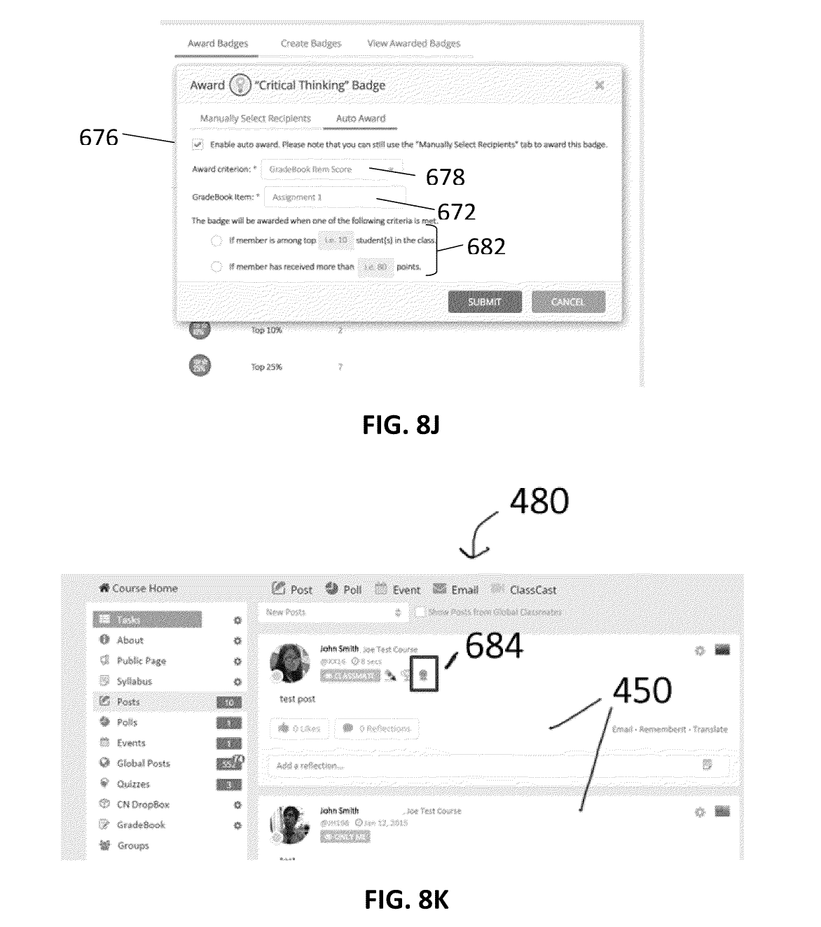

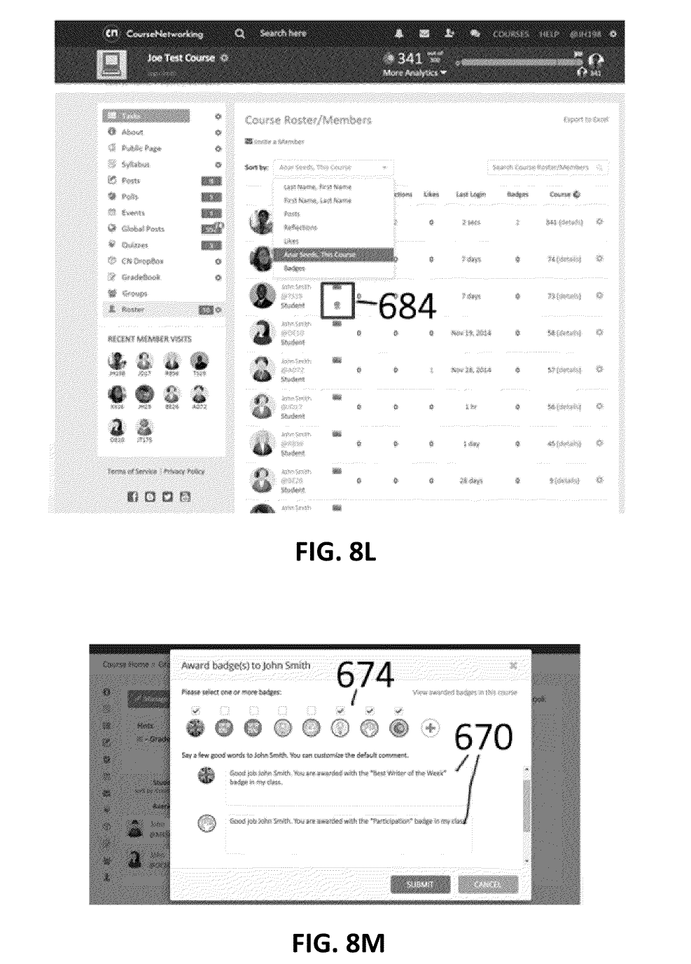

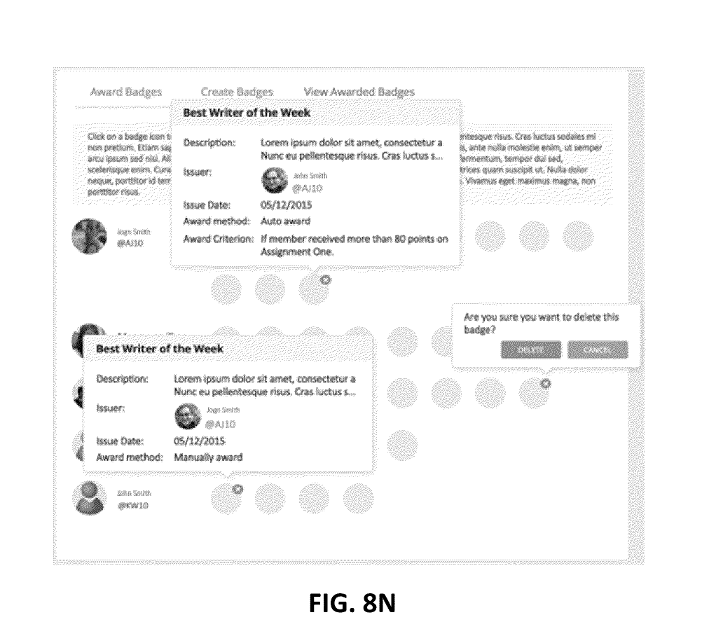

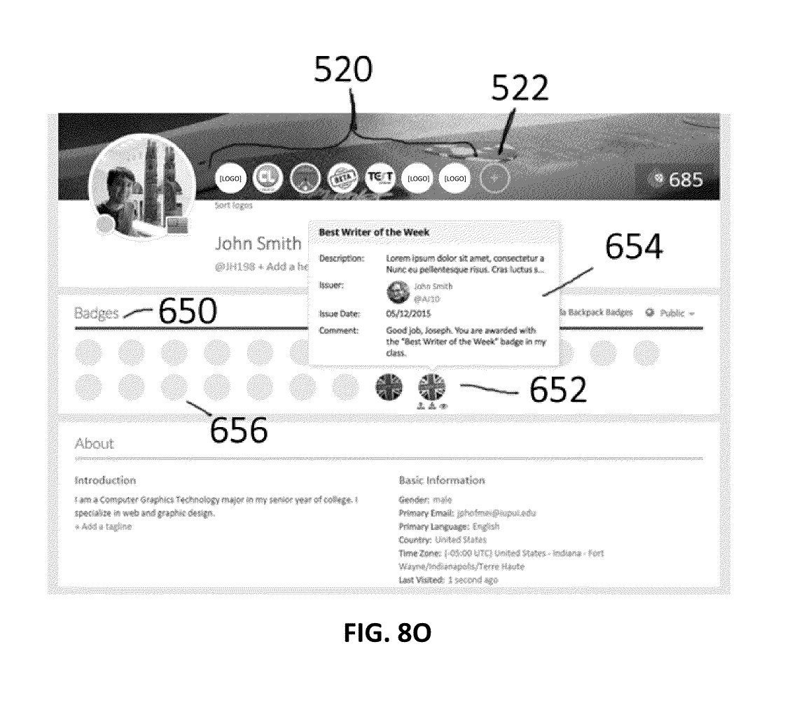

Tasks is a comprehensive, automated assignment tool that provides an authoring environment for an instructor to define conditions and enforce a timeline in connection with an online course offered through the system 300. Perhaps more specifically, the Tasks application allows instructors to define a series of interactive learning activities that might include lessons, assignments, weekly reading assignments, end of course survey, etc. (see FIG. 8A). For example, an instructor may choose to show a series of weekly assignments or curriculum based on specific course learning objectives. In this example the Task tabs may be labeled Week 1, Week 2, Week 3, etc. In another example, the instructor may use one tab for each lesson and label them as lesson 1, lesson 2, lesson 3, etc. Tasks may also provide an instructor with the capability of creating one or more subcategories for each identified Task. Additionally, the Tasks tool enables students to easily visualize course assignments and deadlines.

Furthermore, the Tasks tool has an interactive feature such that it is capable of interfacing and/or communicating with other tools of the system 300 in connection with a course (e.g., the Gradebook and/or calendar tools or functionality). For example, in at least one embodiment the Tasks tool can interface with a calendar function of the system 300, such that a calendar is displayed in a portion of the course page 480 and the tasks due are automatically/dynamically populated and displayed in connection with the appropriate date/day. In this manner, Tasks can be used to ensure the content of within the various course features is consistent and automatically kept up to date.

Furthermore, an instructor may utilize the Tasks tool to temporarily restrict a student's access to certain components of the curriculum. In this manner, a student will not be able see the content of certain units/Tasks unless and until they have first satisfied certain conditions (e.g., Task 3 will be restricted until a student has satisfactorily completed Tasks 1 and 2). The parameter, conditions, and/or timeline associated with such Task access restrictions can be defined and customized by an instructor in connection with either creating the course, or at any time thereafter via the Task panel 700 of a course page 480. Accordingly, the Tasks tool can be employed in connection with courses that are, at least in-part, school based or in connection with fully automated, self-paced courses.

An unlimited number of Tasks can be created to support a variety of course formats, such as face-to-face teaching, hybrid courses, online courses or MOOCs. In at least one embodiment of the system 300, the Task tool is only available for use in connection with a Course page 480 and can only be created and administered by the instructor.

Quizzes is also a tool that instructors may use in connection with a course provided in the course networking system 300. Now referring to FIG. 8B, an instructor can use the Quiz tool via Quiz Panel 702 to create and customize exams or assessments to be taken by the members of the course. The Quizzes tool is comprehensive and affords an instructor a large amount of customization options with respect to customization. It will be appreciated that any resulting exams or assessments may be delivered directly to members of a course or, alternatively, they may be incorporated into the Tasks functionality of the system 300 and made accessible to students only pursuant to instructor-defined restrictions.

The Gradebook and Dropbox tools are additional tools available for use in connection with a course delivered over the course networking system 300 and are accessible via tool set window 486 (see FIGS. 8C and 8D (subfigures (1) and (2)). The Dropbox tool is a repository for files, quizzes, posts and polls that are submitted by students in connection with the course. Instructors are able to view all submitted content and files in a convenient and easily accessible manner, and subsequently assign grades to the same (which are subsequently reflected in Gradebook tool). The Gradebook tool is linked with the Tasks and Dropbox tools. When instructors create a new action item using the Tasks tool and identify the same as being gradable, a new item is automatically populated in Gradebook. Instructors can then use the Gradebook tool to score, organize and manage student grades. Students enrolled in a course can access the Gradebook functionality to view their grades and other details relating to their Gradebook items. Subfigures (1) and (2) of FIG. 8D illustrate two examples of GUI interfaces that may be used to access the functionality of the Gradebook tool.

The course networking system 300 may additionally provide a certification badge tool in connection with a course, Conexus, or even a System Client or other larger association within the system 300 (e.g., to award a Top 10% designation either with respect a course or across a university). The certification badge tool provides course instructors and/or the related institutions utilizing the system 300 (e.g., a university or a System Client) with the ability to recognize and/or award users with certain certifications to indicate exemplary effort, achievement, skill, or work. For example, the certification badge tool may be used to recognize a student as being in the Top 10% of his or her course, or even in the Top 10% of his or her university. Similarly, the certification badge tool may be awarded to recognize a user for achieving a particular certification (an industry-specific certification, for example) or graduating from a degree or other program. FIG. 8E illustrates several non-limiting examples of certification badges that may be automatically available through the system 300 (i.e. predefined certification badges), including a Top 10% badge 640, a Top 25% badge 642, an Anar Master badge 644 (indicative, for example, of a user who accumulates a large amount of rewards points through use of the system 300), a Best Participant badge 645, a Best Paper badge 646, a Creative Thinker badge 647, a Critical Thinker badge 648, and an Excellent badge 649.

As with the previously described course tools, the badge tool may also be accessible via tool set window 486 of a course page 480 (see FIG. 8F). Alternatively, it will be appreciated that administrator-users may have access to similar pages to access this tool set and its functionality. As previously alluded to, an instructor (where used with a course) or administrator (where used by a System Client, university, or other institution utilizing the system 300) may award a certification badge that is predefined within the system 300 (FIG. 8E). Alternatively, certification badges may also be created/customized as desired and/or appropriate. FIG. 8G shows at least one example of an interface for use creating a certification badge using the certification badge tool. Here, a series of buttons, text fields, and drop boxes are provided to facilitate badge creation. For example, in at least one embodiment, an instructor may create a badge by entering a certification badge name in field 660, providing a description of the certification badge in field 662, and assigning a logo or other image to the certification badge using a drag and drop field 664. It will be appreciated that such certification badge creation via the course networking system 300 is fully customizable and other parameters and/or information may also be provided in connection with the creation of a certification badge as is appropriate and/or desired.

FIG. 8H illustrates at least one example of an interface for use in awarding certification badges to users of the system 300. Accordingly, where an instructor or administrator desires to award a certification badge, he or she simply accesses the available badges (here, divided into two groups: those predefined by the system 300 listed as System Badges 666, and those custom created listed as Course Badges 668) and assigns one or more of the available badges to the desired user(s).

FIG. 8I shows at least one embodiment of a pop-up window for use in awarding a single certification badge to one or more users. As shown in FIG. 8I, the instructor/administrator can manually select one or more recipient users using, for example, their unique identifiers assigned by the system 300 (672), and customize a note for each recipient regarding the certification badge award in a provided field (670). Such unique identifiers/users may be selected from a drop-down list populated from the relevant class roster or, such as where an administrator is awarding a certification badge, the available recipient users may be selected from an institution-wide group of users. After the intended recipient users are selected, any other desired information is entered and the same is submitted, the certification badge tool associates the identified certification badge(s) with each of the identified recipient user's profiles (as described in further detail below). In this manner, a course instructor or administrator can quickly award a certification badge to multiple users in a single, convenient action.

Additionally or alternatively, the certification badge tool may be configured to automatically award certification badges to those users who satisfy one or more defined parameters. The pop-up window shown in FIG. 8J provides at least one example of a user interface of the course networking system 300 associated with this functionality. As seen in FIG. 8J, an instructor/administrator may enable the auto award (676) of an identified certification badge, establish and/or otherwise define award criterion and related parameters (678, 680) for the same, and even customize conditions associated with the award of that particular certification badge (682). In this manner, when the certification badge tool detects a user that satisfies the defined parameters/conditions, the appropriate certification badge will be automatically awarded to the same.

As previously described, the certification badge tool may be access directly from the tool set window 486 of a course page 480. However, to facilitate ease and convenience of use, the functionality of the certification badge tool can be directly accessed from other locations as well. For example, the certification badge tool can be integrated with the course page 480. As shown in FIG. 8K, where an instructor/administrator is particularly impressed with a student user's post 450, for example, he or she may directly access the certification badge tool from the relevant post 450 via a badge icon 684 and manually award one or more certification badges to such student user. Similarly, the certification badge tool may be integrated with the class roster such that an instructor may directly award a particular student with a certification badge by the incorporation of one or more badge icons 684 on the class roster (see FIG. 8L).

FIG. 8M illustrates at least one embodiment of a pop-up window that may be used in this process. In such embodiments, after selecting the badge icon 684, the instructor/administrator can select from a list of available certification badges (674) and customize a note regarding each badge in a provided field (670) prior to awarding the same. In addition to the foregoing, links to the certification badge tool functionality can also be incorporated within other areas the course networking system 300 and/or tool sets as desired. For example, in at least one embodiment, the certification badge tool can be accessed directly from the Gradebook tool, either using a badge icon 684 or otherwise (see subfigure (2) of FIG. 8D). Furthermore, the certification badge tool may additionally comprise a GUI configured such that an instructor or administrator may view all certification badges 652 that have been awarded in connection with a particular course, Conexus, or group of users (see FIG. 8N).

In at least one embodiment, when a certification badge is awarded to a student user, the badge is automatically associated with and displayed on the recipient user's profile similar to the graphical icons 520 previously described. Indeed, certification badges 652 may optionally be displayed on a user's profile page in a designated certification badge section 650. For example, as shown in FIG. 8O, the certification badge section 650 may be a prominent area of the user's profile for use in displaying those certification badges 652 earned by such user. Additionally, and again like graphical icons 520, placeholder badges 656 may also be included on the profile page (which may or may not be visible to users other than the profile owner).

In furtherance of the visual-centric design concepts leveraged by the visual profile previously described herein, the certification badges 652 are listed/displayed by icon or logo such that they can be easily reviewed. Furthermore, and in-line with the description of graphical icons 520, the certification badges 652 may also be designed to convey additional information regarding the certification or award in a condensed text format. For example, as shown in FIG. 8O, if a mouse is moved over a badge 652, a data window 654 conveying summary information regarding the certification/award is displayed. In this manner, a user may quickly review another user's profile and obtain a comprehensive understanding of such user's academics, credentials, and work experience, without investing a lot of time in reading paragraphs of text.

However, despite the similarities between graphical icons 520 and certification badges 652, it should be noted that there is at least one significant difference. Unlike graphical icons 520 which can be populated by the profile-owning user him or herself, certification badges 652 may only be assigned via the system 300 (i.e. earned). In other words, if a user has one or more certification badges 652 displayed on his or her profile, then a third party has awarded that user the certification badge 652 via the certification badge tool. Indeed, while in at least one embodiment, a user may elect to hide a certification badge 652 from being displayed in connection with his or her profile (similar to how graphical icons 520 may be electively displayed), a user cannot independently add a certification badge 652 to his or her profile. This functionality highlights a novel and important benefit of the certification badge tool of the course networking system 300; namely, the incorporation of certification badges 652 lends an element of verifiability and credibility to the profile display. Accordingly, the certification badge tool of the course networking system 300 enables users to gradually and dynamically build and showcase a credible, visual resume that is verifiable by potential employers.

Now referring back to user associations generally, in addition to those associations previously discussed that can be manually established by one or more users, an association between two or more user profiles may also be formed by an automatically generated association. For example, the system 300 can be configured to establish such automatic associations between users in response to a predetermined number of common entries, aspects, or elements between such users' profiles. In one embodiment, a user profile may be automatically associated with all of the other user profiles comprising a predetermined number or percentage of common entries, such as interests, courses, course categorizations (described in more detail below), likes, dislikes, educational institutions, employers and/or habits.

Additionally or alternatively, and regardless of the percentage of common entries with other users, a user profile may automatically be associated with all of the other user profiles associated with a like entity (such as, for example, an educational institution or a business, and either via a channel or otherwise) or, perhaps more specifically, with all of the other user profiles associated with a particular degree program or course at a specific educational institution or a particular department or team at a business. Similarly, the course networking system 300 may automatically associate users who are enrolled in courses having like subject matter.

Associations designated manually by user(s) of the course networking system 300 (whether on an individual or group/network basis), or associations designated automatically based on data input by one or more users of the system 300 are hereinafter referred to collectively herein as “user-established associations.” The information provided by the user may be used by the course networking system 300 in a variety of ways. In at least one exemplary embodiment, the user's expressions of interest, profile information, user-established associations, and other actions captured by a user's use of the course networking system 300 can be exploited to direct specific information to the user in a dynamic fashion. As will be described in further detail below, this functionality is significant given, at least in part, the vast amount of content, resources and communications made available to users through the networking system 300. Additionally, and as previously mentioned in connection with Personal Networks, a user may control access permissions for his or her personal profile information, thus allowing the user to define the viewing rights of other users of the system 300 (e.g., limiting the visibility of some or all of a user's personal information to classmates, students taking similar courses, followers, colleagues, potential employers, the public, or some combination thereof).

In addition to, or in conjunction with, the content management and delivery tools previously described, the system 300 may also provide a technical framework capable of incorporating and exploiting extensive and worldwide resources, as well as supporting massively populated learning that is intercultural in nature. For example, in at least one embodiment, users of the course networking system 300 have access to the Internet and its vast array of multimedia resources. This aspect of the course networking system 300 can supplement the users' online educational experience and/or, when the course networking system 300 is used in conjunction with a course offered at a physical location, their physical or traditional education experience. Furthermore, if desired, a user may easily seek out and/or browse subject-specific information, resources and communities to further extend his or her educational experience beyond a course-prescribed curriculum and/or those learning resources provided by a course instructor. It will be appreciated that any combination of content management and delivery tools may be employed with the system 300 and/or other feature sets in order to achieve the desired outcome.

Along these same lines, and as will be described in more detail below, each course and Conexus created on the system 300 may be categorized within the course networking system 300 according to its subject matter. For example, an Intellectual Property Law course may be classified by the system 300 as having a “Law” classification. The course networking system 300 is able to analyze course subject matter classifications and, when courses are identified as falling under a single subject matter classification, the network 300 may automatically form an association (limited or otherwise) between the two courses' members. In at least one embodiment, those users who are participating in different courses that nevertheless have similar subject matter are identified as “Global Classmates” and/or “Global Instructors.”

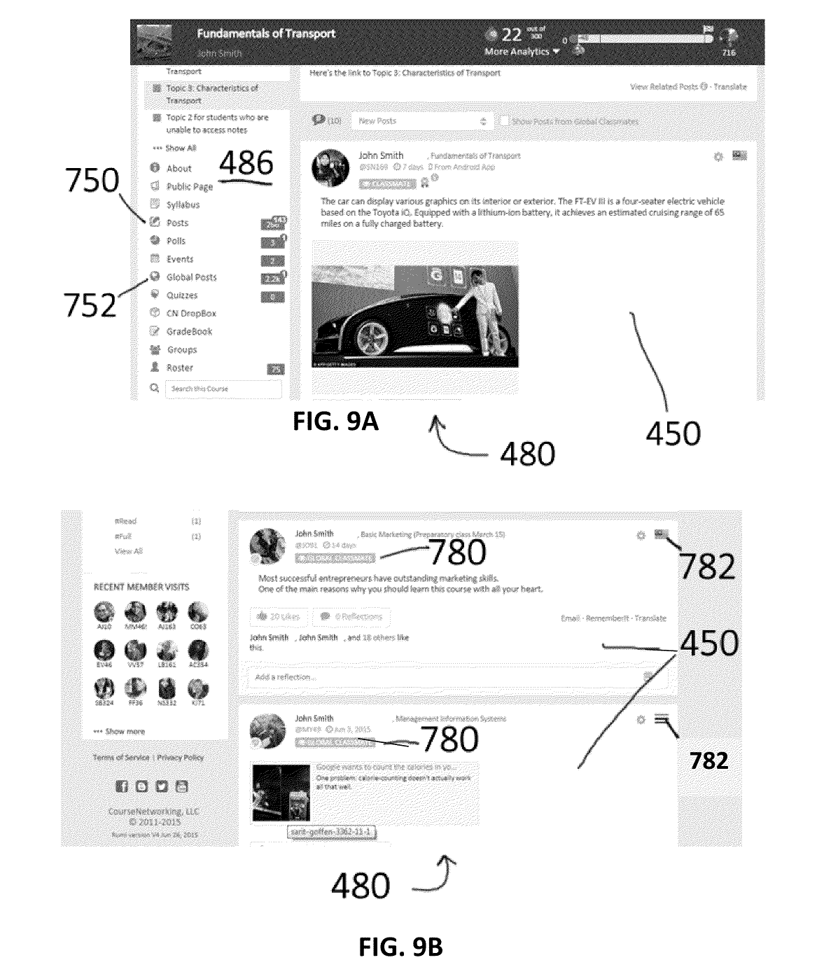

The significance of these course associations relates to the dissemination of information and collaboration between the users. For example, users who are Global Classmates/Instructors may elect to share their posted content not just with the users enrolled in the course that they are in, but also with those Global Classmates/Instructors who are enrolled in a different, but categorically similar, course. To help illustrate the significance of this association feature, a course page 480 for a course utilizing the Global Classmates functionality is shown in FIGS. 9A and 9B. Notably, while the posts link 750 shown in FIG. 9A indicates that there are only 266 published posts associated with (or relevant to) this course topic, the global posts link 752 indicates that there are 2,200 published posts associated with/relevant to the course. This limited example alone evidences the large effect that the incorporation of the Global Classmates/Instructors functionality has on the availability of knowledge and educational resources available through the course networking system 300. Perhaps more specifically, the Global Classmates/Instructors feature vastly increases the number of individuals available for participation in a discussion thread (via posts 450 or otherwise), thereby resulting in a much larger network of resources and for the exponential expansion in the distribution of knowledge. Indeed, instead of a course simply having access to posts and content authored by its own participants/class members, the Global Classmates/Instructor functionality enables students/instructors located at other universities and institutions around the world to enter the discussion.

By way of a non-limiting example, using Global Classmates, a course member studying Transportation at Indiana University (located in Indianapolis, Ind., U.S.A.) will have convenient access to individuals interested in the same topic, but living in different areas of the globe and often from different cultures. Instead of the thirty individuals that might be enrolled in that course with Indiana University, a course member now has access to thousands of individuals—and thus learning resources—worldwide. Two examples of posts 450 published by Global Classmates (designated as such by reference 780) in such a course are shown in FIG. 9B. As indicated by the flag indicator 782, one of these Global Classmates is from Malaysia and the other is from Thailand. The course member taking this course can, thus, post questions and/or discussion threads through the course page 480 and quickly and easily obtain insight from individuals located all over the world. The facilitation of such a wide-spread discussion network not only creates a fertile environment for expanding worldviews, fostering innovation, and promoting understanding across cultures, but it also amplifies the entertainment factor of the course/discussion, thereby helping to keep course members engaged.

Additional feature sets of the course networking system 300 may include communication applications and interactive tools. In general, communication applications capture, store and present communications between specific users and/or groups, usually written but increasingly including audio and video components as well. In at least one embodiment, the course networking system 300 comprises email, instant messaging and/or chat functionalities such that users can directly communicate with each other over and outside of the system 300 via secure channels, in real-time or otherwise. For example, any email, instant messaging and/or chat applications known in the art may be integrated into the system 300. Additionally, in at least one embodiment, such applications can be used to not only send secure communications between users over the course networking system 300, but also to transmit communications from a system 300 user to an external email address and/or messaging handle. The communication applications of the system 300 can also include the tracking and predicting of online communications with respect to third party applications (e.g., Facebook®, Twitter®, Skype®, etc.) and other outside social networks around the world.

In addition to the aforementioned, or perhaps in conjunction therewith, the course networking system 300 may also provide a translator tool to facilitate user accessibility to system 300 content. This is especially useful in connection with the course networking system 300 as the system 300 is not restricted by geographic boundaries and thus allows for input and collaboration from users worldwide. Use of the translator tool in connection with various applications of the system 300 negates language barriers and allows for multicultural collaborations.

The translator tool may comprise any language translation application or function now known or hereinafter discovered that is capable of translating one language to another, user-selected language. The incorporation of this functionality in the course networking system 300 is particularly important due to the global reach and nature thereof. Through the inclusion of translation functionality, users of the system 300 are not limited by language barriers and can effectively collaborate regarding like interests and topics. In at least one embodiment, the translator tool of the course networking system 300 comprises Google® Translate or the like.

Because the course networking system 300 tracks a user's actions on the system 300, the system 300 is capable of dynamically learning and applying a user's preferences to the translator tool. In at least one example of this, the course networking system 300 monitors a user's use of the translation tool such that for any subsequent use of the tool, the system 300 automatically adjusts the translation settings to match the learned user preferences. For example, where a user previously used the translator tool to translate an email communication from English to Chinese, the next time that user accesses the translator tool, the system 300 will have automatically adjusted its translation settings to translate from English to Chinese.

In at least one embodiment of the course networking system 300, the communication applications and interactive tools can be accessed via links present on the homepage 400. Specifically, as shown in FIG. 4A, an email application may be accessed via the Email link present in the posting toolbar 406 and/or unread messages indicator/link 434 of the navigation toolbar 404, and the instant messaging and/or chat functionalities may be accessed at least via the chats received indicator/link 438 of the navigation toolbar 404. FIG. 7 illustrates a portion of the homepage 400 where the email application has been accessed via the posting toolbar 406 to compose a new email message. Additionally, the translation tool may be used in conjunction with a posting application such that it may be accessed, for example, in connection with a post 450 via selecting the Translate link 451 (see FIG. 4A).

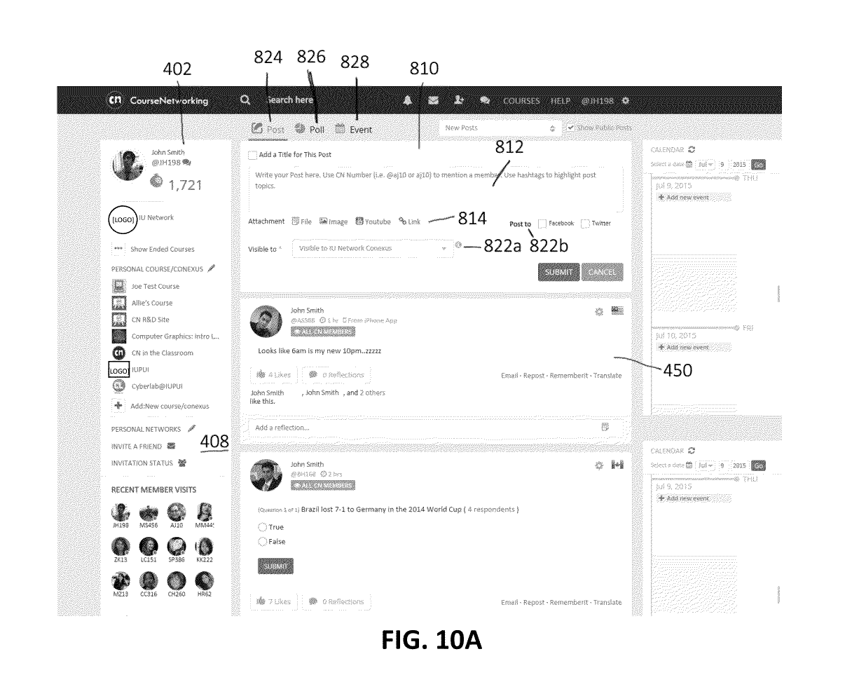

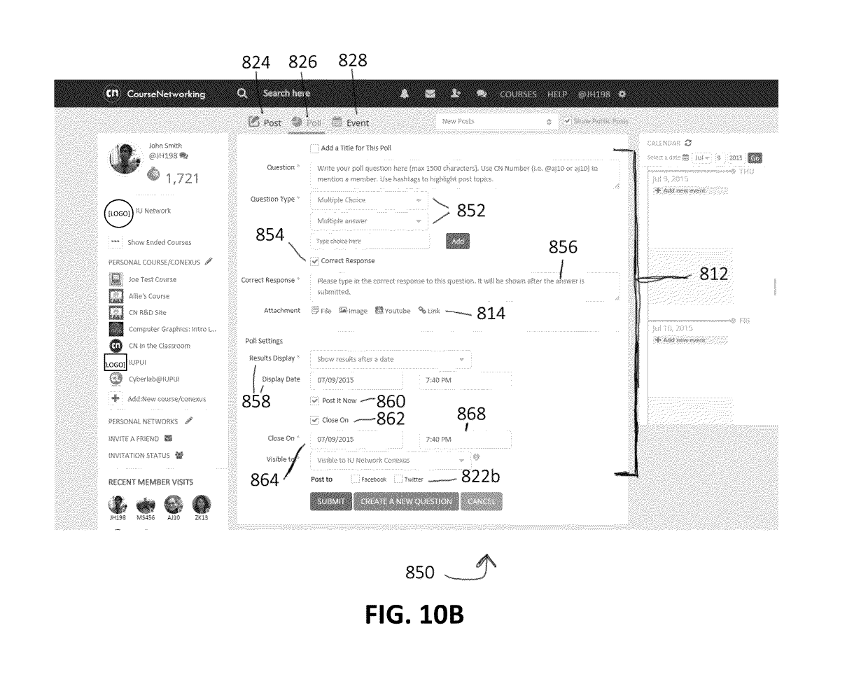

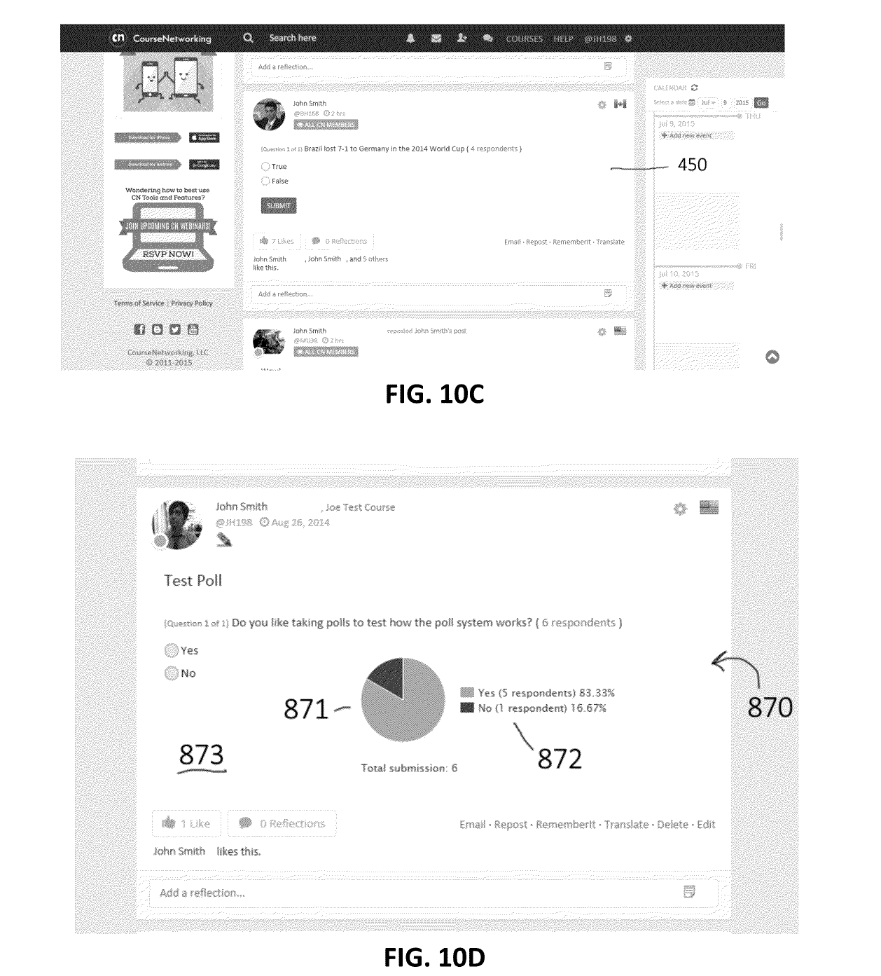

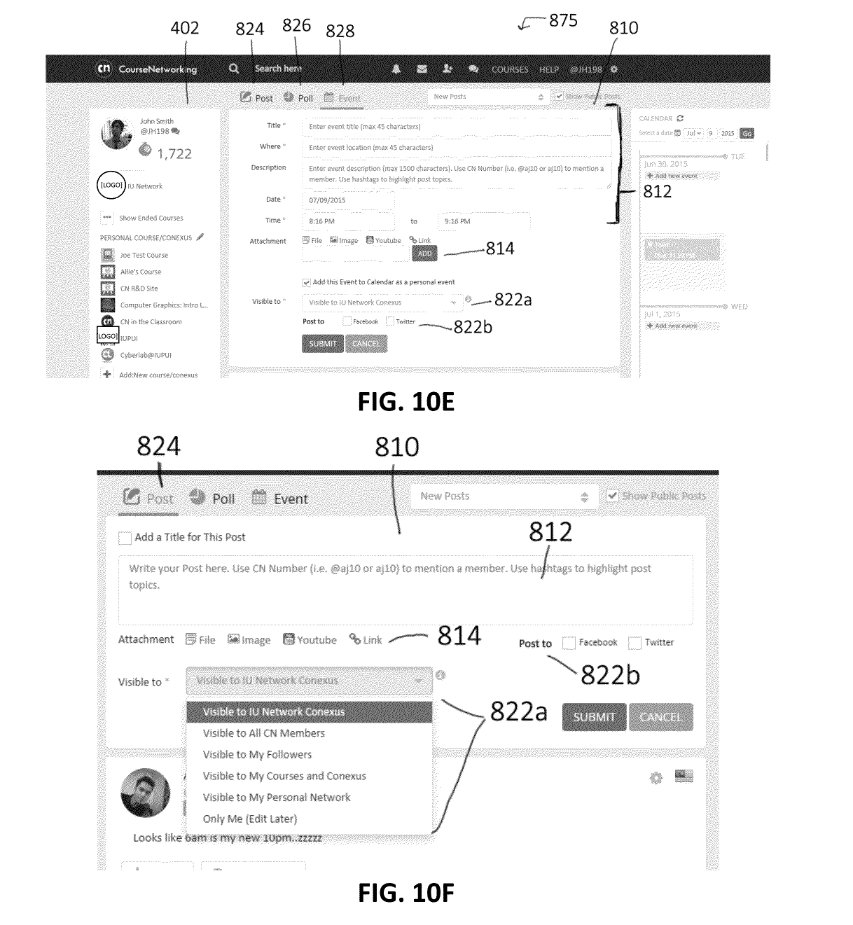

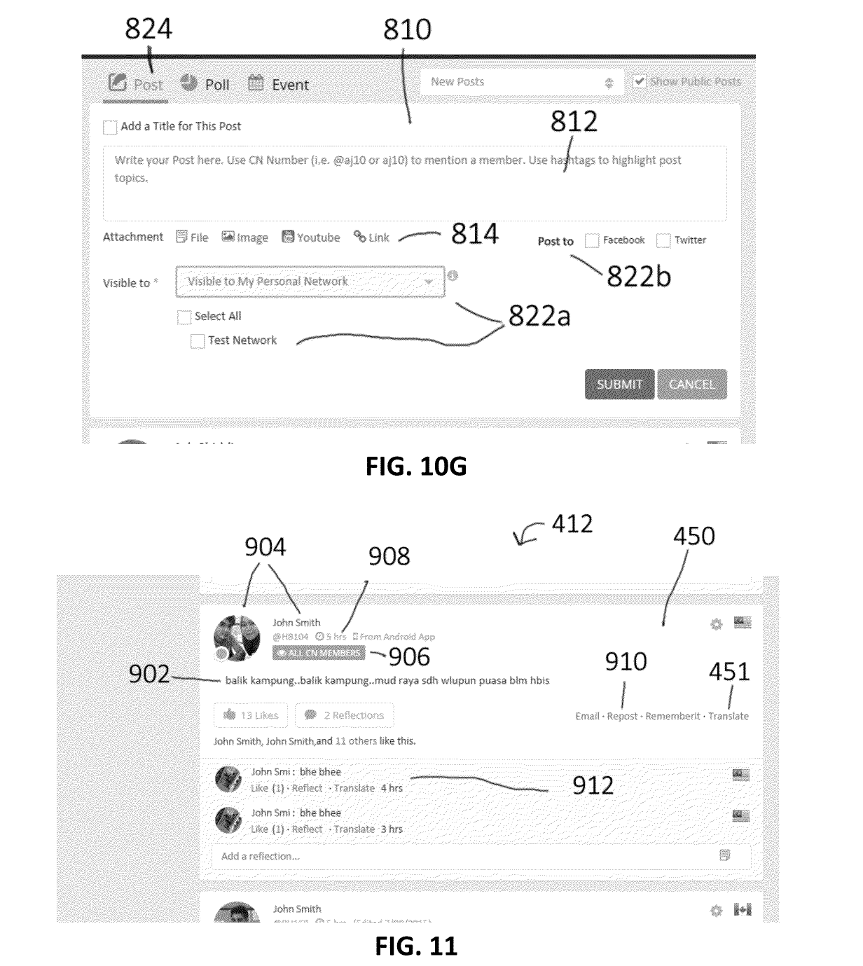

Now reference will be made to the perhaps more complex feature sets of the course networking system 300 that incorporate some functionality from one or more of the previously described features. FIGS. 10A-10G illustrate examples of GUIs for use in connection with the comprehensive posting and reflection tools of the course networking system 300. These comprehensive posting and reflection tools enable users to create and distribute postings with a variety of media attachments, each posting having specifically defined access permissions (each collection of information/media concurrently published to the system 300 referenced generally herein as a “post 450”). Furthermore, the posting and reflection tools described herein allow users of the system 300 to publish specifically formatted posts 450 and enable those users having the appropriate access permissions to “like” a post 450 or “reflect” upon it, thus fostering an inherently social and collaborative environment that supports user feedback and interaction.

In their simplest form, the posting and reflection tools of the course networking system 300 enable users to create and post content within the course networking system 300. The system 300 may provide several different formatting options for the posts 450; in at least one embodiment there are three available formats, which include informational posts, events, and polls. For example, the posting and reflection tools can be used to create a simple informational post for conveying an idea or initiating a discussion, the post 450 comprising a text component (entered into post field 812) and/or a variety of media attachments, including files, images, YouTube® videos, and/or links. Following creation, the post 450 may then be published to the system 300 pursuant to certain identified settings (i.e. access permissions).

As shown in FIG. 10A, selection of the post window 810 or the post field 812 results in displaying the available options with respect to creating and publishing a post 450 to the system 300. These options may include attachment options 814, visibility settings 822 and/or any other option that may be associated with uploading content to the system 300 and/or distributing the post 450.

The attachment options 814 represented in FIGS. 10A, 10B and 10E-10G include buttons for uploading content to the post 450. For example and without limitation, such content may include a file, image, multimedia files and/or streaming content, and/or a link to a URL. In at least one embodiment, a “ShareLink” may be also included in a post 450 (not shown). There, the ShareLink comprises a hyperlink combined with a thumbnail image and may be inserted into the content of the post 450 simply by copying and pasting the appropriate URL into the appropriate post field 812. Similarly, a user may reference another user of the system 300 simply by typing that user's unique identifier into the appropriate post field 812. The system 300 will automatically recognize the unique identifier and create a link to such user's profile page. In addition to and/or in conjunction with the aforementioned, it will be appreciated that any attachment options that are now known or hereinafter developed may be employed in connection with the attachment options 814.

Notably, a user can define detailed access permissions for his or her post 450 using the visibility settings 822. For example, to identify which users will be able to see the post 450 once published (i.e. the distribution range of the post 450), a user can quickly and easily distinguish among his or her user-established associations pursuant to a user-customized set of parameters including the geographic location of users, the course(s) in which users are enrolled, System Client(s) and/or institutional associations, etc. Alternatively, a user may elect to make the post 450 available for system-wide distribution, thus making it “Public” and visible to every user of the system 300, even if they are not a user-established association of the posting user.

As illustrated in FIGS. 10A, 10B and 10E, in at least one embodiment the post window 810 comprises a dropdown menu 822a comprising a list of access permissions for selection by a user in connection with the internal distribution of the post 450 within the course networking system 300. A user can use dropdown menu 822a to indicate which user(s), group(s) of users, and/or Personal Network(s) can view the post 450. Furthermore, in at least one embodiment, the visibility settings 822 may further comprise external visibility options 822b. By selecting the boxes of 822b, a user can elect to concurrently publish the post 450 to one or more external social networking sites in order to maximize distribution.

For example, if a user selects “Visible to All CN Members,” all users of the course networking system 300 will see the post 450, regardless of if a user-established association exists between the posting and viewing users. Other access permission options may include, without limitation: Visible to My Followers (users that follow the posting user in the system 300 will see the post 450); Visible to My Colleagues (users that are identified as the posting user's colleagues in the system 300 will see the post 450); Visible to My Courses (users of course(s) identified by the posting user will see the post 450) (see FIG. 8F); Visible to My Conexus (users of the Conexus identified by the posting user will see the post 450); Visible to My Personal Network (users of the posting user's identified posting Network(s) will see the post 450) (see FIG. 10G); and Only Me (Edit Later) (no other users will see the post 450 unless and until the posting user changes the visibility settings 822). In at least one embodiment, any combination of these access permission options may be selected such that the posting user can easily define and customize a specific group that will have visibility to the resulting post 450. Accordingly, the course networking system 300 posting and reflection tools allow for not only the broadcast of group- and user-oriented content posts 450, but also for the system-wide distribution of information. Additionally, and importantly, the system 300 also provides for the detailed selection of visibility permissions such that a user can specifically define what users will see the resulting post 450.

To further facilitate meaningful and convenient collaborative use of the system 300, the course networking system 300 may comprise prescribed posting formats as previously mentioned. In the embodiments shown in FIGS. 10A-10G, available posting formats include informational-type posts, event-type posts and poll-type posts, which are accessible in the posting toolbar 406 via links 824, 826, and 828, respectively. The post windows 810 associated with each of these posting formats may comprise many of the same options (including, for example, post fields 812, attachment options 814 and visibility settings 822); however, such components may be customized in light of each post-type format and/or the post windows 810 may comprise additional options that are format-specific. Additionally, the resulting posts 450 may have various format-specific displays associated therewith (such as, for example, displaying the results of a poll).

The course networking system 300 allows for and facilitates the detailed customization of poll-type posts 450, which may be used to solicit a response to one or more questions. FIG. 10B illustrates a creation screen 850 for use in creating and publishing poll-type posts 450. As shown in FIG. 10B, the post fields 812 are not solely free form text fields (as are those in the embodiment of FIG. 10A), but instead may additionally comprise multiple dropdown menus and alternatively formatted selections. Specifically, in this embodiment, the post fields 812 of the embodiment shown in FIG. 10B include dropdown menus 852 to specify Question and Answer Types, a check box 854 for opting to enter a “Correct Response” to the poll, a free form text field 856 for entering the “Correct Response,” and dropdown menus 858 related to how the poll results will be displayed (if at all). Additional selections may also be made with respect to when the poll-type post 450 is made available to users (check box 860) and when the poll will close, if at all (check box 860, field 864, and dropdown menu 868).

Available options for Question Type may include multiple choice (with an option for allowing users to respond with one or multiple answers), short answer (for eliciting open-ended responses), true/false, Yes/No, Agree/Disagree, Agree/No Opinion/Disagree, and Scaling Continuums (e.g., scale of 1 to 5 or 1 to 10). It will be appreciated that poll-type posts 450 comprising any combination of the aforementioned Question Type options may be created and/or published to the system 300 in accordance with user preference. Accordingly, users can create a poll-type post 450 having one question or that comprises a multi-question survey using the poll-type post 450 creation screen 850 and/or similar displays available through the course networking system 300.

A non-limiting example of a screenshot of a poll-type post 450 of the system 300 is shown in FIG. 9C. In this embodiment, the poll-type post 450 comprises a single, multiple-choice question that was posted to the course networking system 300 by a user identified as a Global Classmate. Further, from the post 450 itself, it can be determined that, to-date, there have been 3 responses to the polling question of the poll-type post 450.

As previously noted, users can also select display options in connection with displaying the results of a poll to the respondent users, system-wide, or pursuant to any other specified visibility settings 822. Using this functionality, after a poll-type post 450 has been posted to the system 300 pursuant to the established visibility settings 822 and at least one user has responded, the poll-type post 450 can be configured to display information related to user responses, either by way of a pop-up window or otherwise.

For example, in response to a user submitting an answer to a poll-type post 450, the system 300 may automatically display a graphical or descriptive representation of the responses received to-date from the totality of the responding users. Indeed, pie charts, line graphs, bar charts, percentage breakdowns, and even user responses and the breakdown of responses (including or omitting respondents names) may be used pursuant to user preference. Accordingly, poll-type posts 450 are fully and easily customizable and provide a valuable tool for fostering collaboration and discussion between users over the course networking system 300.

FIG. 10D illustrates at least one embodiment of the end-product of the Results Display functionalities associated with use of the system 300. As shown in FIG. 10D, in response to a user selecting a multiple choice answer in response to the poll-type post 450 shown in FIG. 10C, results content 870 is displayed. Specifically, a graphical interpretation 871 of the respondents' answers is provided, as well as percentage breakdown 872 of the same. Additionally, the correct answer 873 to the polling question is displayed.

Now referring to FIG. 10E, a partial screenshot of an event-type post 450 creation screen 875 is shown. Creating an event-type post 450 allows users to make announcements about upcoming events and functions. For example, in at least one embodiment, a user can publish an event-type post 450 to call for a group study session, to remind classmates of a function on campus, or to announce a keynote speaker visiting their department at school. As with the other post 450 formats, visibility settings 822 can be utilized to make the event visible to the relevant users of the course networking system 300 (e.g., users associated with a specific course, Conexus, or Personal Network).

In the embodiment of the event-type post 450 creation screen 875 of FIG. 10E, the post fields 812 are configured to solicit information relevant to planning and holding an event (e.g., indicate a location, provide a description and a start and end date/time, as appropriate). In at least one embodiment, event-type posts 450 may also be linked to a one or more calendar functionalities of the system 300 (such as those associated with a course, a user's homepage 400, etc.).

Now referring to FIG. 11, an informational-type post 450 that has been published to the course networking system 300 is shown displayed in the post display window 412 of the homepage 400. It will be appreciated that while only a single informational-type post 450 is shown in FIG. 11, this is only for simplification and explanatory purposes. Typically, in application, the post display window 412 will display a series of posts 450 presented in chronological order pursuant to when posted or, alternatively, organized in some other manner.

As illustrated in FIG. 11, each post 450 comprises content 902 (which may include any combination of text, links and/or uploaded files, images, etc.), posting user identification 904, the visibility setting 906 assigned to the post 450 (here, the “All CN Members” label indicates that the post 450 is visible all members of the course networking system 300), publication information 908, post action buttons 910, and a collaboration window 912. The publication information 908 indicates when the post 450 was created and/or published to the system 300, as well as viewing information with respect thereto (i.e. this particular post 450 has been viewed by users 1,990 times).

The post action buttons 910 provide specific functionality to a user with respect to that particular post 450. For example, selecting the “Repost” button reposts the post 450 on the system 300 via the reposting user's account and/or to an external social media network, as desired. It will be appreciated that the reposting user may establish his or her own visibility settings 822 with respect to the reposted post 450 and, in at least one embodiment, the original author of the post 450 will be credited in the posting user identification 904 or otherwise. Additional options include emailing the post 450 to a third party (as an attachment or otherwise) using the email communications application of the course networking system 300 and/or translating the post 450 through the use of the translation tool via the translate link 451.

The collaboration window 912 is where users may “like” and/or “reflect” upon that particular post 450, and where the resulting content is displayed. As is conventionally known, a “like” may be used by a user to show general support for the idea or concept presented in the post 450. However, the reflecting aspect of the collaboration window 912 takes user feedback a step farther. Through the reflection functionality of the course networking system 300, users can provide a type of peer review that facilitates effective learning. For example, when there is confusion on a course concept such as the definition of equilateral triangles, users can respond to an inquiry informational-type post 450 to provide explanatory reflections (using text, animations, video, and the like) from a variety of perspectives to further explain the concepts of interest. In this manner, each user can play the role of a teacher, drawing from a massive amount of complementary resources, teaching styles and knowledge. Accordingly, the course networking system 300 described herein may be used to provide socially-mediated learning that is not only extensive and comprehensive in terms of resources, but also rewarding, engaging and entertaining for its users.

Through use of the course networking system 300, users are primarily communicating with an audience of peers. This system 300, and the posting and reflection tools in particular, establish an approach to education and information sharing where users are encouraged to digest and present information in their own terms, which necessarily facilitates authentic communication between users/peers. Importantly, the methods of information sharing and collaboration facilitated by the course networking system 300 serve as direct and indirect supports for more effective learning.

As the course networking system 300 is global in nature, and can support an extensive amount of users, it is important that users are able to organize and effectively search content available thereon in an efficient manner. Accordingly, the course networking system 300 includes searching, sorting and filtering functionalities and feature sets such that a user can easily access and strategically view content within the system 300. In at least one embodiment, posts 450 displayed on a user's homepage 400 can be searched and/or sorted according to subject matter, keyword, user, and/or user-established associations. It will be appreciated that this same sorting and storing functionality may also be applied to course and Conexus feeds. For example, in at least one embodiment, a “Sort by” box may be included the homepage 400 and used by a user to selectively order, sort and/or filter the content (such as posts 450, for example).

One means through which the course networking system 300 may sort, order, filter and/or search content in the system 300 is through the use of hashtags, labels, or tags. For example, in at least one embodiment, hashtags may be added into posts 450 or other content by the user as is known in the art to signify the post's subject matter or relevancy. In this manner, the system 300 may easily search for posts 450 and other content on the system 300 that is labeled or tagged with the appropriate search term (i.e. perform a filter search).

Expanding upon this baseline labeling and searching technology, an instructor or other content mediator of the system 300 may define a series of hashtags, labels, or tags —akin to discussion topics—as a way to guide and/or narrow discussion over the network as it relates to particular topics. For example, an instructor of an online course may define a series of five (5) hashtags and indicate that all discussion posts 450 published on the relevant course page 480 must include one or more of these topics (and be labeled with one or more of the appropriate hashtags). In this way, an instructor may employ the labeling methodology to define parameters for discussion.

Additionally or alternatively, use of the hashtags can enable a one-click searching capability. In at least one embodiment, for example, an instructor may instruct his students to consistently tag content published to the system 300 (posts 450 or otherwise) associated with a particular assignment with a particular hashtag or label (e.g., “#termpaper”). In connection with this application, the system 300 is configured to automatically identify all of the content associated with that hashtag or label upon a search for the same. Accordingly, simply by clicking on, or otherwise searching, the hashtag #termpaper, a system user can be automatically linked to all of the content on the system 300 or within a course that is associated with that hashtag/label. Use of this hashtag or label functionality by all of the students in a course (or even Global Classmates for that matter) thus provides a methodology for automatically and dynamically categorizing searchable content.

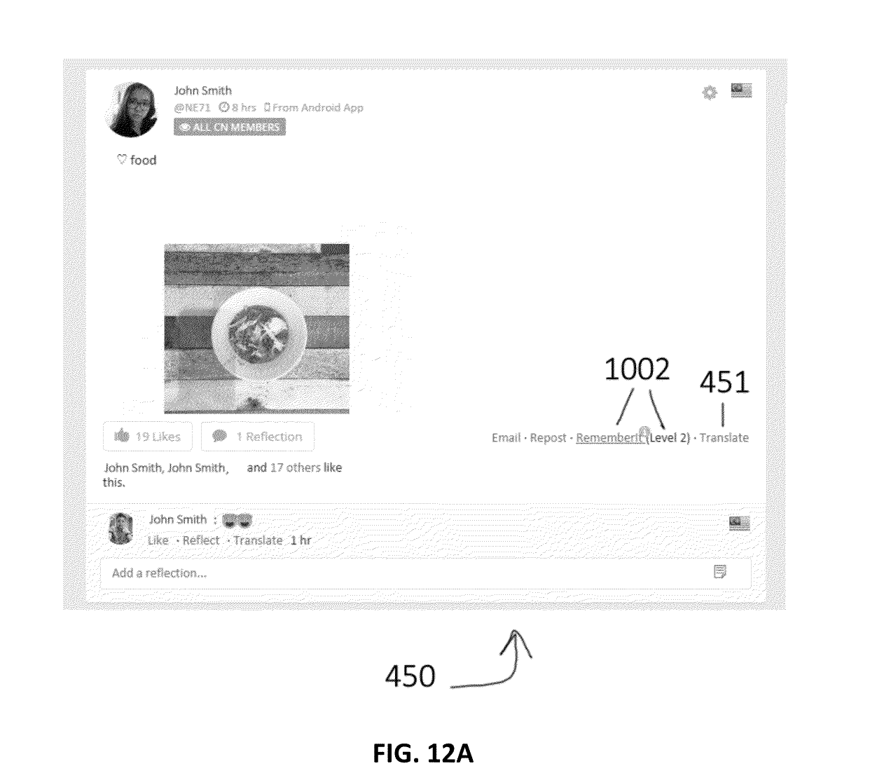

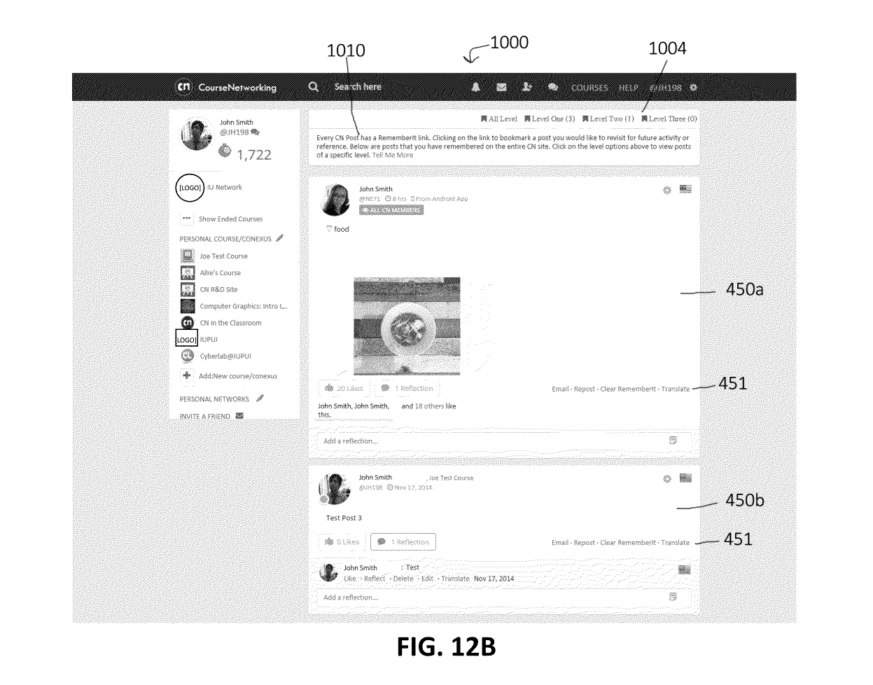

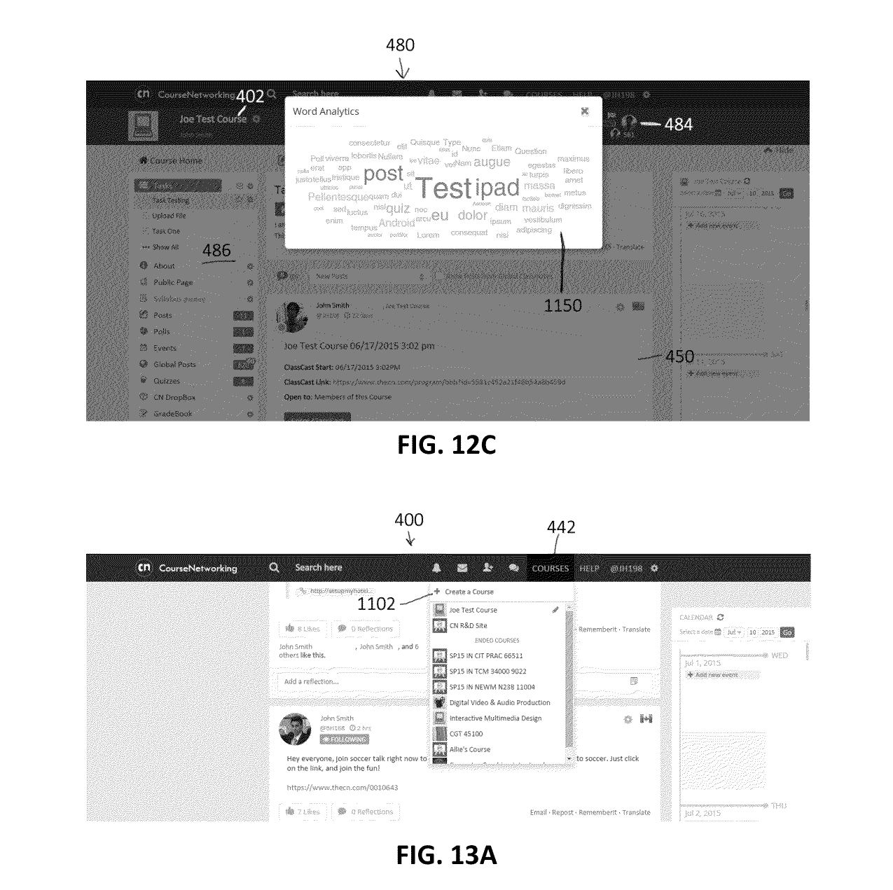

Now referring to FIGS. 12A and 12B, additional or alternative functionality of the system 300 with respect to organizing, sorting and/or filtering posts 450 will be described. Perhaps more specifically, the system 300 provides certain tool sets for tagging posts 450 of particular interest to a user and/or for later activity or attention, as well as a means for organizing such identified posts 450 into a user-defined hierarchy.

Every post 450 on the course networking system 300 has a RememberIt link 1002, regardless of from where such post 450 originated. The “RememberIt” tool is one mechanism that a user can employ to designate posts 450 for later activity or attention. For example, if a user identifies a post 450 that is of interest, he or she need to simply select the RememberIt link 1002 associated with that post 450, which will mark/categorize it as a post 450 of interest to that user (a “marked post 450”).

The RememberIt tool also enables users to distinguish between marked posts 450 via a user defined classification system. Clicking on the RememberIt link 1002 related to a post 450 will display a level-based ranking or designation to be associated with the marked post 450. For example, in at least one embodiment, the words “Level 1,” “Level 2,” or “Level 3” are displayed, depending on how many times that user clicks the link 1002 (see link 1002 of FIG. 12A displaying a “Level 2” designation). In at least one embodiment, these level designations represent one, two or three strings tied around the finger icon 1004 located in the top menu bar of the homepage 400, which may be indicative of the importance and/or urgency of a marked post 450 to the user. However, because in at least one embodiment, this functionality of the RememberIt tool is a user-defined classification system, the various Level designations need not be hierarchical at all and may simply be used by the user to distinguish different classes of marked posts 450. Accordingly, a user can use the RememberIt tool to not only single out noteworthy posts 450, but to also differentiate between the marked posts 450 using the labeling or classification function of the RememberIt tool.

The RememberIt tool may be directly accessed from the homepage 400 via RememberIt tool link 440 (not shown). As shown in FIG. 12B, upon selecting the RememberIt tool link 440, the user will see a window 1010 containing a list of all of the marked posts 450 he or she has designated using the RememberIt tool. In FIG. 12B, two marked posts 450a, 450b have been designated by the user. The RememberIt window 1010 may additionally comprise one or more finger icons 1004, each indicating a different classification or level of hierarchy as defined by the user. As shown in FIG. 12B, this user has one post 450 marked with a Level 1 (one string) importance, and one post 450 marked with a Level 2 (two string) importance. By clicking on these icons 1004, a user can further restrict the display to only those marked posts 450 having a specific Level classification. For example, by clicking on the icon 1004 having one string, only those marked posts 450 having a Level I classification will be shown in the window 1010.

Additionally or alternatively, the system 300 can employ word analytics to sort and distribute posts 450 according to subject matter. In such an embodiment, the system 300 analyzes each post 450 to identify meaningful patterns and/or repetition in the word choice thereof in order to ascertain the subject matter of the post 450. After one or more post subjects are identified, the system 300 associates the post 450 with one or more categories of groups, Conexus, courses, etc. that relate to the subject matter of the post and distributes the post 450 to the members of such groups. As such, this word analytics functionality assists in sorting through and filtering out only those posts 450 with relevant subject matter for distribution to interested parties. FIG. 12C shows at least one embodiment of a display of word analytics results 1150 based on the post 450 shown in the background. In that embodiment, the number of times a word appears in the post 450 is represented along a font-size continuum, with the most repeated words (and thus most likely to be at the heart of the post's subject matter) being in the largest font and the least repeated words being in the smallest font.

In at least on embodiment of the system 300, the course networking system 300 comprises course creation and management tools that allow for the creation, monitoring, control and customization of online courses offered through the course networking system 300. Perhaps more specifically, the course networking system 300 hereof provides the requisite tools such that a user can create, monitor, control and customize courses offered through the system 300 from a web browser interface. For example, the system 300 allows instructors, operating within the system 300 as users, to customize various aspects of a course on the system 300 in order to suit their needs and preferences. Furthermore, it will be appreciated that any users may create, monitor, control and customize courses through the system 300, and that such users need not be professional instructors.

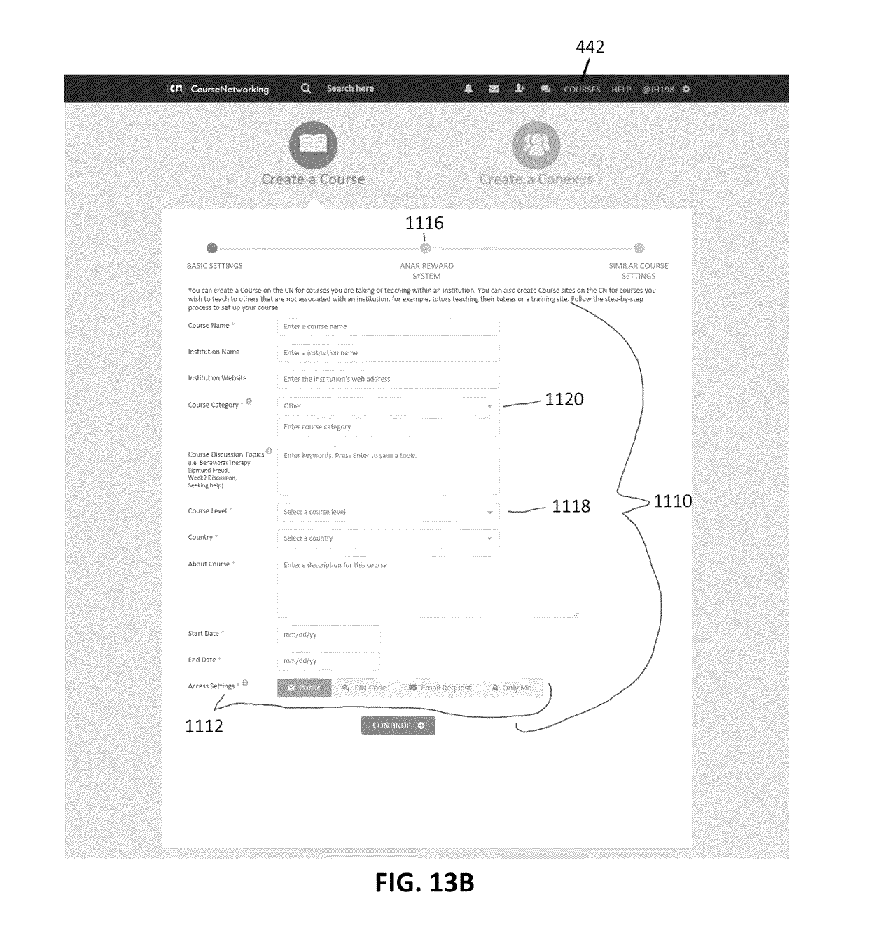

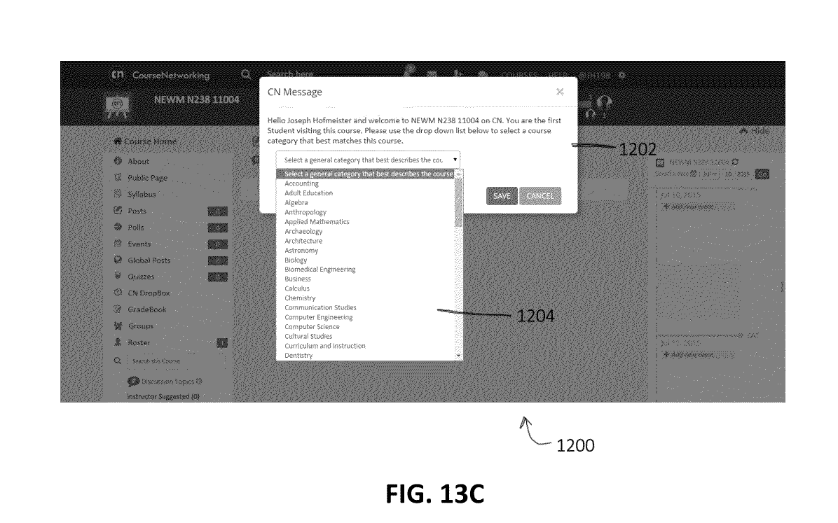

The course networking system 300 provides an easy-to-use interface for course creation. Now referring to FIG. 13A, any user can access the course creation functionality simply by selecting the appropriate option (e.g., accessing the course creation tool via the courses menu link 442 on the homepage 400, and subsequently clicking the Create a course link 1102 in the resulting dropdown menu).

FIG. 13B illustrates at least one embodiment of a screen shot of a course creation webpage 1100 of the course networking system 300. The course creation webpage 1100 provides an efficient and easy-to-use mechanism through which the user can customize the course and its underlying features. As illustrated in the screen shot shown in FIG. 13B, in creating a course on the system 300, the webpage 1100 may comprise the following fields and/or webpage components to obtain information from the user regarding the course: (a) general information fields 1110 for gathering general information about the course being created; (b) course access/enrollment settings 1112 (e.g., available to any system 300 user, limited via access code or email request/administrator approval, or open for a limited-time (i.e. certain dates only for the self-enroll feature)); (c) a MOOC platform option 1114; and (d) a reward tool option 1116. Examples of general course information may include course Name, the physical location where this course will be offered in conjunction with the online course (if applicable), course subject matter categorization, course level, the school associated with this course (if any) and its related information, duration of the course, a general course description and/or a syllabus upload option. Any other information that may be useful with respect to setting up the course may also be requested by the system 300 in addition to, or instead of, the above-listed examples.

It will be appreciated that if the user creating the course falls under the umbrella of a specific System Client's channel (i.e. is associated therewith), then the overall format and substantive nature of the course creation webpage 1100 and/or any other such pages may be established by the governing administrator. For example, a channel administrator may define the available options with respect to the course creation tool and/or the associated course creation webpage 1100 in order to facilitate seamless integration of the course networking system 300 with those processes and terminology already employed by the System Client. For instance, an administrator may specify the course level values 1118 that are available for selection in the dropdown menu informational fields 1110 to ensure such values correspond with the course levels of the System Client. Additionally or alternatively, an administrator may establish a rule that all courses created under its channel will be automatically populated with standard information associated with the System Client, such as the school website address information and/or the duration of the course. As such, an administrator can ensure that standardized terms, dates, etc. are employed in connection with all courses offered through the system 300 that are associated with a particular System Client, thereby maximizing integration of the system 300 with established methodologies and legacy systems of the same.

Notwithstanding the aforementioned, if an administrator does not customize a feature of the system 300, the course networking system 300 may populate the available selections pursuant to its default settings. Furthermore, some fields may be customized by an administrator, while other fields are defined by system 300 defaults. Additionally, the system 300 is configured such that a user creating a course may either associate the course with an institution, which may or may not be a System Client (see the “Create a School-Based Course” input option 1122), or create a course that is personal to the user (see the “Create a Personal course” input option 1124). In this manner, even if a user is associated with a System Client and, thus, under the umbrella of such System Client's channel, he or she is not required to assume the preset customization associated with such channel, but instead may independently decide whether to opt the course into the channel's settings or keep it independent thereof.

Furthermore, a user need not be a professional instructor or have any association with an educational institution or a System Client to access and use the course creation and management tools of the system 300. Where a non-instructor user desires to create a course on the system 300, he or she need only access the course creation webpage 1100 and, instead of selecting the “Create a School-Based Course” button within the general information fields 1110, select the “Create a Personal Course” option. In this manner, the course creation and management tools are available to all users of the system 300, irrespective of their educational and/or professional status or affiliations.

Course categorization as performed by the course networking system 300 will now be described. As shown in FIG. 13B, a course category field 1120 may be specified as an input option in connection with course creation. The course category field 1120 enables the system 300 to assign a category to each course of the system 300 in accordance with the subject matter thereof.

Course subject matter categorization can drive significant system 300 functionality with respect to facilitating user collaboration, global resource development and dissemination of information, and meaningful networking between courses. For example, course categorization can be employed to identify Global Classmates and Global Instructor associations between non-collocated users of the course networking system 300. As previously described herein, Global Classmates and Instructors are those users who are enrolled in courses on the system 300 that are similar to each other's courses from a subject matter perspective. By identifying Global Classmates and promoting the dissemination of information between the same, the course networking system 300 connects users of the system 300 located throughout the world together in a very dynamic and convenient way. Unlike conventional Internet-based systems, the course networking system 300 not only allows for its users to connect with other individuals around the world that have similar interests, but does so in a structured environment that can be subject third-party moderation to facilitate meaningful and thoughtful discussion of one or more particular topics amongst the worldwide user-base. Additionally, this functionality promotes professional networking and relationship building; users who may be located at different schools can nevertheless develop working relationships that may be professionally beneficial in the future.

Consider, for example, an embodiment where a course is Journalism 101 and it is a complementary online component of the same physical course being offered at the University of Texas in Austin (UT Austin). In this case, the value selected for the course Category field 1120 in the course creation webpage 1100 would be “Journalism” from the dropdown menu. The course networking system 300 can then use this subject matter classification to facilitate meaningful interactions between the members of the UT Austin course and the other users of the system 300 that are enrolled in different courses, potentially located around the world, but where those courses are also categorized as being associated with Journalism. In effect, the Global Classmates would be granted access permissions to view the posts 450 associated with each of the associated courses and, in at least one embodiment, such posts 450 would automatically populate to each of the various associated course pages.

Where a course is created on the system 300 that does not seem to fall exactly in any of the categories available for selection, a user can propose the creation of a new category on the system 300. As shown in FIG. 13B, where the appropriate category is not present in the course Category field 1120 dropdown menu, a user may select “Other” and manually enter the proposed course category. The course networking system 300 monitors new category creation and may either approve or deny the proposed course category. If the proposed category is approved, the course being created will be categorized as such and the new category will automatically be incorporated into the system 300 for application to other courses. Denial of a category, however, may occur where the course networking system 300 determines that the proposed course category is not sufficiently distinguishable from one or more of the existing categories. In at least one embodiment, when the proposed category is denied, the course may be assigned to one of the existing categories by the system 300. Accordingly, the course networking system 300 provides for the accurate categorization of the courses, while also ensuring that the number of available course categories does not become so large as to lose their significance and become cumbersome.

FIG. 13C illustrates additional system 300 functionality with respect to course categorization and pairings of courses on similar subject matter. FIG. 13C shows a screenshot of a course page 1200 associated with a course that has not yet been categorized with the course networking system 300. A popup window 1202 is displayed in the foreground, requesting that the user, as the first student visiting the course, identify the appropriate course category from the dropdown menu 1204. Accordingly, the system 300 may comprise safeguards and/or follow-up mechanisms for ensuring that courses are assigned categories upon their creation on the system 300.

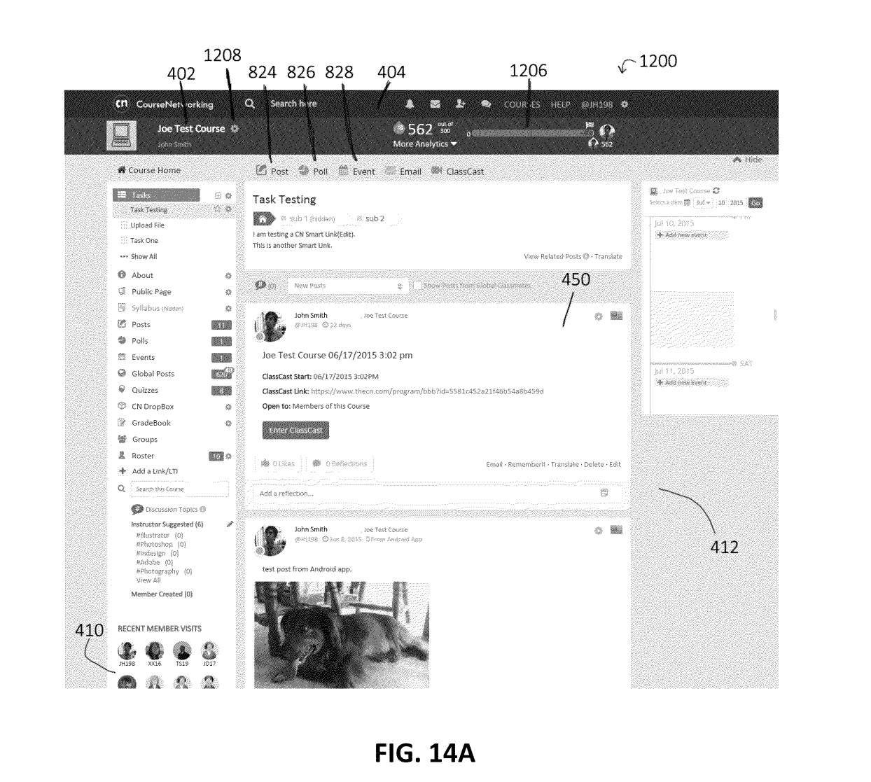

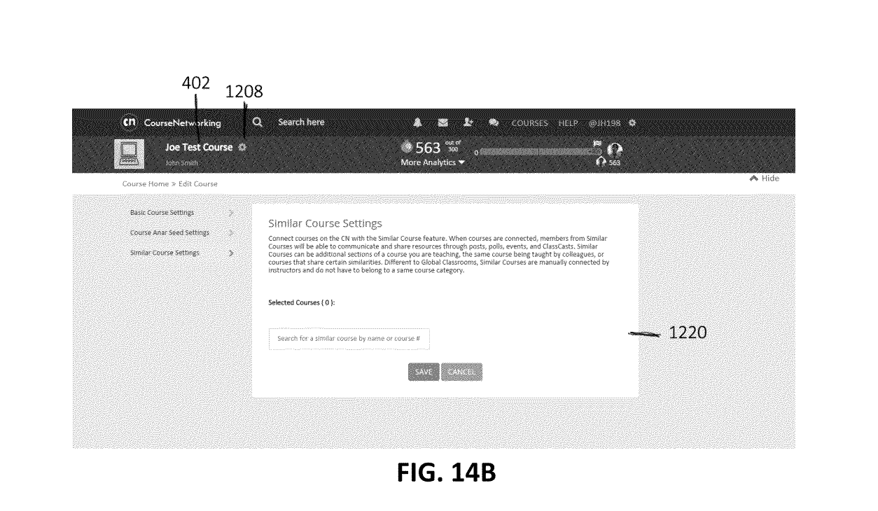

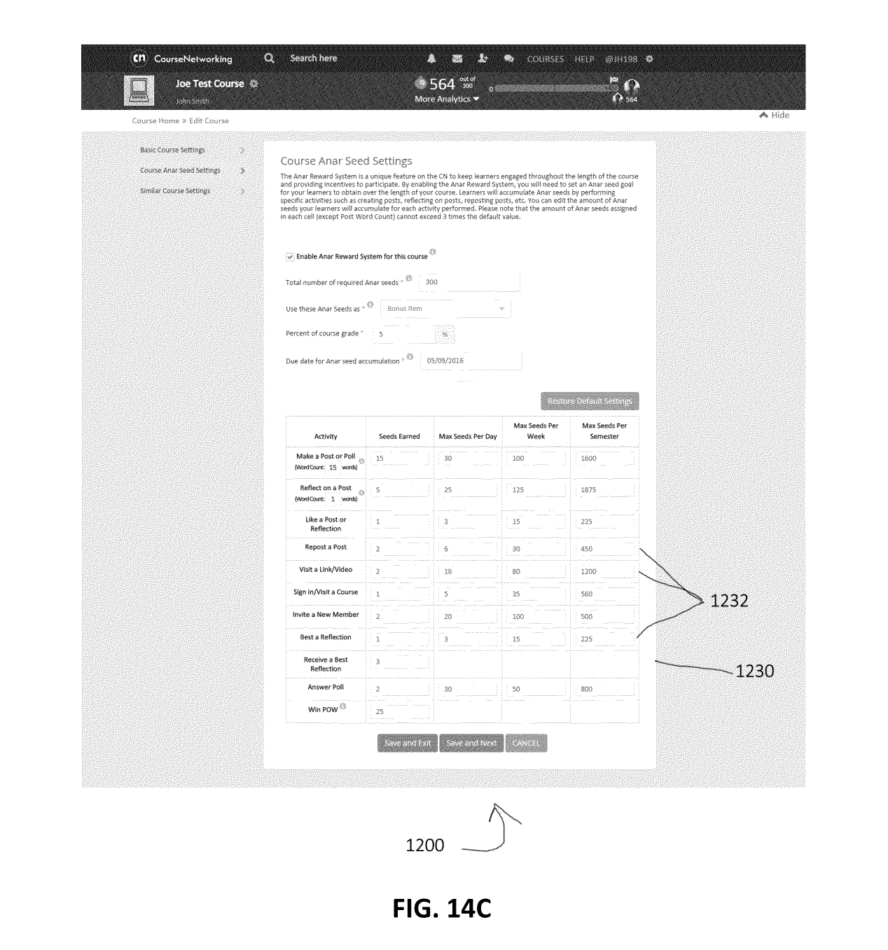

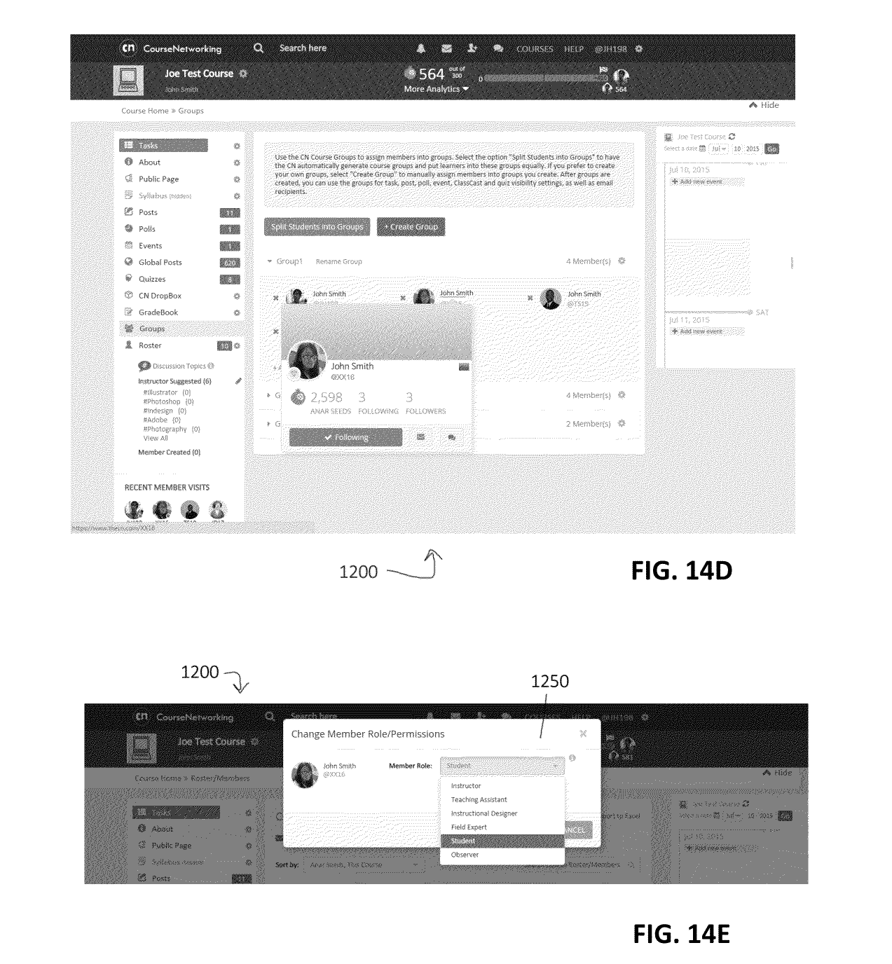

Course customization functionalities will now be described in connection with FIGS. 14A-14E. As previously described, course page 1200 is automatically populated by the system 300 following a user's completion of the course creation functionality. However, a user may further customize the course page 1200 and, thus, the feature sets of the course itself, by accessing the [settings link 1208.

FIG. 14B illustrates a screenshot of course page 1200 having a “Similar Courses” popup window 1220 displayed in the foreground. Here, a user can manually enter other courses on the course networking system 300 with which his or her course should be associated. In at least one embodiment, such “Similar Courses” may comprise additional sections of the same course that are held at the instructor's place of employment, similar courses being taught in other educational institutes and/or any other course that an instructor deems beneficial. In application, designating one or more courses as “Similar Courses” has a similar effect as if the course networking system 300 assigned the courses like categorizations; specifically, the users of Similar Courses are considered Global Classmates such that those members will all have access to each other's course-related content.

As previously described, embodiments of the course networking system 300 may utilize a rewards tool to provide incentives for users to participate in social learning and collaboration. The rewards tool is fully customizable. Indeed, instructors and/or moderators have the ability to alter the number of rewards points (i.e. Anar seeds) users are able to accumulate in their course via the “Course Anar Seed Settings” link of settings link 1208. Accordingly, if a rewards tool is designated for a course or Conexus, FIG. 14C illustrates at least one embodiment of an interface 1232 that may be used to define and assign specific point values to particular activities and/or student accomplishments. Perhaps more specifically, while the system 300 does provide default settings, an instructor may choose to manually modify some or all of the rewards parameters and conditions for a course. Additionally, in at least one embodiment, an instructor/moderator can limit the total number of points that may be awarded within a given period of time, and/or adjust the total amount of points available.

Specified group settings within a course may also be defined. For example, as shown in FIG. 14D, an instructor can identify a particular group of students within the course for inclusion in one or more groups. This functionality can be accessed via the “Group Settings” link of settings link 1208.

In at least one exemplary embodiment of the course networking system 300, roles of members within a course or a Conexus may also be defined. As shown in FIG. 14E, the “Role Settings” link of settings link 1208 results in window 1250 where an instructor or moderator can easily define and/or change member roles. For example, an instructor may change a member role from Student to Teaching Assistant.

It will be appreciated that it is beneficial for different roles to have different access permissions and content editing/publication rights. Indeed, this aspect may to be customized using the system 300. For example, a member designated as a Teaching Assistant or Graduate Assistant may have greater access permissions with respect to the visibility of content within the Gradebook and/or Tasks tools. In this manner, an instructor can specify a particular student to assist with grading and the like, while limiting threats to information security. Additionally and perhaps obviously, an instructor may be given many more rights and permissions than, for example, a Student when it comes to customizing the functionality of those tools and/or the rewards system or accessing information associated therewith.

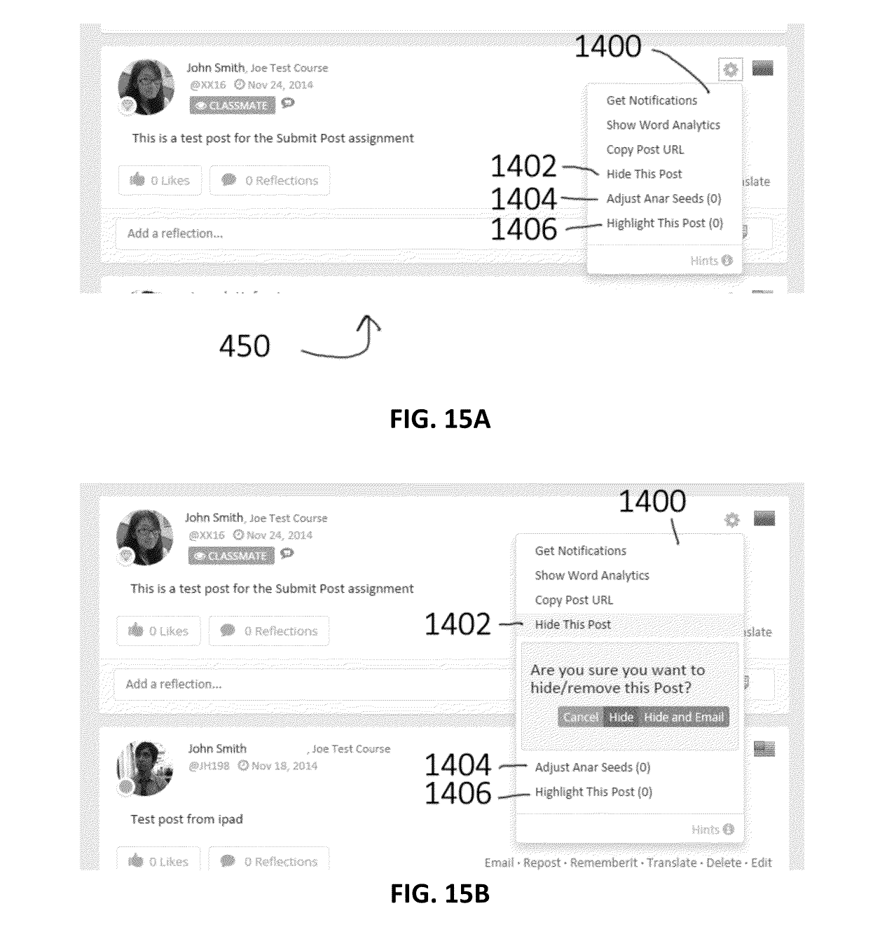

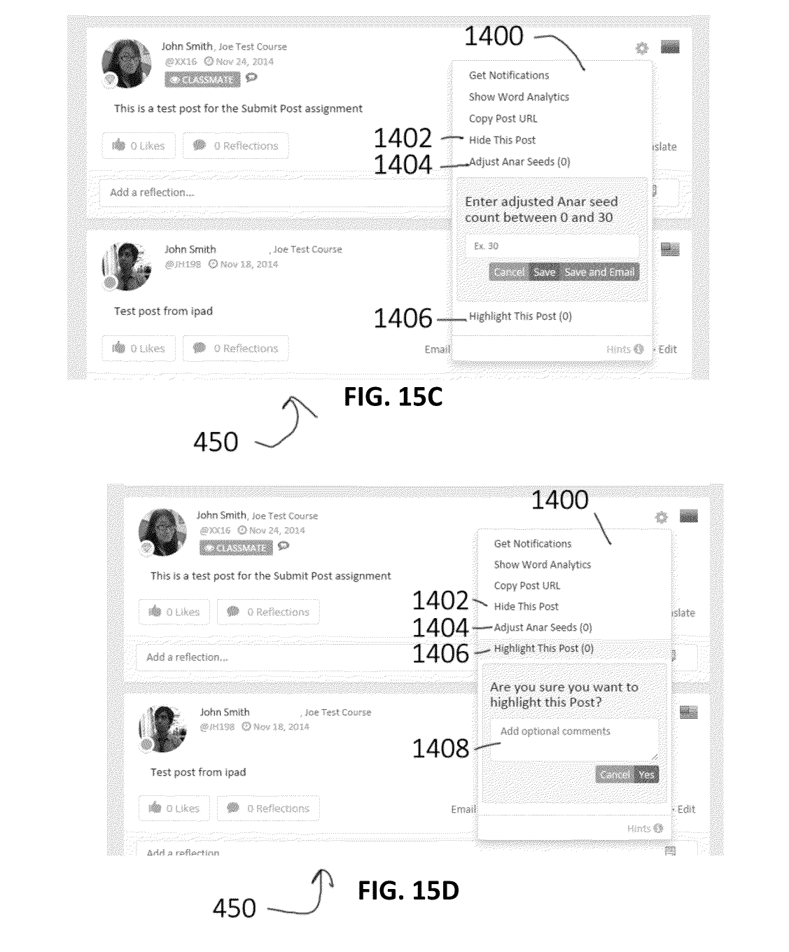

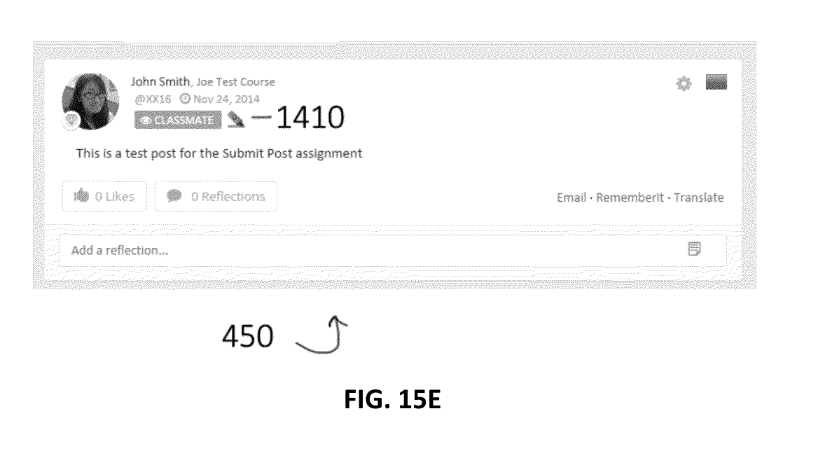

The course networking system 300 may also be configured to provide instructors with certain rights relating to post management in connection with their courses. Now referring to FIGS. 15A-15E, a pop-up window 1400 is shown displaying a series of options associated with the posts 450 published to the course page 480. In the at least one embodiment shown in FIG. 15C, the post management options may include, without limitation: Get Notifications, Show Word Analytics, Copy Post URL, Hide this Post, Adjust Anar Seeds, and Highlight This Post. In addition to those expressly mentioned herein, it will be appreciated that any number of post management options may be incorporated into the system 300.

Primarily, the Get Notifications option simply activates the system's 300 notification functionality such that the instructor is notified of any activity associated with a particular post 450. For example, if/when other students reflect on the post 450, the instructor will be notified. Additionally, the Show Word Analytics option runs analytics on the post 450 to ascertain the subject matter thereof. In at least one embodiment, the results of selecting such option could be formatted similarly to the display of word analytics results 1150 shown in FIG. 12C. The Copy Post URL is similarly straightforward—it enables the instructor to easily copy a link to the post 450 to facilitate easy distribution of the same.

The Hide This Post option 1402 provides an instructor with the ability to hide a post 450 from the students, a functionality that is useful in the event an instructor is not comfortable with a post 450 submitted to the course page 480 by a student. Alternatively, the Hide This Post option could simply be used to filter out less relevant posts 450 posted by Global Classmates, etc. Selection of the Hide This Post option 1402 effectively changes the targeted post's 450 visibility settings such that the post 450 is only displayed to the instructor and is not visible to any other students in the course (i.e. classmates) or similarly categorized courses or groups. Additionally, in the at least one embodiment of the system 300 shown in FIG. 15B, when the Hide This Post link is selected in the pop-up window 1400, the system 300 automatically provides an e-mail link such that the instructor can easily and efficiently e-mail the author of the post 450.

Where a rewards tool is used in connection with a course, an instructor may use the post management options to modify the points associated with a post on a case-by-case basis. As previously described, the rewards tool of the course networking system 300 can be configured such that a prescribed amount of points are automatically allocated to a user for publishing a post to the course page. However, if an instructor is not satisfied with a student's post, the “Adjust Anar Seeds” option 1404 enables the instructor to adjust the amount of points allocated to that student in connection with the post 450. Alternatively, an instructor may use this option 1404 to increase the number of points awarded in connection with the post 450 in the event the quality of the post 450 is outstanding (see FIG. 15C).

Furthermore, an instructor can “highlight” a post 450 and add a personal note thereto using the Highlight This Post option 1406 and the related comment field 1408, respectively. For example, where a student submits an outstanding post 450 that the instructor would like to recognize, the instructor can use the Highlight This Post option 1406 to identify the post 450 and also add his or her reflection thereto (using comment field 1408). In at least one embodiment, highlighting a post 450 results in the post 450 automatically appearing on the top of the post feed in the post display window 412. This priority placement of the highlighted post 450 increases the probability that all students will see the highlighted post 450 the next time that they log into the course networking system 300 (irrespective of when the post 450 as published). Additionally, as shown in FIG. 15D, for post 450 that has been highlighted, a highlighter icon appears next to the post 450 to provide additional visual attention.

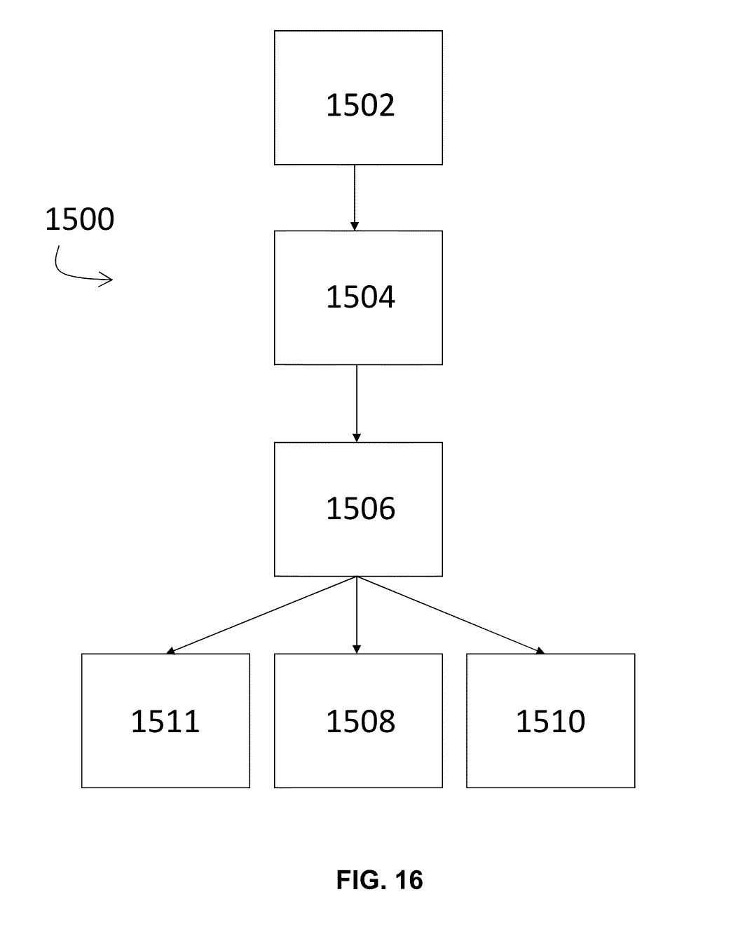

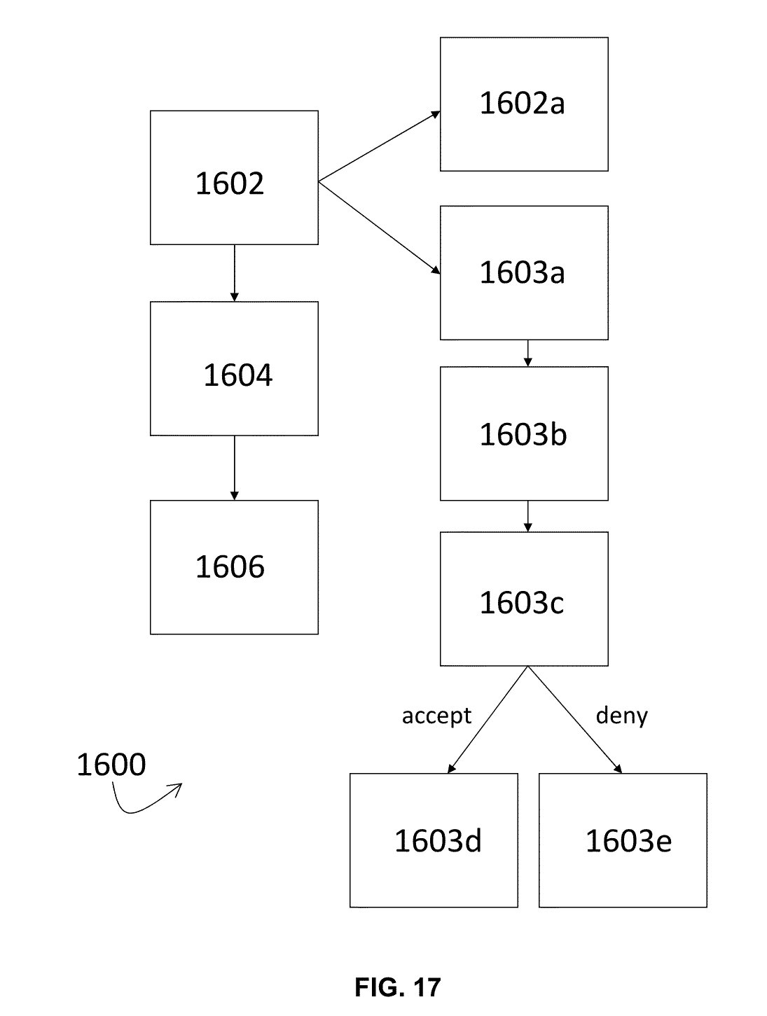

Now referring to FIGS. 16 and 17, flow charts of various exemplary methods of the present disclosure for facilitating user collaboration and communication using the course management system 300 are shown as performed in accordance with one or more embodiments hereof.

FIG. 16 illustrates a flow chart of a method 1500 for facilitating user collaboration and communication across the course networking system 300 through use of the system's 300 rewards tool. In at least one embodiment, an instructor of a course or a moderator of a Conexus may perform method 1500 to promote user's meaningful engagement in the online course or Conexus environment, respectively. Accordingly, performance of the method 1500 facilitates active user involvement and collaboration across the course networking system 300 and, thus, helps to provide an engaging learning experience.

Upon deciding to utilize the rewards tool of the course networking system 300, a user (e.g., an instructor) defines one or more participation parameters as step 1502. For the sake of clarity, the user performing method 1500 as described herein will be referred to as an “instructor”; however, it will be understood that this term is not intended to be limiting as any user of the system 300 who is creating a course, group or Conexus may perform this method 1500.

As previously discussed, what constitutes meaningful engagement or participation varies between courses and groups and, as such, the rewards tool is fully customizable. In at least one embodiment, at step 1502 an instructor may define participation parameters pursuant to his or her overall goals with respect to the related course, group or Conexus. For example, the instructor may identify various activities that, when successfully performed by a user using the course networking system 300, result in a reward. In at least one embodiment, such activities may comprise publishing posts related to the subject matter of the course or group, reflecting on classmates' posts, interacting with classmates through the system 300, participating in online quizzes accessible through the related course page, completing tasks in a timely manner, etc. Additionally or alternatively, the instructor may also include a quality component in one or more of the participation parameters. Where a quality component is defined, the mere performance or completion of an activity is not sufficient to earn some or all of the associated reward; instead, such activity must also satisfy the identified quality standard. For example, an instructor may specify that posts and/or reflections must contain a certain number of words to be eligible for a reward, quizzes must be performed within a specified period of time, and/or tasks performed prior to a specific date.

Furthermore, at step 1502, the user may also assign a certain number of points to each activity such that when it is successfully completed by a user, that number of points will be allocated to the user's reward account. Where points are awarded, the instructor also has the option to specify if the points are to be earned in a cumulative fashion over a period of time (e.g., a semester or the school year) and an instructor can even define interim goals. For example, where the overall time period for the rewards program is defined to be a semester, an instructor may also define interim goals every 6 weeks or so to ensure that the students are not waiting until the end of the semester to perform all of the necessary activities associated with an online course.

After the participation parameters are defined at step 1502, the method 1500 progresses to step 1504. At step 1504, the course networking system 300 tracks the relevant users' activity with respect to the course, group or Conexus, as well as their activity with respect to the overall course networking system 300. This functionality is typically performed on the back-end of the system 300; however, in certain embodiments it may be desirable to allow one or more users visibility to the tracking logs. For example, an instructor or administrator may find it helpful to view the activity tracking information for each of his or her students and/or users or, even students may prefer to see this information regarding their own activity on the system 300. In such cases, the system 300 may be configured to provide this functionality.

Notably, a single user may participate in one or more rewards programs concurrently. Indeed, a user may be a student in multiple online courses that utilize the rewards tool and one or more Conexus that utilize the rewards tool. Additionally, the system 300 may also concurrently track such user's overall activity on the system 300 and allocate certain rewards with respect thereto. As such, the system 300 is capable of tracking each user's activity on the system 300 and associating the relevant activity to the appropriate rewards program(s) and the associated participation parameters.

At step 1506 of the method 1500, the course networking system 300 dynamically quantifies the participation data gathered at step 1504 for each user in terms of the participation parameters for the appropriate rewards program. In other words, for each rewards program, the system 300 automatically compares a user's relevant actions on the system 300 to the participation parameters defined in step 1502 and determines if such activities satisfy the standard set by the instructor or fall short. If an activity is determined to satisfy the instructor's parameters, the method 1500 automatically advances to step 1508, and the user is awarded with a reward (e.g., a predetermined amount of points—or Anar Seeds). However, if the activity does not satisfy the instructor's parameters, the method 1500 either advances to step 1510 where no reward is awarded for the activity, or advances to step 1511, where a partial reward is awarded to the user for the activity (if a partial reward was contemplated and defined in the instructor's initial set up criteria). It will be appreciated that steps 1504-1511 of method 1500 may be performed concurrently and constantly such that the tracking, quantification and awarding functionalities of the system 300 occur in near-real time and are immediately available to the user.

Notification functionalities may also be associated with steps 1508-1511. For example, in at least one embodiment, the system 300 may provide the user with a notification at step 1508, 1510 or 1511 that indicates whether or not the user obtained a full or partial award for a particular activity. Such notifications can be customized by an instructor back in step 1502 and may comprise any format desirable. In at least one embodiment, the notifications may be provided continuously in the form of the progress bar in the participation management window 484 (see FIG. 4D) such that a user can always assess where he or she is at with respect to the instructor-defined parameters.

Now referring to FIG. 17, a flow chart illustrates an additional exemplary method 1600 for comprehensive content sorting and dissemination using the course networking system 300. The method 1600 hereof provides for an automated and convenient way to classify and distribute information according to subject matter and, thus, promote meaningful collaboration between users of the system 300. Indeed, method 1600 enables users—even when located in different parts of the country or world—to easily collaborate and share information relating to a particular subject matter area.

Primarily, all of the users of the course networking system 300 are in some way associated with one or more subject matter categorizations. For example, when a user establishes their initial account with the system 300, he or she provides information to the system 300 regarding their interests. The system 300 is configured to analyze this information (either through word analytics or otherwise) and, based on those results, automatically associate the user with one or more categories of subject matter. Furthermore, each course/group/Conexus of the system 300 is associated with one or more categories. When a user creates and/or is enrolled in a course, group and/or Conexus, the categorization of the same is also associated with the user. The course networking system 300 can then use this interest-specific information to automatically and dynamically route related to content —either directly or through a course/group/Conexus—to the user in an effective and organized manner.

In at least one embodiment, method 1600 can be employed to categorize information and strategically route the same to interested users. At step 1602 of the method 1600, the courses, Conexus and other groups available over the course networking system 300 are all categorized according to subject matter. This categorization can either be performed automatically by the system 300 itself through word analytics or other means, or manually by a user (e.g., a course or Conexus creator).

When a user manually assigns the categorization, step 1602 comprises one or more sub-steps 1602a or 1603a-1603e. Perhaps more specifically, when a user of the course networking system 300 creates a course/group/Conexus and desires to manually categorize the same, at sub-step 1602a, the user selects an existing category in the system 300 to assign to the course (which may be provided through a dropdown menu or otherwise). Alternatively, if the user believes that the subject matter of the course, group or Conexus does not fall exactly within any of the existing categories, the user may propose the creation of a new category in the system 300 at sub-step 1603a.

The course networking system 300 is configured to continuously or periodically monitor for the creation of new categories within the system 300. Accordingly, as a result of its ongoing category monitoring processes, at sub-step 1603b the course networking system 300 identifies the new proposed category created by the user. After identifying the new proposed category, the system 300 compares the new category to the existing categories at sub-step 1603c to determine if the new proposed category is distinct enough from the existing categories to justify the creation of a new category. The logic employed by the system 300 at this sub-step 1603c to determine the range of acceptable differences between two or more categories may be established by an administrator of the system 300 or by any individual as is appropriate. If the proposed category is approved, the method 1600 advances to sub-step 1603d and the new category assigned to the newly created course/group/Conexus and automatically incorporated into the system 300 for application to other courses, groups and/or Conexus. Denial of the proposed category, however, advances the method 1600 to sub-step 1603e. At sub-step 1603e, the new proposed category is removed from the course/group/Conexus and the system 300 automatically assigns an existing category to the same. In this manner, the course networking system 300 provides for the accurate categorization of courses/groups/Conexus, while also ensuring that the number of available categorizes is managed and does not become so large as to lose their significance and accessibility.

After a category is assigned to a course/group/Conexus, the method 1600 advances to step 1604. At step 1604, one or more of the users associated with that categorized course/group/Conexus publishes content—either through a post 450, educational resources, or otherwise—to such course/group/Conexus. Because the content is published to a course/group/Conexus associated with a particular category, at step 1606 the course networking system 300 distributes and/or makes that content visible to all other users, course, groups, and Conexus that fall within that category. In this manner, the method 1600 facilitates the intelligent dissemination of information to interested parties. Furthermore, users who are not collocated, at different educational institutions, etc. (i.e. Global Classmates and/or Global Instructors) can gain access to discussions, conversations and information relating to a topic of interest and even provide feedback and/or reflections to such content via the social networking tools of the course networking system 300.

While various embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for facilitating user collaboration and communication across a network-based learning environment, the system comprising:
a plurality of user devices, each associated with a user having one or more interests;
at least one server computer in communication with each of the user devices over a network, the at least one server computer comprising a processor in communication with at least one storage device;
an environment supported by the server in which information is capable of being published, the environment comprising a means for facilitating interaction between the users in the environment, the means comprising at least one or more social networking features;
a means for allowing a first user to enter and publish content in the environment to create a first entry, the first entry visible to at least one of the other users; and
a means for analyzing the first entry and identifying a subject matter indicia therein, such means executed by the processor;
wherein the at least one server computer is configured to make the content of the first entry available to those users having at least one interest that correlates with the subject matter indicia of the first entry.

2. The system of claim 1, further comprising a means for allowing a second user to create a second entry by entering and publishing reflective content in the environment in response to the first entry, wherein the second entry is associated with the first entry in the environment and available to at least the first and second users.

3. The system of claim 1, further comprising a means for allowing each user to publish a visual portfolio comprising one or more graphical icons, each of the graphic icons indicative of a credential or experience of the relevant user, and wherein at least part of the visual portfolio is visible to at least one of the other users.

4. The system of claim 3, further comprising:
a means for a user to award a certification badge to another user; and
a means for automatically publishing the awarded certification badge to the visual portfolio of the awarded user,
wherein the awarding user is designated as an instructor of a course delivered at least in part via the environment with the awarded user registered in the course.

5. The system of claim 1, wherein the subject matter indicia is selected from a group consisting of a hashtag published within the content of the first entry, a metatag associated with the first entry, and a label.

6. A system for facilitating user collaboration and communication across a network-based learning environment, the system comprising:
a plurality of user devices, each associated with a user having one or more interests;
at least one server computer in communication with each of the user devices over a network; and
a learning environment configured for the publication of information, the environment comprising one or more social networking features to facilitate interaction between the users in the environment and an incentive application, the incentive application configured to promote user participation in the environment by tracking and quantifying the participation of one or more users in the environment in terms of one or more participation parameters and credit a reward to a user in response to such user satisfying the one or more participation parameters.

7. The system of claim 6, wherein the environment comprises an online course, the reward comprises a point-based reward, and the one or more participation parameters are defined by an instructor of the online course.

8. The system of claim 6, wherein user participation in the environment comprises one or more activities selected from the group consisting of creating content, publishing content in the environment, interacting with other users using the social networking features of the environment, reflecting on content published to the environment by other users using the social networking features of the environment, and participating in an activity associated with an online course.

9. The system of claim 7, wherein:
the amount of the point-based reward credited to the user is cumulative over a prescribed period of time and the one or more participation parameters further comprise one or more goal values; and
the incentive application is configured to dynamically assess the cumulative number of points credited to a user during the prescribed period of time as compared to the one or more goal values to achieve a status value for the user and provide the user with a feedback notification of the status value.

10. The system of claim 6, wherein the incentive application is configured to receive and consider input from a second user on the participation of a first user for consideration in quantifying the participation.

11. The system of claim 9, wherein the incentive application further comprises a means to provide the user with one or more feedback notifications of the status value within the prescribed period of time.

12. A method for providing educational services and facilitating user collaboration and communication across a network-based environment, the method comprising:
receiving a request from one or more users to access a network-based learning environment;
providing a plurality of groups to users over a network, each of the groups having at least one subject matter focus;
assigning, using a processor, at least one category value to each group pursuant to the subject matter focus of the group;
associating one or more of the users with one or more of the groups;
receiving a first content from a first user in connection with such user's participation in a first group; and
making the first content available to those users of the learning environment that are associated with the groups having the same category value as the first group.

13. The method of claim 12, further comprising providing social networking tools for interaction between the users within the network-based learning environment, and wherein the content is received from the user in connection with the user's use of the social networking tools.

14. The method of claim 12, wherein the learning environment further comprises an automated assignment tool and a gradebook tool and further comprising the steps of:
generating one or more task items using the automated assignment tool, each of the task items associated with one of the groups;
identifying resources and content associated with each task item;
providing a link in each task item to the identified resources and content; and
where a task item is identified as gradable, interfacing the automated assignment tool with the gradebook tool such that a corresponding category is created in the gradebook tool for each task item.

15. The method of claim 14, further comprising the steps of:
interfacing the automated assignment tool with a dropbox tool;
uploading content to a task item using the automated task tool;
transferring the uploaded content to the dropbox tool; and
creating a record in the category of the gradebook tool that corresponds with the task item, the record relating to the uploaded content.

16. The method of claim 12, further comprising the steps of:
receiving a second content from a second user in response to the first content of the first user; and
making the second content available to those users of the learning environment that are associated with the groups having at least one like category value as the first group;
wherein the first and second users are not associated with the same group, are not collocated, and comprise global classmates.

17. The method of claim 12, wherein the step of assigning at least one category value to each group is automatically performed by the processor using word analytics or comprises a user creating a new category value and assigning the new category value to a group.

18. The method of claim 17, further comprising the steps of:
monitoring for the creation of new category values;
identifying the new category value;
comparing the new category value with existing category values;
accepting or denying the new category value based the degree of difference between the new category value and the existing category values; and
if the new category value is denied, automatically assigning at least one existing category value to the group pursuant to a subject matter indicia of the group.

19. The method of claim 12, wherein the content comprises a post or educational resources.

20. The method of claim 12, further comprising the steps of:
defining one or more user roles for one or more of the users associated with a group; and
defining access permissions associated with each of the user roles;
wherein the user role can be selected from the group consisting of student, teaching assistant, graduate student, course coordinator, external reviewer, instructional designer, librarian, academic liaison, professional mentor, field expert, and audit student.
